(19) United States
(12) Patent Application Publication
(10) Pub. No.: US 2026/0023285 A1
(43) Pub. Date: Jan. 22, 2026

(54) OPTICAL COMPONENT AND OPTICAL ELEMENT

(71) Applicant: FUJIFILM Corporation, Tokyo (JP)

(72) Inventors: Shinpei YOSHIDA, Minamiashigara-shi (JP); Hiroshi SATO, Minamiashigara-shi (JP); Yukito SAITOH, Minamiashigara-shi (JP); Yujiro YANAI, Minamiashigara-shi (JP); Yuta TAKAHASHI, Minamiashigara-shi (JP)

(73) Assignee: FUJIFILM Corporation, Tokyo (JP)

(21) Appl. No.: 19/339,350

(22) Filed: Sep. 25, 2025

Related U.S. Application Data
(63) Continuation of application No. PCT/JP2024/010683, filed on Mar. 19, 2024.

(30) Foreign Application Priority Data
Mar. 31, 2023 (JP) 2023-057649

(51) Int. Cl. G02F 1/13363; G02F 1/1335

(52) U.S. Cl. CPC G02F 1/133638; G02F 1/133541; G02F 1/133636

(57) ABSTRACT

An object of the present invention is to provide an optical component having a novel configuration capable of converting only circularly polarized light in a specific wavelength range into circularly polarized light having an opposite turning direction. The optical component of the present invention includes, in the following order, a first λ/4 plate, an optical laminate, and a second λ/4 plate, in which the optical laminate includes two or more liquid crystal layer sets in a thickness direction, the liquid crystal layer set each consisting of a first liquid crystal layer which is formed by immobilizing a liquid crystal compound twist-aligned in the thickness direction and a second liquid crystal layer which is formed by immobilizing a liquid crystal compound twist-aligned in the thickness direction, in which a twisted direction of the liquid crystal compound in the second liquid crystal layer is opposite to a twisted direction of the liquid crystal compound in the first liquid crystal layer, in the liquid crystal layer set, an alignment direction of the liquid crystal compound in a surface of the first liquid crystal layer on the second liquid crystal layer side is parallel to an alignment direction of the liquid crystal compound in a surface of the second liquid crystal layer on the first liquid crystal layer side, and a twisted angle of the liquid crystal compound in the first liquid crystal layer is equal to a twisted angle of the liquid crystal compound in the second liquid crystal layer.

### CROSS-REFERENCE TO RELATED APPLICATIONS

This application is a Continuation of PCT International Application No. PCT/JP2024/010683 filed on Mar. 19, 2024, which claims priority under 35 U.S.C. § 119 (a) to Japanese Patent Application No. 2023-057649 filed on Mar. 31, 2023. The above applications are hereby expressly incorporated by reference, in their entirety, into the present application.

### BACKGROUND OF THE INVENTION

### 1. Field of the Invention

The present invention relates to an optical component and an optical element using the optical component.

### 2. Description of the Related Art

In recent years, augmented reality (AR) glasses which display a virtual image, various information, and the like in a superimposed manner on a scene which is actually being viewed have been put into practical use. The AR glasses are also called, for example, smart glasses or a head mounted display (HMD).

WO2019/131918A discloses an optical element in which wavelength dependence of a refraction angle is small, for example, red light, green light, and blue light incident from the same direction can be refracted and emitted in almost the same direction, and it is disclosed that this optical element can be applied to the AR glasses.

In the optical element disclosed in WO2019/131918A, the wavelength dependence of the refraction angle can be reduced by using a combination of a wavelength selective phase difference layer (optical component) and a plurality of optically anisotropic layers. The above-described wavelength selective phase difference layer (optical component) has a function of converting circularly polarized light in a specific wavelength range into circularly polarized light having an opposite turning direction.

### SUMMARY OF THE INVENTION

WO2019/131918A discloses the above-described wavelength selective phase difference layer (optical component), but there is a demand for an optical component having a novel configuration different from the configuration.

Therefore, an object of the present invention is to provide an optical component having a novel configuration capable of converting only circularly polarized light in a specific wavelength range into circularly polarized light having an opposite turning direction.

Another object of the present invention is to provide an optical element using the above-described optical component.

The present inventors have completed the present invention as a result of intensive studies to solve the above-described problems. That is, the present inventors have found that the above-described objects can be achieved by the following configuration.

[1] An optical component comprising, in the following order:
a first λ/4 plate;
an optical laminate; and
a second λ/4 plate,
in which the optical laminate includes two or more liquid crystal layer sets in a thickness direction, the liquid crystal layer set each consisting of a first liquid crystal layer which is formed by immobilizing a liquid crystal compound twist-aligned in the thickness direction and a second liquid crystal layer which is formed by immobilizing a liquid crystal compound twist-aligned in the thickness direction, in which a twisted direction of the liquid crystal compound in the second liquid crystal layer is opposite to a twisted direction of the liquid crystal compound in the first liquid crystal layer,
in the liquid crystal layer set, an alignment direction of the liquid crystal compound in a surface of the first liquid crystal layer on the second liquid crystal layer side is parallel to an alignment direction of the liquid crystal compound in a surface of the second liquid crystal layer on the first liquid crystal layer side, and
a twisted angle of the liquid crystal compound in the first liquid crystal layer is equal to a twisted angle of the liquid crystal compound in the second liquid crystal layer.

[2] The optical component according to [1],
in which the liquid crystal compound in the first liquid crystal layer includes any one of a rod-like liquid crystal compound or a disk-like liquid crystal compound, and the liquid crystal compound in the second liquid crystal layer includes the other.

[3] The optical component according to [1] or [2],
in which at least one of the first λ/4 plate or the second λ/4 plate is a laminate consisting of a liquid crystal layer A formed by immobilizing a liquid crystal compound twist-aligned in the thickness direction and a liquid crystal layer B formed by immobilizing a liquid crystal compound twist-aligned in the thickness direction.

[4] The optical component according to [3],
in which a twisted angle of the liquid crystal compound in the liquid crystal layer A is 16.5° to 36.5° and a product Δn_{A}d_{A} of a difference Δn_{A} in refractive index of the liquid crystal layer A and a thickness d_{A} of the liquid crystal layer A is 252 to 312 nm, and
a twisted angle of the liquid crystal compound in the liquid crystal layer B is 68.6° to 88.6° and a product Δn_{B}d_{B} of a difference Δn_{B} in refractive index of the liquid crystal layer B and a thickness d_{B} of the liquid crystal layer B is 110 to 170 nm.

[5] The optical component according to [3] or [4],
in which the liquid crystal layer A is disposed on the optical laminate side, and
an alignment direction of the liquid crystal compound in a surface of the optical laminate on the liquid crystal layer A side is parallel to an alignment direction of the liquid crystal compound in a surface of the liquid crystal layer A on the optical laminate side.

[6] The optical component according to any one of [3] to [5],
in which an alignment direction of the liquid crystal compound in a surface of the liquid crystal layer A on the liquid crystal layer B side is parallel to an alignment direction of the liquid crystal compound in a surface of the liquid crystal layer B on the liquid crystal layer A side.

[7] An optical element comprising:
a plurality of optically anisotropic layers which are formed of a composition containing a liquid crystal compound and have a liquid crystal alignment pattern in which an orientation of an optical axis derived from the liquid crystal compound changes while continuously rotating in at least one in-plane direction; and
the optical component according to any one of [1] to [6], which is disposed between at least one pair of adjacent two optically anisotropic layers among the plurality of optically anisotropic layers,
in which, in a case where a length over which the orientation of the optical axis derived from the liquid crystal compound rotates by 180° in the one direction in which the orientation of the optical axis derived from the liquid crystal compound changes while continuously rotating in the liquid crystal alignment pattern of the optically anisotropic layer is set as a single period, at least one layer of the optically anisotropic layers has a length of the single period different from lengths of the single periods of the other optically anisotropic layers.

According to the present invention, an object is to provide an optical component having a novel configuration capable of converting only circularly polarized light in a specific wavelength range into circularly polarized light having an opposite turning direction.

In addition, according to the present invention, it is also possible to provide an optical element using the above-described optical component.

### BRIEF DESCRIPTION OF THE DRAWINGS

FIG. 1 is a view conceptually showing an example of the optical component according to the embodiment of the present invention.

FIG. 2 is a graph for describing the optical component according to the embodiment of the present invention.

FIG. 3 is a graph for describing the optical component according to the embodiment of the present invention.

FIG. 4 is a view conceptually showing another example of the optical component according to the embodiment of the present invention.

FIG. 5 is a graph for describing the optical component shown in FIG. 4.

FIG. 6 is a view conceptually showing an example of the optical element according to the embodiment of the present invention.

FIG. 7 is a view conceptually showing an optically anisotropic layer of the optical element shown in FIG. 6.

FIG. 8 is a plan view showing the optically anisotropic layer of the optical element shown in FIG. 6.

FIG. 9 is a conceptual diagram showing the action of the optically anisotropic layer of the optical element shown in FIG. 6.

FIG. 10 is a conceptual diagram showing the action of the optically anisotropic layer of the optical element shown in FIG. 6.

FIG. 11 is a conceptual diagram showing an action of the optical element shown in FIG. 6.

FIG. 12 is a conceptual diagram showing an action of the optical element shown in FIG. 6.

FIG. 13 is a view conceptually showing another example of the optical element according to the embodiment of the present invention.

FIG. 14 is a conceptual diagram showing an action of the optical element shown in FIG. 12.

FIG. 15 is a conceptual diagram showing an action of the optical element shown in FIG. 12.

FIG. 16 is a view conceptually showing an example of an exposure device which exposes an alignment film of the optical element shown in FIG. 6.

FIG. 17 is a plan view showing another example of the optically anisotropic layer of the optical element according to the embodiment of the present invention.

FIG. 18 is a view conceptually showing an example of an exposure device which exposes an alignment film forming the optically anisotropic layer shown in FIG. 16.

FIG. 19 is a view conceptually showing an example of AR glasses using an example of the optical element according to the embodiment of the present invention.

FIG. 20 is a view conceptually showing another example of an optically anisotropic layer of the optical element according to the embodiment of the present invention.

### DESCRIPTION OF THE PREFERRED EMBODIMENTS

Hereinafter, the present invention will be described in detail.

The description of the configuration requirements described below is made on the basis of representative embodiments of the present invention, but it should not be construed that the present invention is limited to those embodiments.

Hereinafter, meaning of each description in the present specification will be explained. In the present specification, a numerical range represented by “to” means a range including numerical values before and after “to” as a lower limit value and an upper limit value.

Re(λ) and Rth(λ) each represent an in-plane retardation and a thickness-direction retardation at a wavelength λ. Re(λ), Rth(λ), and Δnd are measured with AxoScan (manufactured by Axometrics, Inc.).

In the present specification, “visible light” refers to light in a wavelength range of 380 nm to 780 nm. In addition, in the present specification, a measurement wavelength is 550 nm unless otherwise specified.

In addition, in the present specification, a relationship between angles (for example, “orthogonal”, “parallel”, a specific angle, and the like) is intended to include a range of errors acceptable in the art to which the present invention belongs. Specifically, the angle is in a range of the exact angle±less than 10°, and the error from the exact angle is preferably 5° or less and more preferably 3° or less.

In addition, all of the drawings shown below are conceptual views for describing the present invention, and the positional relationship, size, thickness, shape, and the like of each constituent may be different from the actual ones.

### <Optical Component>

The optical component according to the embodiment of the present invention includes a first λ/4 plate, an optical laminate, and a second λ/4 plate in this order.

The optical laminate includes two or more liquid crystal layer sets in a thickness direction, the liquid crystal layer set each consisting of a first liquid crystal layer which is formed by immobilizing a liquid crystal compound twist-aligned in the thickness direction and a second liquid crystal layer which is formed by immobilizing a liquid crystal compound twist-aligned in the thickness direction, in which a twisted direction of the liquid crystal compound in the second liquid crystal layer is opposite to a twisted direction of the liquid crystal compound in the first liquid crystal layer.

In addition, in the liquid crystal layer set, an alignment direction of the liquid crystal compound in a surface of the first liquid crystal layer on the second liquid crystal layer side is parallel to an alignment direction of the liquid crystal compound in a surface of the second liquid crystal layer on the first liquid crystal layer side. In addition, a twisted angle of the liquid crystal compound in the first liquid crystal layer is equal to a twisted angle of the liquid crystal compound in the second liquid crystal layer.

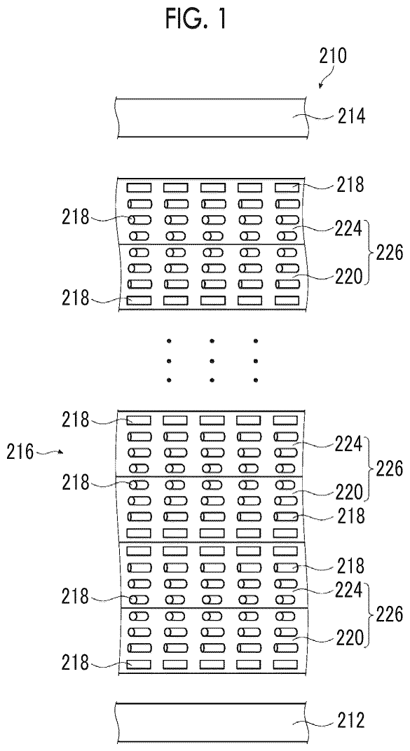

FIG. 1 conceptually shows an example of the optical component according to the embodiment of the present invention.

An optical component 210 shown in FIG. 1 includes a first λ/4 plate 212, a second λ/4 plate 214, and a liquid crystal polarization interference element 216. The liquid crystal polarization interference element 216 is disposed between the first λ/4 plate 212 and the second λ/4 plate 214. The liquid crystal polarization interference element 216 corresponds to the optical laminate in the optical component according to the embodiment of the present invention.

The liquid crystal polarization interference element 216 is an optical element which acts as a λ/2 phase difference plate for light in a specific wavelength range (having a specific wavelength) and does not act as a phase difference layer for light in other wavelength ranges. Accordingly, the optical component 210 shown in FIG. 1 can convert only circularly polarized light in a specific wavelength range into circularly polarized light having an opposite turning direction. Regarding circularly polarized light in a wavelength range other than the specific wavelength range, the circularly polarized light is transmitted without changing a turning direction thereof. That is, the optical component 210 according to the embodiment of the present invention functions as a wavelength selective phase difference layer with respect to circularly polarized light.

The first λ/4 plate 212 and the second λ/4 plate 214 are plates having a function of converting linearly polarized light having a specific wavelength into circularly polarized light (or converting circularly polarized light into linearly polarized light). More specifically, the first λ/4 plate 212 and the second λ/4 plate 214 are plates in which an in-plane retardation at a predetermined wavelength λ nm is λ/4 (or an odd multiple thereof).

The first λ/4 plate 212 and the second λ/4 plate 214 are not particularly limited, and a known λ/4 plate can be used. The first λ/4 plate 212 and the second λ/4 plate 214 will be described in detail later.

In the optical component 210 of the example shown in the drawing, the liquid crystal polarization interference element 216 is disposed between the first λ/4 plate 212 and the second λ/4 plate 214.

In FIG. 1, the first λ/4 plate 212, the second λ/4 plate 214, and the liquid crystal polarization interference element 216 are spaced from each other.

However, the present invention is not limited thereto, and the first λ/4 plate 212, the second λ/4 plate 214, and the liquid crystal polarization interference element 216 may be laminated being in contact with each other. In addition, in a case where the first λ/4 plate 212 and the second λ/4 plate 214 are in contact with the liquid crystal polarization interference element 216, they may be bonded to each other with a transparent adhesive to transmitted light, such as an optical clear adhesive (OCA) and an acrylic pressure sensitive adhesive, as necessary.

The liquid crystal polarization interference element 216 is formed by laminating an even number of liquid crystal layers each formed by immobilizing a liquid crystal compound 218 twist-aligned in a thickness direction. The liquid crystal compound 218 is a rod-like liquid crystal compound.

Specifically, the liquid crystal polarization interference element 216 is formed by alternately laminating a first liquid crystal layer 220 formed by immobilizing a liquid crystal compound 218 twist-aligned in the thickness direction and a second liquid crystal layer 224 formed by immobilizing a liquid crystal compound 218 twist-aligned in the thickness direction, in which a twisted direction of the liquid crystal compound 218 in the first liquid crystal layer 220 is opposite to a twisted direction of the liquid crystal compound 218 in the second liquid crystal layer 224.

The liquid crystal polarization interference element 216 has a configuration in which one combination of the first liquid crystal layer 220 and the second liquid crystal layer 224 constitutes one liquid crystal layer set 226 and two or more liquid crystal layer sets 226 are laminated in the thickness direction.

Accordingly, the total number of the first liquid crystal layers 220 and the second liquid crystal layers 224 laminated is an even number.

In one liquid crystal layer set 226, an alignment direction of the liquid crystal compound 218 in a surface of the first liquid crystal layer 220 on the second liquid crystal layer 224 side is parallel to an alignment direction of the liquid crystal compound 218 in a surface of the second liquid crystal layer 224 on the first liquid crystal layer 220 side.

That is, in one liquid crystal layer set 226, the alignment directions of the liquid crystal compound 218 are parallel to each other at an interface between the first liquid crystal layer 220 and the second liquid crystal layer 224.

In one liquid crystal layer set 226, the alignment direction of the liquid crystal compound 218 in the surface of the first liquid crystal layer 220 on the second liquid crystal layer 224 side and the alignment direction of the liquid crystal compound 218 in the surface of the second liquid crystal layer 224 on the first liquid crystal layer 220 side can be detected by obliquely cutting the liquid crystal polarization interference element 216 and analyzing the alignment direction of the liquid crystals in a surface of a cross section.

The method is described in detail in “Depth-Dependent Determination of Molecular Orientation for WV-Film” (FMC8-3, IDW′04, 651 to 654) written by Yohei Takahashi et al.

Furthermore, in the thickness direction of one liquid crystal layer set 226, a twisted angle of the liquid crystal compound 218 in the first liquid crystal layer 220 is equal to a twisted angle of the liquid crystal compound 218 in the second liquid crystal layer 224.

As described above, the twisted direction of the liquid crystal compound 218 in the thickness direction in the first liquid crystal layer 220 is opposite to that in the second liquid crystal layer 224. That is, for example, in a case where the twisted angle of the liquid crystal compound 218 in the first liquid crystal layer 220 is denoted by “φ [°]”, the twisted angle of the liquid crystal compound 218 in the second liquid crystal layer 224 is denoted by “−φ [°]”.

Accordingly, in one liquid crystal layer set 226, the liquid crystal compound 218 is twisted up to a certain angle in the first liquid crystal layer 220 along the thickness direction, and is twisted to return to the original state in the second liquid crystal layer 224. For example, in a case where the twisted angle of the liquid crystal compound 218 in the thickness direction is 30°, the liquid crystal compound 218 is twisted from 0° to 30° in the first liquid crystal layer 220, and then returned to be twisted from 30° to 0° in the second liquid crystal layer 224.

In the present example, for example, the twisted angle of the liquid crystal compound is defined as 0° in a direction of a transmission axis of the first λ/4 plate 212, and is positive (+) in the clockwise direction and negative (−) in the counterclockwise direction.

That is, absolute values of the twisted angles in the first liquid crystal layer 220 and the second liquid crystal layer 224 are the same.

As described above, in the liquid crystal polarization interference element 216, the first liquid crystal layer 220 and the second liquid crystal layer 224 are alternately laminated in the thickness direction, in which the liquid crystal compound 218 (rod-like liquid crystal compound) is twist-aligned in the thickness direction, the liquid crystal compound 218 has a parallel alignment at the interface, the twisted directions of the liquid crystal compound 218 are opposite to each other, and the absolute values of the twisted angles are the same.

That is, light passing through the liquid crystal polarization interference element 216 alternately and repeatedly receives influences of a slow axis which rotates by a predetermined angle in one direction and a slow axis which rotates by a predetermined angle in the opposite direction. For example, in a case where the absolute value of the twisted angle of the liquid crystal compound 218 is 30°, light passing through the liquid crystal polarization interference element 216 alternately and repeatedly receives the influence of the slow axis which rotates from 0° to 30° and the influence of the slow axis which rotates from 30° to 0°.

Therefore, in the liquid crystal polarization interference element 216, And of the first liquid crystal layer 220 and the second liquid crystal layer 224 is set according to the wavelength range in which the optical component 210 converts circularly polarized light into circularly polarized light having an opposite turning direction, and the twisted angle of the liquid crystal compound in the first liquid crystal layer 220 and the second liquid crystal layer 224 is further adjusted according to the total number of lamination of the first liquid crystal layer 220 and the second liquid crystal layer 224. As a result, the liquid crystal polarization interference element 216 which acts as a λ/2 phase difference plate for light in a specific wavelength range and does not act as a phase difference plate for the other light, that is, does not provide retardation can be formed.

The number of the liquid crystal layer sets 226 in the liquid crystal polarization interference element 216 can be detected by obliquely cutting the liquid crystal polarization interference element 216 and analyzing the alignment direction of the liquid crystals on a surface of a cross section. The method is described in detail in the above-described document written by Yohei Takahashi et al.

In addition, the change in the twisted direction of the liquid crystal can be confirmed based on a difference in components in a depth direction of the element by using a time-of-flight secondary ion mass spectrometry (TOF-SIMS) device (TOF.SIMS5 manufactured by ION-TOF) or the like, based on the difference in the chiral agent.

In the Δnd of the first liquid crystal layer 220 and the second liquid crystal layer 224 constituting the liquid crystal polarization interference element 216, Δn is a birefringence of the liquid crystal compound 218 constituting the first liquid crystal layer 220 and the second liquid crystal layer 224. In addition, d is a thickness of the first liquid crystal layer 220 and the second liquid crystal layer 224. An can be measured with AxoScan manufactured by Axometrics, Inc.

In the present invention, And of the first liquid crystal layer 220 and Δnd of the second liquid crystal layer 224 are the same.

As described above, the liquid crystal polarization interference element 216 acts as a λ/2 phase difference plate only for light in a specific wavelength range. Accordingly, And of the first liquid crystal layer 220 and the second liquid crystal layer 224 is a wavelength at which the liquid crystal polarization interference element 216 acts as the λ/2 phase difference plate, that is, half (half wavelength) of a central wavelength of a wavelength range in which the optical component 210 converts circularly polarized light into circularly polarized light having an opposite turning direction.

For example, in a case where the wavelength at which the liquid crystal polarization interference element 216 acts as the λ/2 phase difference plate, that is, the central wavelength of the wavelength range in which the optical component 210 converts circularly polarized light into circularly polarized light having an opposite turning direction is assumed to be 550 nm, And of the first liquid crystal layer 220 and the second liquid crystal layer 224 is 275 nm.

And of the first liquid crystal layer 220 and the second liquid crystal layer 224 may have an error of approximately ±10% with respect to the half of the central wavelength of the wavelength range in which the optical component 210 converts circularly polarized light into circularly polarized light having an opposite turning direction.

On the other hand, regarding the twisted angle of the liquid crystal compound 218 in the first liquid crystal layer 220 and the second liquid crystal layer 224 constituting the liquid crystal polarization interference element 216, the optimum twisted angle at which the liquid crystal polarization interference element 216 acts as the λ/2 phase difference plate is set by simulation according to the central wavelength of the wavelength range in which the optical component 210 converts circularly polarized light into circularly polarized light having an opposite turning direction and the total number N of laminations of the first liquid crystal layer 220 and the second liquid crystal layer 224.

A general optical simulation unit can be used for the simulation, or calculation can be performed using LCD Master 1D (manufactured by SHINTECH Co., Ltd., Ver. 9.8.0.0).

Here, according to the simulation conducted by the present inventors, a twisted angle φ of the liquid crystal compound 218 in the first liquid crystal layer 220 and the second liquid crystal layer 224 with respect to the total number N of laminations of the first liquid crystal layers 220 and the second liquid crystal layers 224 is as follows:
an optimum value of the twisted angle φ is 63.6° in a case where the number N of laminations is 2 (one liquid crystal layer set),
an optimum value of the twisted angle φ is 35.5° in a case where the number N of laminations is 4 (two liquid crystal layer sets),
an optimum value of the twisted angle φ is 23.6° in a case where the number N of laminations is 6 (three liquid crystal layer sets),
an optimum value of the twisted angle φ is 17.7° in a case where the number N of laminations is 8 (four liquid crystal layer sets),
an optimum value of the twisted angle φ is 14.1° in a case where the number N of laminations is 10 (five liquid crystal layer sets),
an optimum value of the twisted angle φ is 11.8° in a case where the number N of laminations is 12 (six liquid crystal layer sets),
an optimum value of the twisted angle φ is 10.1° in a case where the number N of laminations is 14 (seven liquid crystal layer sets), and
an optimum value of the twisted angle φ is 8.8° in a case where the number N of laminations is 16 (eight liquid crystal layer sets).

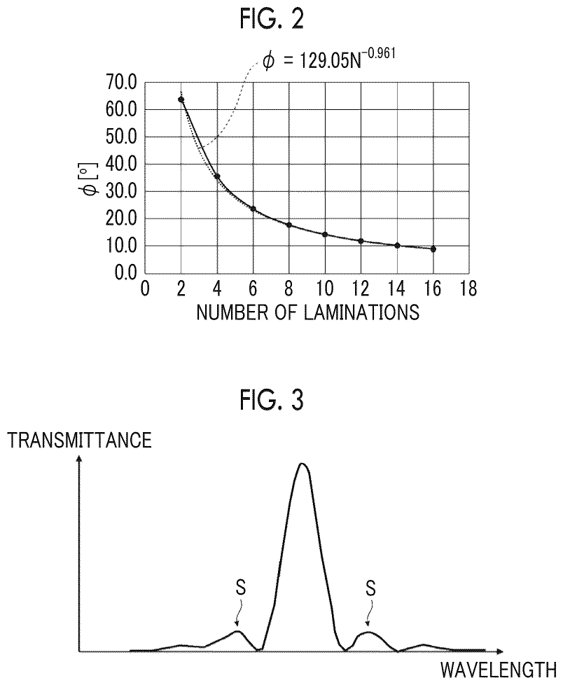

As conceptually shown in FIG. 2, in a case where the results (solid line) are fitted to an approximate curve (broken line), it suitably matches the following expression:

$$φ = 12 \; 9.05 \times {N}^{- 0.961}$$

Accordingly, in the present invention, the twisted angle±φ [°] of the liquid crystal compound 218 in the first liquid crystal layer 220 and the second liquid crystal layer 224, corresponding to the total number N of laminations of the first liquid crystal layers 220 and the second liquid crystal layers 224, preferably satisfies:

$$0.9 \times ( 12 \; 9.05 \times {N}^{- 0.961} ) \leq \vert φ \vert \leq 1. 1 \times ( 129.05 \times {N}^{- 0.961} ) ,$$

and more preferably satisfies:

$$\vert φ \vert = 129.05 \times {N}^{- 0.961}$$

The absolute values of the twisted angles of the liquid crystal compound 218 in the first liquid crystal layer 220 and the second liquid crystal layer 224 are not limited to the aspect in which the absolute values match each other, and may have an error of ±10% or less of the absolute value of the twisted angle.

It is preferable that the error be small, and it is most preferable that the absolute values of the twisted angles of the liquid crystal compound 218 in the first liquid crystal layer 220 and the second liquid crystal layer 224 are identical to each other.

The twisted angle of the liquid crystal compound 218 in the first liquid crystal layer 220 and the second liquid crystal layer 224 constituting the liquid crystal polarization interference element 216 can be detected by obliquely cutting the liquid crystal polarization interference element 216 and analyzing the alignment direction of the liquid crystals on the surface of the cross section. The method is described in detail in the above-described document written by Yohei Takahashi et al.

In addition, the twisted angle of the liquid crystal compound 218 can also be measured by using AxoScan (manufactured by Axometrics, Inc.) with a separate measurement unit in which a model with parameters input thereto is assumed.

The thickness d of the first liquid crystal layer 220 and the second liquid crystal layer 224 is not limited, and the thickness d may be appropriately set depending on the liquid crystal compound 218 used such that the central wavelength of the wavelength range in which the optical component 210 converts circularly polarized light into circularly polarized light having an opposite turning direction can be a half wavelength.

The thickness d of the first liquid crystal layer 220 and the second liquid crystal layer 224 is preferably 1 to 5 μm and more preferably 1 to 3 μm.

The first liquid crystal layer 220 and the second liquid crystal layer 224 are usually formed of the same liquid crystal compound 218. In addition, And of the first liquid crystal layer 220 and Δnd of the second liquid crystal layer 224 are the same. Accordingly, the thicknesses of the first liquid crystal layer 220 and the second liquid crystal layer 224 are the same.

The total number N of laminations of the first liquid crystal layer 220 and the second liquid crystal layer 224 is not limited as long as the number of the liquid crystal layer sets 226 is two or more, that is, four or more layers are laminated, and the number of layers laminated is an even number.

The total number N of laminations of the first liquid crystal layer 220 and the second liquid crystal layer 224 is preferably 4 to 30, more preferably 4 to 20, and still more preferably 4 to 10.

In the optical component 210 according to the embodiment of the present invention, as the total number N of laminations of the first liquid crystal layer 220 and the second liquid crystal layer 224 is larger, that is, as the number of liquid crystal layer sets 226 is larger, the wavelength range in which the liquid crystal polarization interference element 216 acts as the λ/2 phase difference layer is narrow.

Accordingly, in the optical component 210 according to the embodiment of the present invention, as the total number N of laminations of the first liquid crystal layer 220 and the second liquid crystal layer 224 increases, the half-width of the wavelength range of light to be converted into circularly polarized light having an opposite turning direction decreases. In other words, as the total number N of laminations of the first liquid crystal layer 220 and the second liquid crystal layer 224 is larger, the optical component 210 can be an optical element in which the wavelength range in which circularly polarized light is converted into circularly polarized light having an opposite turning direction is narrow.

Therefore, according to the width of the wavelength range required for the optical component 210, the total number N of laminations of the first liquid crystal layer 220 and the second liquid crystal layer 224, that is, the number of the liquid crystal layer sets 226 may be appropriately selected to be a small number in a case where a wide wavelength range is preferable and may be appropriately selected to be a large number in a case where a narrow wavelength range is required.

The liquid crystal polarization interference element 216 may be produced by a known method.

Examples thereof include a method of producing the liquid crystal layer 220 and the second liquid crystal layer 224 by a coating method using a liquid crystal composition for forming the first liquid crystal layer 220 and the second liquid crystal layer 224.

First, an alignment film aligned in one direction is formed on an appropriately selected support.

As the alignment film, known alignment films can be used, such as a rubbed film containing an organic compound such as a polymer; an obliquely vapor-deposited film of an inorganic compound; a film having microgrooves; a film obtained by accumulating a Langmuir-Blodgett (LB) film of an organic compound such as @-tricosanoic acid, dioctadecylmethylammonium chloride, and methyl stearate by a Langmuir-Blodgett method; and a film obtained by applying a coating liquid for forming an alignment film containing a photo-alignment material onto a surface of a support, drying the coating liquid, and exposing the coating film using a polarizer such as a wire grid polarizer.

On the other hand, a composition (liquid crystal composition) for forming the first liquid crystal layer 220, which contains a liquid crystal compound and a chiral agent having a function of inducing a twisted alignment of the liquid crystal compound in the thickness direction, and a composition for forming the second liquid crystal layer 224 are prepared.

In the first liquid crystal layer 220 and the second liquid crystal layer 224, the twisted directions of the liquid crystal compound 218 in the thickness direction are opposite to each other, and by selecting the chiral agent, the twisted directions of the liquid crystal compound in the thickness direction can be selected. In addition, by adjusting the amount of the chiral agent to be added, the twisted angle of the liquid crystal compound 218 in the thickness direction can be adjusted.

A solvent for preparing the composition is not limited and can be appropriately selected depending on the purpose, and an organic solvent is preferable. The organic solvent is not limited and may be appropriately selected according to the purpose; and examples thereof include ketones, alkyl halides, amides, sulfoxides, heterocyclic compounds, hydrocarbons, esters, and ethers. Among these, one kind may be used alone, or two or more kinds may be used in combination. Among these, in consideration of environmental load, ketones are preferable.

The composition for forming the first liquid crystal layer 220 is applied onto a surface of the formed alignment film to align the liquid crystal compound 218, dried; and cured by ultraviolet irradiation or the like as necessary to form the first liquid crystal layer 220.

Next, the composition for forming the second liquid crystal layer 224 is applied onto a surface of the formed first liquid crystal layer 220, dried, and cured by ultraviolet irradiation or the like as necessary to form the second liquid crystal layer 224, thereby forming first liquid crystal layer set.

Here, in a case where the liquid crystal layer is formed on the liquid crystal layer by the coating method, the alignment of the upper liquid crystal layer follows the alignment of the liquid crystal compound on the surface of the lower liquid crystal layer.

Accordingly, the alignment direction of the liquid crystal compound 218 in the first liquid crystal layer 220 is parallel to (matches) the alignment direction of the liquid crystal compound 218 in the second liquid crystal layer 224 at the interface between the first liquid crystal layer 220 and the second liquid crystal layer 224.

Next, the composition for forming the first liquid crystal layer 220 is applied onto the surface of the formed second liquid crystal layer 224, dried, and cured by ultraviolet irradiation or the like as necessary to form the first liquid crystal layer 220.

In the liquid crystal polarization interference element 216 constituting the optical component 210 according to the embodiment of the present invention, the twist of the liquid crystal compound 218 of the first liquid crystal layer 220 in the thickness direction and the twist of the liquid crystal compound 218 the second liquid crystal layer 224 in the thickness direction of have the same twisted angle and opposite twisted directions. Accordingly, in a case where an angle of the alignment of the liquid crystal compound 218 at the interface between the first liquid crystal layer 220 formed on the surface of the alignment film and the alignment film is defined as 0°, an angle of the alignment of the liquid crystal compound 218 on the upper surface of the second liquid crystal layer 224 also returns to 0°.

In addition, as described above, in a case where the liquid crystal layer is formed on the liquid crystal layer by the coating method, the liquid crystal compound in the vicinity of the interface between the upper liquid crystal layer and the lower liquid crystal layer follows the alignment of the liquid crystal compound on the surface of the lower liquid crystal layer.

Accordingly, at the interface between the second liquid crystal layer 224 and the first liquid crystal layer 220, the alignment direction of the liquid crystal compound 218 in the second liquid crystal layer 224 is parallel to the alignment direction of the liquid crystal compound 218 in the first liquid crystal layer 220 as 0°.

Next, the formation of the second liquid crystal layer 224 on the surface of the formed first liquid crystal layer 220, the formation of the first liquid crystal layer 220 on the surface of the formed second liquid crystal layer 224, and the formation of the second liquid crystal layer 224 on the surface of the formed first liquid crystal layer 220 are repeated as many times as the number of liquid crystal layers to be formed, that is, the number of liquid crystal layer sets to be formed, thereby producing the liquid crystal polarization interference element 216.

Furthermore, for example, the optical component 210 as shown in FIG. 1 is obtained by setting an angle between the alignment direction of the liquid crystal compound 218 in the first liquid crystal layer 220 formed first and the in-plane slow axis of the first λ/4 plate 212 to 45° and further disposing the second λ/4 plate 214 such that the in-plane slow axis of the first λ/4 plate 212 and the in-plane slow axis of the second λ/4 plate 214 are perpendicular to each other to sandwich the liquid crystal polarization interference element 216 in the thickness direction (laminating direction).

In the above description, the angle between the alignment direction of the liquid crystal compound 218 in the first liquid crystal layer 220 formed first and the in-plane slow axis of the first λ/4 plate 212 is 45°, but the angle may be 45°+15°, preferably 45°+10°.

In the liquid crystal polarization interference element 216 of the optical component 210 according to the embodiment of the present invention, the first liquid crystal layer 220 and the second liquid crystal layer 224 are not limited to those directly laminated by the coating method as described above. That is, the liquid crystal polarization interference element 216 may be produced by producing a sheet-like first liquid crystal layer 220 and a sheet-like second liquid crystal layer 224, alternately laminating the first liquid crystal layer 220 and the second liquid crystal layer 224, and bonding the first liquid crystal layer 220 and the second liquid crystal layer 224 with a bonding agent transparent to transmitted light, such as OCA and an acrylic pressure sensitive adhesive.

However, in consideration of transmittance of the transmitted light, it is preferable that the first liquid crystal layer 220 and the second liquid crystal layer 224 are directly laminated by the coating method, without using an adhesive layer or the like.

In the optical component 210 (liquid crystal polarization interference element 216) according to the embodiment of the present invention, the liquid crystal compound 218 (rod-like liquid crystal compound) is not limited, and various known liquid crystal compounds can be used.

As the rod-like liquid crystal compound, azomethines, azoxys, cyano biphenyls, cyanophenyl esters, benzoic acid esters, cyclohexane carboxylic acid phenyl esters, cyanophenyl cyclohexanes, cyano-substituted phenyl pyrimidines, alkoxy-substituted phenyl pyrimidines, phenyl dioxanes, tolanes, and alkenylcyclohexylbenzonitriles are preferably used. In addition to the above-described low-molecular-weight liquid crystal molecules, a high-molecular-weight liquid crystal molecular can also be used.

In the first liquid crystal layer 220 and the second liquid crystal layer 224, it is preferable that the alignment of the rod-like liquid crystal compound is fixed by polymerization, and examples of the polymerizable rod-like liquid crystal compound include compounds described in Makromol. Chem., (1989), Vol. 190, p. 2255, Advanced Materials (1993), Vol. 5, p. 107, U.S. Pat. Nos. 4,683,327A, 5,622,648A, 5,770,107A, WO95/22586A, WO95/24455A, WO97/00600A, WO98/23580A, WO98/52905A, JP1989-272551A (JP-H1-272551A), JP1994-16616A (JP-H6-16616A), JP1995-110469A (JP-H7-110469A), JP1999-80081A (JP-H11-80081A), and JP2001-64627A. Furthermore, as the rod-like liquid crystal compound, for example, compounds described in JP1999-513019A (JP-H11-513019A) and JP2007-279688A can also be preferably used.

As described above, the chiral agent has a function of inducing the twisted alignment of the liquid crystal compound in the thickness direction. The chiral agent may be selected according to the purpose because a helical twisted direction or a helical pitch of the induced helix varies depending on the compound.

The chiral agent is not particularly limited, and a known compound (for example, chiral agent for twisted nematic (TN) and Super Twisted Nematic (STN), described in “Liquid Crystal Device Handbook”, Chapter 3, Section 4-3, p. 199, Japan Society for the Promotion of Science edited by the 142nd committee, 1989), isosorbide (chiral agent having an isosorbide structure, an isomannide derivative, or the like can be used.

In addition, a chiral agent in which back isomerization, dimerization, isomerization, dimerization or the like occurs due to light irradiation so that the helical twisting power (HTP) decreases can also be suitably used.

The chiral agent generally includes an asymmetric carbon atom, but an axially chiral compound or a planar chiral compound including no asymmetric carbon atom can also be used as the chiral agent. Examples of the axially chiral compound or the planar chiral compound include binaphthyl, helicene, paracyclophane, and derivatives thereof. The chiral agent may also have a polymerizable group. In a case where both the chiral agent and the liquid crystal compound have a polymerizable group, a polymer having a repeating unit induced from the polymerizable liquid crystal compound and a repeating unit induced from the chiral agent can be formed by a polymerization reaction between the polymerizable chiral agent and the polymerizable liquid crystal compound. In this aspect, the polymerizable group in the polymerizable chiral agent is preferably the same group as the polymerizable group in the polymerizable liquid crystal compound. Accordingly, the polymerizable group of the chiral agent is preferably an unsaturated polymerizable group, an epoxy group, or an aziridinyl group, more preferably an unsaturated polymerizable group, and still more preferably an ethylenically unsaturated polymerizable group.

In addition, the chiral agent may be a liquid crystal compound.

In a case where the chiral agent has a photoisomerization group, a pattern having a desired reflection wavelength corresponding to a luminescence wavelength can be formed by irradiation with actinic ray or the like through a photo mask after coating and alignment, which is preferable. As the photoisomerization group, an isomerization site of a compound exhibiting photochromic properties, an azo group, an azoxy group, or a cinnamoyl group is preferable. Specific examples of the compound include compounds described in JP2002-080478A, JP2002-080851A, JP2002-179668A, JP2002-179669A, JP2002-179670A, JP2002-179681A, JP2002-179682A, JP2002-338575A, JP2002-338668A, JP2003-313189A, JP2003-313292A, and the like.

The twisted angle of the liquid crystal compound 218 in the thickness direction changes depending on the amount of the chiral agent to be added.

Accordingly, by appropriately selecting the chiral agent and setting the amount thereof to be added, the twisted direction and the twisted angle of the liquid crystal compound 218 in the first liquid crystal layer 220 and the second liquid crystal layer 224 can be optionally set.

In addition to the liquid crystal compound and the chiral agent, a polymerization initiator, a leveling agent, a crosslinking agent, a surfactant, or the like may be added to the composition for forming the first liquid crystal layer 220 and the second liquid crystal layer 224, as necessary.

In the optical component 210 shown in FIG. 1, all the first liquid crystal layers 220 are the same, and all the second liquid crystal layers 224 are also the same. That is, in the optical component 210 shown in FIG. 1, all the first liquid crystal layers 220 have the same Δnd and the same twisted angle of the liquid crystal compound 218, and all the second liquid crystal layers 224 have the same Δnd and the same twisted angle of the liquid crystal compound 218.

However, the present invention is not limited thereto, and the liquid crystal layers may have a distribution of Δnd and a distribution of the twisted angle of the liquid crystal compound 218 in the thickness direction. That is, in the optical component according to the embodiment of the present invention, as long as the first liquid crystal layer and the second liquid crystal layer have the same Δnd, the twisted directions of the liquid crystal compound 218 are opposite to each other, and the twisted angles (absolute values of the twisted angles) are the same, liquid crystal layer sets in which the Δnd and the twisted angle of the liquid crystal compound 218 are different from each other may be present.

For example, a configuration in which the Δnd of the liquid crystal layer and the twisted angle of the liquid crystal compound 218 are different between the liquid crystal layer set in the center in the thickness direction (laminating direction) and the liquid crystal layer sets on both sides in the thickness direction is exemplified.

Specifically, compared to the liquid crystal layers of the liquid crystal layer set in the center in the thickness direction, the Δnd of the liquid crystal layers of the liquid crystal layer sets on both sides in the thickness direction may be increased and the twisted angle of the liquid crystal compound 218 may be reduced.

For example, in a case where the optical component (liquid crystal polarization interference element) has eight liquid crystal layers, that is, four liquid crystal layer sets, the following configuration is exemplified:
in the first liquid crystal layer set, And of the first liquid crystal layer (first layer) is denoted by Δnd1, a twisted angle of the liquid crystal compound is denoted by φ1, Δnd of the second liquid crystal layer (second layer) is denoted by Δnd1, and a twisted angle of the liquid crystal compound is denoted by −φ1;
in the second liquid crystal layer set, And of the first liquid crystal layer (third layer) is denoted by Δnd2 which is smaller than Δnd1, a twisted angle of the liquid crystal compound is denoted by φ2 which is larger than φ1, And of the second liquid crystal layer (fourth layer) is denoted by Δnd2, and a twisted angle of the liquid crystal compound is denoted by −φ2;
in the third liquid crystal layer set, And of the first liquid crystal layer (fifth layer) is denoted by Δnd2, a twisted angle of the liquid crystal compound is denoted by φ2, Δnd of the second liquid crystal layer (sixth layer) is denoted by Δnd2, and a twisted angle of the liquid crystal compound is denoted by −φ2; and
in the fourth liquid crystal layer set, And of the first liquid crystal layer (seventh layer) is denoted by Δnd1, a twisted angle of the liquid crystal compound is denoted by φ1, Δnd of the second liquid crystal layer (eighth layer) is denoted by Δnd1, and a twisted angle of the liquid crystal compound is denoted by −φ1.

As described above, the liquid crystal polarization interference element functions as a λ/2 phase difference plate for light in a specific wavelength range of interest and does not act as a phase difference layer for the other light. On the other hand, in a case where linearly polarizing plates disposed in crossed nicols are provided above and below the liquid crystal polarization interference element, the liquid crystal polarization interference element functions as a bandpass filter centered on the specific wavelength range as conceptually shown in FIG. 3. That is, in the above-described aspect, the liquid crystal polarization interference element functions as a bandpass filter having a high transmittance in the specific wavelength range and a low transmittance in the other wavelength ranges. However, a transmission wavelength range, which is referred to as a sidelobe and is indicated by an arrow S in the drawing, may be generated at a position of a shorter wavelength and a position of a longer wavelength than the target specific wavelength range, with the target specific wavelength range interposed therebetween. That is, in the liquid crystal polarization interference element, a polarized light component generated by the function of the λ/2 phase difference plate may be generated even in a wavelength range other than the specific wavelength range.

With regard to this, as described above, in a case where, compared to the liquid crystal layer of the liquid crystal layer set in the center in the thickness direction, the Δnd of the liquid crystal layers of the liquid crystal layer sets on both sides in the thickness direction is increased and the twisted angle of the liquid crystal compound 218 is reduced, the side lobe can be reduced. That is, the polarization component generated by the function of the λ/2 phase difference plate can be reduced.

For example, the Δnd of the liquid crystal layer may be adjusted by changing the thickness of the liquid crystal layer, or may be adjusted by changing the liquid crystal compound to be used.

In addition, the twisted angle of the liquid crystal compound may be adjusted by changing the type and/or the amount of the chiral agent to be added.

In such a configuration in which, compared to the liquid crystal layer of the liquid crystal layer set in the center in the thickness direction, the Δnd of the liquid crystal layers of the liquid crystal layer sets on both sides in the thickness direction is increased and the twisted angle of the liquid crystal compound 218 is reduced, a method of providing the number of the liquid crystal layers in the center, in which the Δnd of the liquid crystal layer is increased and the twisted angle of the liquid crystal compound 218 is reduced compared to those on both sides, that is, a method of dividing the liquid crystal layer sets on both sides and in the center is not limited, and may be appropriately set according to the number of the liquid crystal layers (liquid crystal layer sets) in the liquid crystal polarization interference element of the optical component.

In addition, the Δnd of the liquid crystal layers of the liquid crystal layer sets on both sides in the thickness direction, the twisted angle of the liquid crystal compound 218, the Δnd of the liquid crystal layer of the liquid crystal layer set in the center in the thickness direction, and the twisted angle of the liquid crystal compound 218 may be set, by simulation, to the optimum Δnd and the optimum twisted angle for reducing the sidelobe, in a case where the liquid crystal polarization interference element functions as the λ/2 phase difference plate and the bandpass filter is provided as described above.

It is preferable that a change in the twisted angle of the liquid crystal compound 218 from both sides toward the center in the laminating direction (thickness direction), and a distribution of the Δnd of the liquid crystal layer of the liquid crystal layer set are controlled as gradually and finely as possible.

In the optical component 210 shown in FIG. 1, in each liquid crystal layer, the liquid crystal compound 218 is a rod-like liquid crystal compound and the liquid crystal layer is formed of only the rod-like liquid crystal compound; but the present invention is not limited thereto.

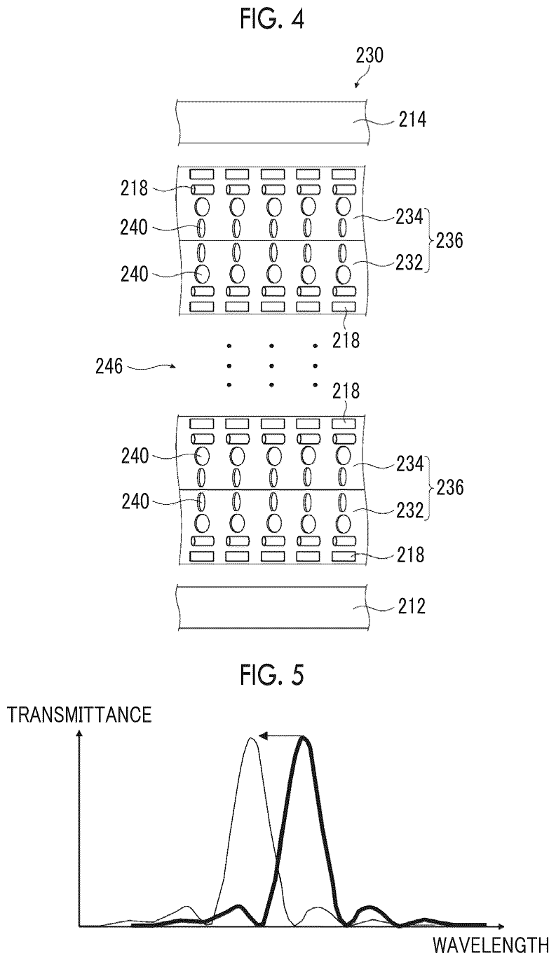

That is, in the optical component according to the embodiment of the present invention, the liquid crystal layer may contain a disk-like liquid crystal compound in addition to the liquid crystal compound 218, as in a first liquid crystal layer 232 and a second liquid crystal layer 234 of an optical component 230 shown in FIG. 4.

That is, the liquid crystal compound in the first liquid crystal layer 232 may include any one of a rod-like liquid crystal compound or a disk-like liquid crystal compound, and the liquid crystal compound in the second liquid crystal layer 234 may include the other.

In the following description, the liquid crystal compound 218 is also referred to as a rod-like liquid crystal compound 218 to clearly distinguish it from a disk-like liquid crystal compound 240. In addition, in the optical component 230 shown in FIG. 4, the same members are represented by the same reference numerals, and in the following description, different members will be mainly described.

In the optical component 230 shown in FIG. 4, the first liquid crystal layer 232 and the second liquid crystal layer 234 are formed by immobilizing the rod-like liquid crystal compound 218 and the disk-like liquid crystal compound 240 twist-aligned in the thickness direction.

In addition, in the optical component 230, the twisted directions of the liquid crystal compounds in the first liquid crystal layer 232 and the second liquid crystal layer 234 are opposite to each other, and the twisted angles of the liquid crystal compounds are the same. That is, a total twisted angle of the rod-like liquid crystal compound 218 and the disk-like liquid crystal compound 240 in the first liquid crystal layer 232 and the second liquid crystal layer 234 is in a relationship of “q” and “−4” as in the above-described example.

Furthermore, in the optical component 230, the alignment directions of the liquid crystal compounds are parallel to each other at the interface between the first liquid crystal layer 232 and the second liquid crystal layer 234.

In the optical component 230 shown in FIG. 4, in the thickness direction from the lower side to the upper side in the drawing, the first liquid crystal layer 232 contains the rod-like liquid crystal compound 218 twist-aligned in the thickness direction, and then contains the disk-like liquid crystal compound 240 twist-aligned in the thickness direction.

On the other hand, in the thickness direction from the lower side to the upper side in the drawing, the second liquid crystal layer 234 on the first liquid crystal layer 232 contains the disk-like liquid crystal compound 240 twist-aligned in the thickness direction, and contains the rod-like liquid crystal compound 218 twist-aligned in the thickness direction on the disk-like liquid crystal compound 240. The twisted alignment directions of the liquid crystal compounds in the first liquid crystal layer 232 is opposite to that in the second liquid crystal layer 234.

The optical component 230 also includes a liquid crystal polarization interference element 246 in which the first liquid crystal layer 232 and the second liquid crystal layer 234 are alternately laminated, and the liquid crystal polarization interference element 246 has three or more liquid crystal layer sets each consisting of the first liquid crystal layer 232 and the second liquid crystal layer 234.

In a liquid crystal layer set 236 of the example shown in FIG. 4, the first liquid crystal layer 232 is provided to have an order of “rod-like liquid crystal compound/disk-like liquid crystal compound” and the second liquid crystal layer 234 is provided to have an order of “disk-like liquid crystal compound/rod-like liquid crystal compound” in the thickness direction from the bottom to the top in the drawing; but the present invention is not limited thereto. For example, in the liquid crystal layer set of the optical component according to the embodiment of the present invention, the first liquid crystal layer may be provided to have an order of “rod-like liquid crystal compound/disk-like liquid crystal compound” and the second liquid crystal layer may be provided to have an order of “rod-like liquid crystal compound/disk-like liquid crystal compound” in the thickness direction from the bottom to the top in the drawing.

In addition, the number, order, and thickness of the regions consisting of the rod-like liquid crystal compound 218 and the regions consisting of the disk-like liquid crystal compound 240 may be appropriately changed under the condition that the sum of the Δnd of each of the liquid crystal layers and the twisted angle of the liquid crystal compound does not change.

As conceptually shown in FIG. 5, in a bandpass filter using the above-described liquid crystal polarization interference element 216, in a case where light is incident from an oblique direction, a wavelength shift occurs in which a transmission wavelength range moves to a short wavelength side.

On the other hand, as in the liquid crystal polarization interference element 246, the first liquid crystal layer 232 and the second liquid crystal layer 234 each have the region consisting of the rod-like liquid crystal compound 218 and the region consisting of the disk-like liquid crystal compound 240, so that the phase difference (Rth) in the thickness direction of the first liquid crystal layer 232 and the second liquid crystal layer 234 can be reduced, and the wavelength shift (coloring) in a case where light is incident from an oblique direction can be suppressed. That is, even in a case where circularly polarized light is incident from a direction inclined from the normal direction of the surface of the optical component 230, only circularly polarized light in a specific wavelength range of interest can be converted into circularly polarized light having an opposite turning direction.

In a case where the first liquid crystal layer 232 and the second liquid crystal layer 234 each are composed of a region consisting of the rod-like liquid crystal compound 218 and a region consisting of the disk-like liquid crystal compound 240, a ratio of a thickness of the region consisting of the rod-like liquid crystal compound 218 to a thickness of the region consisting of the disk-like liquid crystal compound 240 is not limited.

Here, in a case where the first liquid crystal layer 232 and the second liquid crystal layer 234 each are composed of a region consisting of the rod-like liquid crystal compound 218 and a region consisting of the disk-like liquid crystal compound 240, the Δnd of the liquid crystal layer is preferably divided into two equal parts between the region consisting of the rod-like liquid crystal compound 218 and the region consisting of the disk-like liquid crystal compound 240, according to the Δn of the liquid crystal compound used.

In addition, the Δn of the rod-like liquid crystal compound 218 and the disk-like liquid crystal compound 240 are preferably the same value from the viewpoint of reducing interfacial reflection, but the rod-like liquid crystal compound 218 and the disk-like liquid crystal compound 240 having different Δn may be used.

The liquid crystal polarization interference element 246 consisting of liquid crystal layers having such a region consisting of the rod-like liquid crystal compound 218 and such a region consisting of the disk-like liquid crystal compound 240 can also be formed by a coating method using a composition which forms the region consisting of the rod-like liquid crystal compound 218 in the first liquid crystal layer 232, a composition which forms the region consisting of the disk-like liquid crystal compound 240 in the first liquid crystal layer 232, a composition which forms the region consisting of the disk-like liquid crystal compound 240 in the second liquid crystal layer 234, and a composition which forms the region consisting of the rod-like liquid crystal compound 218 in the second liquid crystal layer 234, as in the above description.

In a case where the region consisting of the disk-like liquid crystal compound 240 is formed on the region consisting of the rod-like liquid crystal compound 218, and in a case where the region consisting of the rod-like liquid crystal compound 218 is formed on the region consisting of the disk-like liquid crystal compound 240, the liquid crystal compound in the region formed on the upper side follows the alignment direction (longitudinal direction) of the liquid crystal compound in the region on the lower side, as in the above description.

Accordingly, as described above, in the liquid crystal layer having the region consisting of the rod-like liquid crystal compound 218 and the region consisting of the disk-like liquid crystal compound 240, the liquid crystal compound is also continuously twisted and aligned in the thickness direction in one liquid crystal layer, and the alignment directions of the liquid crystal compound are parallel to each other at an interface between the first liquid crystal layer 232 and the second liquid crystal layer 234.

In the present invention, as described above, the direct lamination of the liquid crystal layers (regions) by the coating method may be used, or sheet-like liquid crystal layers may be laminated and bonded with OCA or the like.

In addition, in the present invention, the liquid crystal layer set each consisting of the first liquid crystal layer 232 and the second liquid crystal layer 234 may be formed at once by applying a composition containing the disk-like liquid crystal compound 240 and the rod-like liquid crystal compound 218.

In the present invention, in a case where the first liquid crystal layer 232 and the second liquid crystal layer 234 have the region consisting of the disk-like liquid crystal compound 240, the disk-like liquid crystal compound to be used is not limited, and various known compounds can be used.

As the disk-like liquid crystal compound, for example, compounds described in JP2007-108732A, JP2010-244038A, and the like can be preferably used.

In a case where the disk-like liquid crystal compound is used in the liquid crystal layer, the liquid crystal compound 240 rises in the thickness direction in the liquid crystal layer as shown in FIG. 4, and the optical axis derived from the liquid crystal compound is defined as an axis perpendicular to a disc plane, that is, a so-called fast axis.

In addition, both the first liquid crystal layer 232 and the second liquid crystal layer 234 shown in FIG. 4 have one region consisting of the rod-like liquid crystal compound 218 and one region consisting of the disk-like liquid crystal compound 240; but the present invention is not limited thereto.

That is, in the present invention, in a case where the first liquid crystal layer and the second liquid crystal layer each have a region consisting of a rod-like liquid crystal compound and a region consisting of a disk-like liquid crystal compound, one liquid crystal layer may have a plurality of the regions consisting of a rod-like liquid crystal compound and/or a plurality of the regions consisting of a disk-like liquid crystal compound.

The twisted angle and twisted direction of the liquid crystal compound in the first liquid crystal layer 232 and the second liquid crystal layer 234 constituting the liquid crystal polarization interference element 246 can be detected by obliquely cutting the liquid crystal polarization interference element 246 and analyzing the alignment direction of the liquid crystals on the surface of the cross section. The method is described in detail in the above-described document written by Yohei Takahashi et al.

In the optical component according to the embodiment of the present invention, the first liquid crystal layer and the second liquid crystal layer may contain an infrared absorbing colorant.

In a case where the first liquid crystal layer and the second liquid crystal layer contain an infrared absorbing colorant, it is possible to make liquid crystal wavelength dispersion in the liquid crystal layer to be strongly normal dispersion. As a result, it is possible to narrow the wavelength range of light on which the liquid crystal polarization interference element functions as a λ/2 wavelength plate. That is, by adding the infrared absorbing colorant to the first liquid crystal layer and the second liquid crystal layer and setting the liquid crystal wavelength dispersion in the liquid crystal layer to strong normal dispersion, it is possible to obtain an optical component having a narrower wavelength range in which circularly polarized light is converted into circularly polarized light having an opposite turning direction.

As the infrared absorbing colorant, various infrared absorbing colorants, which can reduce the difference in refractive index between the x direction and the y direction by being aligned in the same direction as the liquid crystal compound, can be used.

The infrared absorbing colorant is not particularly limited as long as it is a colorant which absorbs infrared rays (for example, light having a wavelength of 700 to 900 nm). Among these, the infrared absorbing colorant is preferably a dichroic colorant. The dichroic colorant refers to a colorant having properties in which an absorbance of the molecule in a major axis direction is different from that in a minor axis direction.

As the infrared absorbing colorant, a diketopyrrolopyrrole-based colorant, a diimmonium-based colorants, a phthalocyanine-based colorant, a naphthalocyanine-based colorant, an azo-based colorant, a polymethine-based colorant, an anthraquinone-based colorant, a pyrylium-based colorant, a squarylium-based colorant, a triphenylmethane-based colorant, a cyanine-based colorant, an aminium-based colorants, or the like can be used.

In addition, as the infrared absorbing colorant, metal complex colorants or boron complex-based colorants can also be used.

The infrared absorbing colorant is described in detail in WO2019/044859A.

An amount of the infrared absorbing colorant to be added in the first liquid crystal layer and the second liquid crystal layer is not particularly limited and may be appropriately set depending on the width of the wavelength range required for the optical component in which circularly polarized light is converted into circularly polarized light having an opposite turning direction.

In the optical component according to the embodiment of the present invention, the first liquid crystal layer and the second liquid crystal layer may contain a liquid crystal elastomer.

With regard to the first liquid crystal layer and the second liquid crystal layer containing a liquid crystal elastomer, the liquid crystal layer may be formed of the liquid crystal elastomer, or the liquid crystal layer formed of a usual liquid crystal compound which is not an elastomer may contain the liquid crystal elastomer.

As described above, in a case where the first liquid crystal layer and the second liquid crystal layer contain the liquid crystal elastomer, the first liquid crystal layer and the second liquid crystal layer can have elasticity, and thus the thickness of the liquid crystal layer can be changed by stretching or contracting the optical component in the plane direction.

The Δnd of the liquid crystal layer can be changed by changing the thickness of the liquid crystal layer. As a result, in the optical component, it is possible to change the wavelength range of light for converting circularly polarized light into circularly polarized light having an opposite turning direction. That is, by containing the liquid crystal elastomer in the first liquid crystal layer and the second liquid crystal layer, the wavelength range can be varied by stretching and contracting the liquid crystal layer, that is, the optical component, and active wavelength control can be performed in the optical component.

The liquid crystal elastomer is not limited, and various known liquid crystal elastomers can be used.

As the liquid crystal elastomer, for example, a liquid crystal elastomer prepared using a liquid crystal monomer, a chiral agent, a crosslinking agent, and a plasticizer, as described in JP2020-131638A, can be used. As a result, mechanical properties are imparted and rubber elasticity is provided to the liquid crystal elastomer, which makes deformation according to an external force which is necessary for the active wavelength control possible.

In a case where the first liquid crystal layer and the second liquid crystal layer are formed of a usual liquid crystal compound which is not an elastomer and the elasticity is imparted by adding the liquid crystal elastomer, an amount of the liquid crystal elastomer to be added is not limited and may be appropriately set according to the required elasticity, that is, the control range of the wavelength range for converting circularly polarized light into circularly polarized light having an opposite turning direction.

Such an optical component according to the embodiment of the present invention can be used at any wavelength. That is, the optical component according to the embodiment of the present invention can be used for any electromagnetic waves such as ultraviolet rays, visible light, infrared rays, terahertz waves, and millimeter waves.

Hereinbefore, the optical component according to the embodiment of the present invention has been described in detail, but the present invention is not limited to the above-described examples and various improvements and changes can be made without departing from the spirit of the present invention.

### [First λ/4 Plate and Second λ/4 Plate]

The optical component according to the embodiment of the present invention includes a first λ/4 plate and a second λ/4 plate.

As described above, the first λ/4 plate and the second λ/4 plate are plates having a function of converting linearly polarized light having a specific wavelength into circularly polarized light (or converting circularly polarized light into linearly polarized light). The first λ/4 plate 212 and the second λ/4 plate 214 are not particularly limited, and a known λ/4 plate can be used.

An in-plane retardation Re(550) of the first λ/4 plate 212 and the second λ/4 plate 214 at a wavelength of 550 nm is preferably 100 to 200 nm, more preferably 120 to 160 nm, and still more preferably 130 to 150 nm.

The λ/4 plate may consist of one layer or two or more layers. The λ/4 plate preferably has a layer containing a liquid crystal compound. In a case where the λ/4 plate has a layer containing a liquid crystal compound, the layer containing a liquid crystal compound may be a layer formed by immobilizing the liquid crystal compound horizontally aligned in one direction, or may be a layer formed by immobilizing the liquid crystal compound twist-aligned in the thickness direction.

In addition, the λ/4 plate may be a so-called broadband λ/4 plate in which a layer generating a λ/4 phase difference and a layer generating a λ/2 phase difference are laminated.

Among these, it is preferable that at least one of the first λ/4 plate 212 or the second λ/4 plate 214 is a laminate consisting of a liquid crystal layer A formed by immobilizing a liquid crystal compound twist-aligned in the thickness direction and a liquid crystal layer B formed by immobilizing a liquid crystal compound twist-aligned in the thickness direction. In addition, it is more preferable that the first λ/4 plate 212 and the second λ/4 plate 214 are the laminate consisting of the above-described liquid crystal layer A and the above-described liquid crystal layer B.

In addition, in a case where the first λ/4 plate 212 is a laminate consisting of the above-described liquid crystal layer A and the above-described liquid crystal layer B, it is preferable that the alignment direction of the liquid crystal compound in the surface of the first λ/4 plate 212 on the first liquid crystal layer 220 side is parallel to the alignment direction of the liquid crystal compound in the surface of the first liquid crystal layer 220 on the first λ/4 plate 212 side.

In addition, in a case where the second λ/4 plate 214 is a laminate consisting of the above-described liquid crystal layer A and the above-described liquid crystal layer B, it is preferable that the alignment direction of the liquid crystal compound in the surface of the second λ/4 plate 214 on the second liquid crystal layer 224 side is parallel to the alignment direction of the liquid crystal compound in the surface of the second liquid crystal layer 224 on the second λ/4 plate 214 side.

Hereinafter, preferred aspects (first aspect and second aspect) of the λ/4 plate will be described.

### First Aspect

A first aspect of the λ/4 plate preferably used in the optical component according to the embodiment of the present invention is a laminate consisting of a liquid crystal layer A formed by immobilizing a liquid crystal compound twist-aligned in the thickness direction and a liquid crystal layer B formed by immobilizing a liquid crystal compound twist-aligned in the thickness direction.

Here, in the first aspect, a twisted direction of the liquid crystal compound in the liquid crystal layer A and a twisted direction of the liquid crystal compound in the liquid crystal layer B are the same, a twisted angle of the liquid crystal compound in the liquid crystal layer A is 26.5°±10.0°, and a twisted angle of the liquid crystal compound in the liquid crystal layer B is 78.6°±10.0°.

In addition, an in-plane slow axis on the surface of the liquid crystal layer A on the liquid crystal layer B side is parallel to an in-plane slow axis on the surface of the liquid crystal layer B on the liquid crystal layer A side.

Furthermore, a value of a product Δn_{A}·d_{A} of a refractive index anisotropy Ana of the liquid crystal layer A measured at a wavelength of 550 nm and a thickness d_{A} of the liquid crystal layer A, and a value of a product Δn_{B}·d_{B} of a refractive index anisotropy Ang of the liquid crystal layer B measured at a wavelength of 550 nm and a thickness d_{B} of the liquid crystal layer B satisfy the following expressions (A1) and (B1).

$$252 nm \leq Δ {n}_{A} \cdot {d}_{A} \leq 312 nm \qquad Expression ( A1 )$$

$$110 nm \leq Δ {n}_{B} \cdot {d}_{B} \leq 170 nm \qquad Expression ( B1 )$$

The twisted angle of the liquid crystal compound in the liquid crystal layer A is preferably 26.5°±8.0° and more preferably 26.5°±6.0°.

The twisted angle of the liquid crystal compound in the liquid crystal layer B is preferably 78.6°±8.0° and more preferably 78.6°±6.0°.

The twisted angle can be measured using AxoScan (polarimeter) device of Axometrics, Inc. and using analysis software of Axometrics, Inc.

In addition, it is preferable that the value of Δn_{A}·d_{A} and the value of Δn_{B}·d_{B} described above satisfy the following expressions (A2) and (B2).

$$262 nm \leq Δ {n}_{A} \cdot {d}_{A} \leq 302 nm \qquad Expression ( A2 )$$

$$120 nm \leq Δ {n}_{B} \cdot {d}_{B} \leq 160 nm \qquad Expression ( B2 )$$

The value of Δn_{A}·d_{A} and the value of Δn_{B}·d_{B} can be measured using AxoScan (polarimeter) device of Axometrics, Inc. and using analysis software of Axometrics, Inc., in the same manner as the method of measuring the twisted angle.

Furthermore, it is more preferable that the value of Δn_{A}·d_{A} and the value of Δn_{B}·d_{B} described above satisfy the following expressions (A3) and (B3).

$$272 nm \leq Δ {n}_{A} \cdot {d}_{A} \leq 292 nm \qquad Expression ( A3 )$$

$$130 nm \leq Δ {n}_{B} \cdot {d}_{B} \leq 150 nm \qquad Expression ( B3 )$$

An alignment film which can regulate the alignment direction of the liquid crystal compound may be disposed between the liquid crystal layer A and the liquid crystal layer B; but from the viewpoint that adhesiveness between the liquid crystal layer A and the liquid crystal layer B is more excellent, it is preferable that the alignment film is not disposed between the liquid crystal layer A and the liquid crystal layer B.

The type of the liquid crystal compound used for forming the liquid crystal layer A and the liquid crystal layer B is not particularly limited. As the liquid crystal layer A and the liquid crystal layer B, for example, a liquid crystal layer obtained by forming a low-molecular-weight liquid crystal compound in a nematic alignment of the liquid crystal state and then immobilizing the compound by photocrosslinking or thermal crosslinking, or a liquid crystal layer obtained by forming a high-molecular-weight liquid crystal compound in a nematic alignment of the liquid crystal state and then cooling the compound to fix the alignment can also be used.

In general, the types of the liquid crystal compound are classified into a rod-shaped type (rod-like liquid crystal compound) and a disk-shaped type (discotic liquid crystal compound) from the shapes thereof. Each of the types can further be classified into a low-molecular-weight type and a high-molecular-weight type. The term “high-molecular-weight” generally refers to a compound having a degree of polymerization of 100 or more (Polymer Physics-Phase Transition Dynamics, written by Masao Doi, p. 2, published by Iwanami Shoten, 1992). In the present invention, any liquid crystal compound can be used, but a rod-like liquid crystal compound or a discotic liquid crystal compound is preferably used. Two or more types of rod-like liquid crystal compounds, two or more types of discotic liquid crystal compounds, or a mixture of a rod-like liquid crystal compound and a discotic liquid crystal compound may be used.

As the rod-like liquid crystal compound, for example, rod-like liquid crystal compounds described in claim 1 of JP1999-513019A (JP-H11-513019A) or paragraphs [0026] to [0098] of JP2005-289980A can be preferably used; and as the discotic liquid crystal compounds, for example, discotic liquid crystal compounds described in paragraphs [0020] to [0067] of JP2007-108732A or paragraphs to of JP2010-244038A can be preferably used, but the liquid crystal compounds are not limited thereto.

It is more preferable that the liquid crystal layer A or the liquid crystal layer B is formed of a rod-like liquid crystal compound or discotic liquid crystal compound having a polymerizable group, because a change in temperature or a change in humidity can be reduced. The liquid crystal compound may also be a mixture of two or more kinds, and in this case, it is preferable that at least one liquid crystal compound has two or more polymerizable groups.

That is, the liquid crystal layer A or the liquid crystal layer B is preferably a layer formed by immobilizing the rod-like liquid crystal compound or discotic liquid crystal compound having a polymerizable group by polymerization or the like; and in this case, it is not necessary to exhibit liquid crystallinity after the formation of the layer.

The type of the polymerizable group included in the discotic liquid crystal compound and the rod-like liquid crystal compound is not particularly limited; and a functional group capable of an addition polymerization reaction is preferable, and a polymerizable ethylenically unsaturated group or a ring polymerizable group is preferable. More specifically, preferred examples thereof include a (meth)acryloyl group, a vinyl group, a styryl group, and an allyl group, and a (meth)acryloyl group is more preferable.

The λ/4 plate can be produced by various methods. An example thereof is as follows.

First, a support such as a polymer film and a glass plate is prepared, an alignment film is formed thereon as necessary, and a composition for forming the liquid crystal layer A, which contains a liquid crystal compound having a polymerizable group and optionally an additive such as a chiral agent, is applied onto a surface of the support or a surface of the alignment film to form a coating film. The coating film is heated as desired to twist-align the molecules of the liquid crystal compound in the coating film, and then cooled to a temperature at which the coating film is solidified, and the polymerization is allowed to proceed by a curing treatment (irradiation with ultraviolet rays (light irradiation treatment) or a heating treatment) to fix the twisted alignment, thereby obtaining the liquid crystal layer A having optical activity. The liquid crystal composition can be applied using a coating liquid of the liquid crystal composition, containing a solvent described later, by a known method (for example, a wire bar coating method, an extrusion coating method, a direct gravure coating method, a reverse gravure coating method, and a die-coating method). In addition, the coating liquid may be jetted and formed using an ink jet device.

Next, a composition for forming the liquid crystal layer B, which contains a liquid crystal compound having a polymerizable group and optionally an additive such as a chiral agent, is applied onto the liquid crystal layer A (or the surface of the alignment film formed thereon as necessary) to form a coating film. Thereafter, the liquid crystal compound having a polymerizable group in an alignment state is subjected to a curing treatment (heating treatment or light irradiation treatment) to form the liquid crystal layer B.

The liquid crystal layer A may be formed by directly applying the composition onto the liquid crystal polarization interference element 216 shown in FIG. 1. In addition, the liquid crystal layer B may be formed by directly applying the composition onto the liquid crystal polarization interference element 216, and then the liquid crystal layer A may be formed on a surface of the liquid crystal layer B opposite to the liquid crystal polarization interference element 216 side.

In a case where the liquid crystal layer A is formed by directly applying the composition onto the liquid crystal polarization interference element 216 as described above, the alignment direction of the liquid crystal compound on the surface of the liquid crystal polarization interference element 216 on the liquid crystal layer A side and is likely to be parallel to the alignment direction of the liquid crystal compound on the surface of the liquid crystal layer A on the liquid crystal polarization interference element 216 side. In addition, in a case where the liquid crystal layer B is formed by directly applying the composition onto the liquid crystal polarization interference element 216, the alignment direction of the liquid crystal compound on the surface of the liquid crystal polarization interference element 216 on the liquid crystal layer B side and is likely to be parallel to the alignment direction of the liquid crystal compound on the surface of the liquid crystal layer B on the liquid crystal polarization interference element 216 side.

It is preferable that the liquid crystal compound aligned (preferably vertically aligned) is immobilized while maintaining the alignment state. The immobilization is preferably performed by a polymerization reaction of the polymerizable group introduced into the liquid crystal compound using a polymerization initiator. The polymerization reaction includes a thermal polymerization reaction using a thermal polymerization initiator and a photopolymerization reaction using a photopolymerization initiator. The photopolymerization reaction is preferable.

An amount of the polymerization initiator used is preferably 0.01% to 20% by mass and more preferably 0.5% to 5% by mass with respect to the solid content of the composition. In a case where the liquid crystal layer A and the liquid crystal layer B are formed, a chiral agent may be used as desired together with the above-described liquid crystal compound as necessary. The chiral agent is added to twist-align the liquid crystal compound, but naturally, it is not necessary to add the chiral agent in a case where the liquid crystal compound is a compound exhibiting optical activity, such as a compound having an asymmetric carbon in a molecule thereof. In addition, it is not necessary to add the chiral agent depending on the production method and the twisted angle.

The chiral agent is not particularly limited in a structure thereof as long as it is compatible with the liquid crystal compound used in combination. Any known chiral agent (for example, described in “Liquid Crystal Device Handbook” edited by the 142nd Committee of the Japan Society for the Promotion of Science, Chapter 3, 4-3, Chiral agents for TN and STN, p. 199, 1989) can be used. The chiral agent generally includes an asymmetric carbon atom, but an axially chiral compound or a planar chiral compound including no asymmetric carbon atom can also be used as the chiral agent. Examples of the axially chiral compound or the planar chiral compound include binaphthyl, helicene, paracyclophane, and derivatives thereof. In addition, the chiral agent may have liquid crystallinity.

By using a plasticizer, a surfactant, a polymerizable monomer, or the like in combination with the above-described liquid crystal compound, the uniformity of the coating film, the strength of the film, the aligning properties of the liquid crystal compound, and the like can be improved. It is preferable that these materials have compatibility with the liquid crystal compound and do not inhibit the alignment.

In order to vertically or horizontally align the liquid crystal compound, an additive (alignment control agent) facilitating the horizontal alignment or the vertical alignment may be used. As the additive, various known additives can be used.

Examples of the polymerizable monomer include radically polymerizable compounds and cationically polymerizable compounds. A polyfunctional radically polymerizable monomer is preferable, and a monomer which is copolymerizable with the above-described liquid crystal compound including a polymerizable group is more preferable. Examples thereof include compounds described in paragraphs [0018] to [0020] of JP2002-296423A. An amount of the above-described compound to be added is generally in a range of 1% to 50% by mass and preferably in a range of 5% to 30% by mass with respect to the liquid crystal compound.

Examples of the surfactant include a known compound in the related art, and a fluorine-based compound is particularly preferable. Specific examples thereof include compounds described in paragraphs to of JP2001-330725A, and compounds described in paragraphs [0069] to [0126] of JP2003-295212.

It is preferable that the polymer used together with the liquid crystal compound can thicken the coating liquid. Examples of the polymer include cellulose ester. Preferred examples of the cellulose ester include those described in paragraph [0178] of JP2000-155216A. An amount of the above-described polymer to be added is preferably in a range of 0.1% to 10% by mass and more preferably in a range of 0.1% to 8% by mass with respect to the liquid crystal compound so as not to inhibit the alignment of the liquid crystal compound.

A discotic nematic liquid crystal phase-solid phase transition temperature of the liquid crystal compound is preferably 70° C. to 300° C. and more preferably 70° C. to 170° C.

As a solvent used for preparing the composition (coating liquid), an organic solvent is preferably used. Examples of the organic solvent include amides (for example, N,N-dimethylformamide), sulfoxides (for example, dimethyl sulfoxide), heterocyclic compounds (for example, pyridine), hydrocarbons (for example, benzene and hexane), alkyl halides (for example, chloroform and dichloromethane), esters (for example, methyl acetate, ethyl acetate, and butyl acetate), ketones (for example, acetone and methyl ethyl ketone), and ethers (for example, tetrahydrofuran and 1,2-dimethoxyethane). An alkyl halide or a ketone is preferable. Two or more kinds of the organic solvents may be used in combination.

In the first aspect, the composition for forming the liquid crystal layer A or the composition for forming the liquid crystal layer B may be applied onto the surface of the alignment film to align the molecules of the liquid crystal compound (for example, the discotic liquid crystal compound).

The alignment film can be provided by methods such as rubbing treatment of an organic compound (preferably a polymer), oblique vapor deposition of an inorganic compound, formation of a layer having microgrooves, or accumulation of an organic compound (for example, @-tricosanoic acid, dioctadecylmethylammonium chloride, or methyl stearate) by the Langmuir-Blodgett method (LB film). Furthermore, there is also known an alignment film capable of expressing an alignment function by application of an electric field, application of a magnetic field, or light (preferably polarized light) irradiation.

The alignment film is preferably formed by a rubbing treatment of a polymer.

Examples of the polymer include a methacrylate-based copolymer, a styrene-based copolymer, polyolefin, polyvinyl alcohol and modified polyvinyl alcohol, poly(N-methylol acrylamide), polyester, polyimide, a vinyl acetate copolymer, carboxymethyl cellulose, and polycarbonate, which are described in paragraph [0022] of JP1996-338913A (JP-H8-338913A). A silane coupling agent can be used as the polymer. A water-soluble polymer (for example, poly(N-methylol acrylamide), carboxymethyl cellulose, gelatin, polyvinyl alcohol, and modified polyvinyl alcohol) is preferable; gelatin, polyvinyl alcohol, or modified polyvinyl alcohol is more preferable; and polyvinyl alcohol or modified polyvinyl alcohol is most preferable.

Basically, the alignment film can be formed by applying a solution containing the above-described polymer which is an alignment film forming material and an optional additive (for example, a crosslinking agent) onto a transparent support, heating and drying (crosslinking) the solution, and rubbing the solution.

As the rubbing treatment, a treatment method widely used as a liquid crystal alignment treatment step of LCD can be adopted. That is, a method of rubbing the surface of the alignment film in a certain direction using paper, gauze, felt, rubber, nylon, polyester fibers, or the like can be used for the alignment. In general, the rubbing is performed approximately several times using a cloth in which fibers having a uniform length and thickness are averaged and tufted.

In a case where the first aspect of the λ/4 plate, which is preferably used in the optical component according to the embodiment of the present invention, is used, it is preferable that the liquid crystal layer A is disposed on the optical laminate side.

### Second Aspect

A second aspect of the λ/4 plate preferably used in the optical component according to the embodiment of the present invention is a laminate consisting of a liquid crystal layer A formed by immobilizing a liquid crystal compound twist-aligned in the thickness direction and a liquid crystal layer B formed by immobilizing a liquid crystal compound twist-aligned in the thickness direction.

Here, in the second aspect, a twisted direction of the liquid crystal compound in the liquid crystal layer A and a twisted direction of the liquid crystal compound in the liquid crystal layer B are the same, a twisted angle of the liquid crystal compound in the liquid crystal layer A is 59.7°±10.0°, and a twisted angle of the liquid crystal compound in the liquid crystal layer B is 127.6°±10.0°.

In addition, an in-plane slow axis on the surface of the liquid crystal layer A on the liquid crystal layer B side is parallel to an in-plane slow axis on the surface of the liquid crystal layer B on the liquid crystal layer A side.

Furthermore, a value of a product Δn_{A}·d_{A} of a refractive index anisotropy Ana of the liquid crystal layer A measured at a wavelength of 550 nm and a thickness d_{A} of the liquid crystal layer A, and a value of a product Δn_{B}·d_{B} of a refractive index anisotropy Ans of the liquid crystal layer B measured at a wavelength of 550 nm and a thickness d_{B} of the liquid crystal layer B satisfy the following expressions (A4) and (B4).

$$111 nm \leq Δ {n}_{A} \cdot {d}_{A} \leq 171 nm \qquad Expression ( A4 )$$

$$252 nm \leq Δ {n}_{B} \cdot {d}_{B} \leq 312 nm \qquad Expression ( B4 )$$

The twisted angle of the liquid crystal compound in the liquid crystal layer A is preferably 59.7°±8.0° and more preferably 59.7°±6.0°.

The twisted angle of the liquid crystal compound in the liquid crystal layer B is preferably 127.6°±8.0° and more preferably 127.6°±6.0°.

The twisted angle can be measured using AxoScan (polarimeter) device of Axometrics, Inc. and using analysis software of Axometrics, Inc.

In addition, it is preferable that the value of Δn_{A}·d_{A} and the value of Δn_{B}·d_{B} described above satisfy the following expressions (A5) and (B5).

$$121 nm \leq Δ {n}_{A} \cdot {d}_{A} \leq 161 nm \qquad Expression ( A5 )$$

$$262 nm \leq Δ {n}_{B} \cdot {d}_{B} \leq 302 nm \qquad Expression ( B5 )$$

The value of Δn_{A}·d_{A} and the value of Δn_{B}·d_{B} can be measured using AxoScan (polarimeter) device of Axometrics, Inc. and using analysis software of Axometrics, Inc., in the same manner as the method of measuring the twisted angle.

Furthermore, it is more preferable that the value of Δn_{A}·d_{A} and the value of Δn_{B}·d_{B} described above satisfy the following expressions (A6) and (B6).

$$131 nm \leq Δ {n}_{A} \cdot {d}_{A} \leq 151 nm \qquad Expression ( A6 )$$

$$272 nm \leq Δ {n}_{B} \cdot {d}_{B} \leq 292 nm \qquad Expression ( B6 )$$

An alignment film which can regulate the alignment direction of the liquid crystal compound may be disposed between the liquid crystal layer A and the liquid crystal layer B; but from the viewpoint that adhesiveness between the liquid crystal layer A and the liquid crystal layer B is more excellent, it is preferable that the alignment film is not disposed between the liquid crystal layer A and the liquid crystal layer B.

Examples of materials constituting the liquid crystal layer A and the liquid crystal layer B include the materials constituting the liquid crystal layer A and the liquid crystal layer B described above.

In addition, the method for producing the liquid crystal layer A and the liquid crystal layer B is not particularly limited, and examples thereof include the above-described method for producing the liquid crystal layer A and the liquid crystal layer B.

In a case where the second aspect of the λ/4 plate, which is preferably used in the optical component according to the embodiment of the present invention, is used, it is preferable that the liquid crystal layer A is disposed on the optical laminate side.

### <Optical Element>

The optical element according to the embodiment of the present invention includes a plurality of optically anisotropic layers which are formed of a composition containing a liquid crystal compound and have a liquid crystal alignment pattern in which an orientation of an optical axis derived from the liquid crystal compound changes while continuously rotating in at least one in-plane direction, and the optical component according to the embodiment of the present invention, which is disposed between at least one pair of adjacent two optically anisotropic layers among the plurality of optically anisotropic layers.

Here, in a case where a length over which the orientation of the optical axis derived from the liquid crystal compound rotates by 180° in the one direction in which the orientation of the optical axis derived from the liquid crystal compound changes while continuously rotating in the liquid crystal alignment pattern of the optically anisotropic layer is set as a single period, at least one layer of the optically anisotropic layers has a length of the single period different from lengths of the single periods of the other optically anisotropic layers.

As described above, the optical component according to the embodiment of the present invention acts as a wavelength selective phase difference plate with respect to circularly polarized light. Hereinafter, the optical component according to the embodiment of the present invention may be referred to as “wavelength selective phase difference plate”.

In the optical element according to the embodiment of the present invention, wavelength dependence of a refraction angle of incident and transmitted light is small, and light components having different wavelengths incident from the same direction can be emitted in almost the same direction.

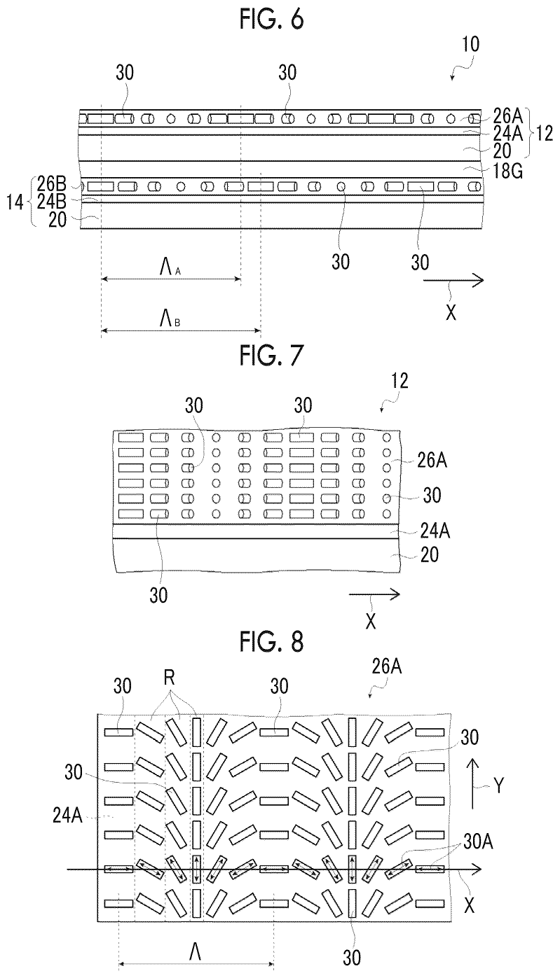

FIG. 6 shows an example of the optical element according to the embodiment of the present invention.

An optical element 10 shown in FIG. 6 includes a first optically anisotropic member 12, a second optically anisotropic member 14, and a wavelength selective phase difference plate 18G which is disposed between the first optically anisotropic member 12 and the second optically anisotropic member 14.

As described above, in the optical element according to the embodiment of the present invention, optically anisotropic layers which are formed of a composition containing a liquid crystal compound and have a predetermined liquid crystal alignment pattern in which an optical axis derived from the liquid crystal compound rotates are arranged in a thickness direction. The first optically anisotropic member 12 includes a support 20, an alignment film 24A, and a first optically anisotropic layer 26A. In addition, the second optically anisotropic member 14 includes the support 20, the alignment film 24B, and the second optically anisotropic layer 26B.

In addition, in the optical element according to the embodiment of the present invention, as described above, the wavelength selective phase difference plate converts circularly polarized light in a specific wavelength range (first wavelength region) into circularly polarized light having an opposite turning direction, and allows transmission (passage) of light in the other second wavelength region. In the optical element 10 of the example shown in the drawing, the wavelength selective phase difference plate 18G converts a turning direction of green circularly polarized light into an opposite turning direction and allows transmission of the other light as circularly polarized light having the same turning direction.

Although not shown in the drawing, the first optically anisotropic member 12 and the wavelength selective phase difference plate 18G, and the wavelength selective phase difference plate 18G and the second optically anisotropic member 14 are bonded to each other through a bonding layer provided therebetween, respectively.

The first optically anisotropic member 12, the wavelength selective phase difference plate 18G, and the second optically anisotropic member 14 may be laminated and held by a frame, a holding device, or the like to form the optical element according to the embodiment of the present invention.

In addition, the optical element according to the embodiment of the present invention is not limited to the configuration in which the first optically anisotropic member 12, the wavelength selective phase difference plate 18G, and the second optically anisotropic member 14 are laminated in contact with each other as in the example shown in the drawing, and a configuration in which the members are arranged in a state where one or more members are spaced from each other may be adopted.

In addition, the optical element 10 of the example shown in the drawing includes the support 20 for each of the optically anisotropic members; but the optical element according to the embodiment of the present invention does not necessarily include the support 20 for each of the optically anisotropic members.

For example, the optical element according to the embodiment of the present invention may have a configuration in which the wavelength selective phase difference plate 18G is formed on a surface of the second optically anisotropic member 14 (second optically anisotropic layer 26B), the alignment film 24A is formed on a surface thereon, and the first optically anisotropic layer 26A is formed thereon.

Alternatively, the support 20 of the second optically anisotropic member 14 may be peeled off from the above-described configuration such that the optical element according to the embodiment of the present invention is configured with only the wavelength selective phase difference plate, the alignment film, and the optically anisotropic layers. In addition, the alignment film may be peeled off from the above-described configuration such that the optical element according to the embodiment of the present invention is configured with only the wavelength selective phase difference plate and the optically anisotropic layers.

That is, in the optical element according to the embodiment of the present invention, various layer configurations can be used as long as the plurality of optically anisotropic layers are arranged, the wavelength selective phase difference plate is disposed between at least one pair of two optically anisotropic layers adjacent to each other among the arranged optically anisotropic layers, the optically anisotropic layer has the liquid crystal alignment pattern in which the orientation of the optical axis derived from the liquid crystal compound rotates in one direction, and the liquid crystal alignment pattern of at least one optically anisotropic layer has different single periods described below.

### [Optically Anisotropic Member]

In the optical element 10 according to the embodiment of the present invention, the wavelength selective phase difference plate 18G is provided between the first optically anisotropic member 12 and the second optically anisotropic member 14.

As described above, the first optically anisotropic member 12 includes the support 20, the alignment film 24A, and the first optically anisotropic layer 26A. In addition, the second optically anisotropic member 14 includes the support 20, the alignment film 24B, and the second optically anisotropic layer 26B.

### (Support)

In the first optically anisotropic member 12 and the second optically anisotropic member 14, the supports 20 support the alignment films 24A and 24B and the first and second optically anisotropic layers 26A and 26B, respectively.

In the following description, in a case where it is not necessary to distinguish between the alignment films 24A and 24B, the alignment films 24A and 24B will also be collectively referred to as “alignment film”. In addition, in the following description, in a case where it is not necessary to distinguish between the first and second optically anisotropic layers 26A and 26B, the first and second optically anisotropic layers 26A and 26B will also be collectively referred to as “optically anisotropic layer”.

As the support 20, various sheet-shaped materials (films or plate-shaped materials) can be used as long as the support can support the alignment film and the optically anisotropic layer.

### (Alignment Film)

In the first optically anisotropic member 12, the alignment film 24A is formed on the surface of the support 20. In the second optically anisotropic member 14, the alignment film 24B is formed on the surface of the support 20.

The alignment film 24A is an alignment film for aligning a liquid crystal compound 30 to a predetermined liquid crystal alignment pattern during the formation of the first optically anisotropic layer 26A in the first optically anisotropic member 12. The alignment film 24B is an alignment film for aligning a liquid crystal compound 30 to a predetermined liquid crystal alignment pattern during the formation of the second optically anisotropic layer 26B in the second optically anisotropic member 14.

As will be described later, in the optical element 10 according to the embodiment of the present invention, the optically anisotropic layer has a liquid crystal alignment pattern in which an orientation of an optical axis 30A (see FIG. 6) derived from the liquid crystal compound 30 changes while continuously rotating in one in-plane direction (arrow X direction described later). Accordingly, the alignment film of each of the optically anisotropic members is formed such that the optically anisotropic layer can form the liquid crystal alignment pattern.

In the optical element according to the embodiment of the present invention, in a case where a length over which the orientation of the optical axis 30A rotates by 180° in the one direction in which the orientation of the optical axis 30A changes while continuously rotating in the liquid crystal alignment pattern is set as a single period (rotation period of the optical axis), at least one of the optically anisotropic layers has a length of the single period different from that of the other optically anisotropic layer. In the optical element 10 shown in FIG. 6, a single period (single period Λ_{A}) of the liquid crystal alignment pattern in the first optically anisotropic layer 26A is shorter than a single period (single period Λ_{B}) of the liquid crystal alignment pattern in the second optically anisotropic layer 26B.

In the following description, “the orientation of the optical axis 30A rotates” will also be simply referred to as “the optical axis 30A rotates”.

As the alignment film, various known films can be used.

Examples of the alignment film include a rubbed film formed of an organic compound such as a polymer, an obliquely deposited film formed of an inorganic compound, a film having a microgroove, and a film formed by lamination of Langmuir-Blodgett (LB) films formed with a Langmuir-Blodgett's method using an organic compound such as @-tricosanoic acid, dioctadecylmethylammonium chloride, or methyl stearate.

The alignment film formed by a rubbing treatment can be formed by rubbing a surface of a polymer layer with paper or fabric in a given direction multiple times.

Preferred examples of the material used for the alignment film include a material for forming polyimide, polyvinyl alcohol, a polymer having a polymerizable group described in JP1997-152509A (JP-H9-152509A), and an alignment film described in JP2005-97377A, JP2005-99228A, and JP2005-128503A.

In the optical element 10 according to the embodiment of the present invention, the alignment film can be suitably used as a so-called photo-alignment film obtained by irradiating a photo-alignable material with polarized light or non-polarized light. That is, in the optical element 10 according to the embodiment of the present invention, a photo-alignment film which is formed by applying a photo-alignment material onto the support 20 is suitably used as the alignment film.

The irradiation of polarized light can be performed in a direction perpendicular or oblique to the photo-alignment film, and the irradiation of non-polarized light can be performed in a direction oblique to the photo-alignment film.

Preferable examples of the photo-alignment material used in the photo-alignment film which can be used in the present invention include: an azo compound described in JP2006-285197A, JP2007-76839A, JP2007-138138A, JP2007-94071A, JP2007-121721A, JP2007-140465A, JP2007-156439A, JP2007-133184A, JP2009-109831A, JP3883848B, and JP4151746B; an aromatic ester compound described in JP2002-229039A; a maleimide- and/or alkenyl-substituted nadiimide compound having a photo-alignable unit described in JP2002-265541A and JP2002-317013A; a photocrosslinking silane derivative described in JP4205195B and JP4205198B, a photocrosslinking polyimide, a photocrosslinking polyamide, or a photocrosslinking ester described in JP2003-520878A, JP2004-529220A, and JP4162850B; and a photodimerizable compound, in particular, a cinnamate compound, a chalcone compound, or a coumarin compound described in JP1997-118717A (JP-H9-118717A), JP1998-506420A (JP-H10-506420A), JP2003-505561A, WO2010/150748A, JP2013-177561A, and JP2014-12823A.

Among these, an azo compound, a photocrosslinking polyimide, a photocrosslinking polyamide, a photocrosslinking ester, a cinnamate compound, or a chalcone compound is suitability used.

A thickness of the alignment film is not particularly limited. The thickness with which a required alignment function can be obtained may be appropriately set depending on the material for forming the alignment film.

The thickness of the alignment film is preferably 0.01 to 5 μm and more preferably 0.05 to 2 μm.

A method for forming the alignment film is not limited, and various known methods can be used depending on the material for forming the alignment film. Examples thereof include a method including: applying the alignment film to a surface of the support 20; drying the applied alignment film; and exposing the alignment film to laser light to form an alignment pattern.

FIG. 17 conceptually shows an example of an exposure device which exposes the alignment film to form an alignment pattern. In the example shown in FIG. 17, for example, the exposure of the alignment film 24A in the first optically anisotropic member 12 is shown, but the alignment film 24B in the second optically anisotropic member 14 can also form the alignment pattern with the same exposure device.

An exposure device 60 shown in FIG. 17 includes a light source 64 including a laser 62, a λ/2 plate (not shown) which changes a polarization direction of a laser light M emitted from the laser 62, a beam splitter 68 which splits the laser light M emitted from the laser 62 and passing through the λ/2 plate (not shown) into two rays MA and MB, mirrors 70A and 70B which are each disposed on an optical path of the splitted two rays MA and MB, and λ/4 plates 72A and 72B.

Although not shown in the drawing, the light source 64 includes a polarizing plate and emits a linearly polarized light P₀. The λ/4 plates 72A and 72B have optical axes orthogonal to each other. The λ/4 plate 72A converts the linearly polarized light P₀ (ray MA) into dextrorotatory circularly polarized light P_{R}, and the λ/4 plate 72B converts the linearly polarized light P₀ (ray MB) into levorotatory circularly polarized light P_{L}.

The support 20 including the alignment film 24A on which the alignment pattern is not yet formed is disposed at an exposed portion, the two rays MA and MB intersect and interfere each other on the alignment film 24A, and the alignment film 24A is irradiated with and exposed to the interference light.

Due to the interference at this time, the polarization state of light with which the alignment film 24A is irradiated periodically changes according to interference fringes. As a result, in the alignment film 24A, an alignment pattern in which the alignment state periodically changes can be obtained.

In the exposure device 60, by changing an intersecting angle α between the two rays MA and MB, a period of the alignment pattern can be adjusted. That is, by adjusting the intersecting angle α in the exposure device 60, in the alignment pattern in which the optical axis 30A derived from the liquid crystal compound 30 continuously rotates in the one direction, the length of single period (single period A) over which the optical axis 30A rotates by 180° in the one direction in which the optical axis 30A rotates can be adjusted.

By forming the optically anisotropic layer on the alignment film having the alignment pattern in which the alignment state periodically changes, as described below, the first optically anisotropic layer 26A having the liquid crystal alignment pattern in which the optical axis 30A derived from the liquid crystal compound 30 continuously rotates in the one direction can be formed.

In addition, by rotating the optical axes of the λ/4 plates 72A and 72B by 90°, respectively, the rotation direction of the optical axis 30A can be reversed.

In the optical element according to the embodiment of the present invention, the alignment film is provided as a preferred aspect and is not an essential configuration requirement.

For example, the following configuration can also be adopted, in which, by forming the alignment pattern on the support 20 using a method of rubbing the support 20, a method of processing the support 20 with laser light or the like, or the like, the first optically anisotropic layer 26A and the like have the liquid crystal alignment pattern in which the orientation of the optical axis 30A derived from the liquid crystal compound 30 changes rotationally in at least one in-plane direction.

### <<Optically Anisotropic Layer>>

In the first optically anisotropic member 12, the first optically anisotropic layer 26A is formed on the surface of the alignment film 24A. In the second optically anisotropic member 14, the second optically anisotropic layer 26B is formed on the surface of the alignment film 24B.

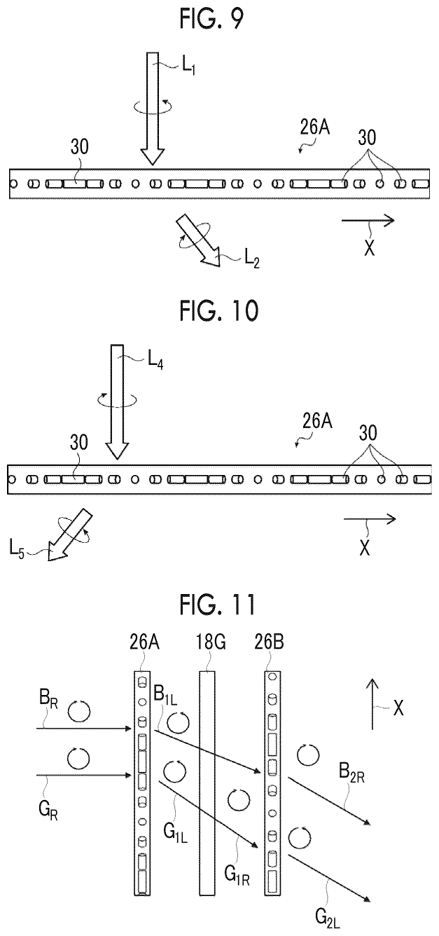

In FIG. 6 (and FIGS. 9 to 11 described later), in order to simplify the drawing and to clarify the configuration of the optical element 10, only liquid crystal compounds 30 (liquid crystal compound molecules) on the surface of the alignment film in the first optically anisotropic layer 26A and the second optically anisotropic layer 26B are shown. However, as conceptually shown in FIG. 7 showing the first optically anisotropic layer 26A, the first optically anisotropic layer 26A and the second optically anisotropic layer 26B have a structure in which the aligned liquid crystal compounds 30 are stacked as in an optically anisotropic layer which is formed of a typical composition containing a liquid crystal compound.

As described above, in the optical element 10 according to the embodiment of the present invention, the optically anisotropic layer (the first optically anisotropic layer 26A and the second optically anisotropic layer 26B) is formed of the composition containing a liquid crystal compound.

In a case where a value of an in-plane retardation is set as λ/2, the optically anisotropic layer has a function as a general λ/2 plate, that is, a function of imparting a phase difference of a half wavelength, that is, 180° to two linearly polarized light components which are included in light incident into the optically anisotropic layer and are orthogonal to each other.

The optically anisotropic layer has the liquid crystal alignment pattern in which the orientation of the optical axis derived from the liquid crystal compound changes while continuously rotating in one direction indicated by arrow X in a plane of the optically anisotropic layer.

The optical axis 30A derived from the liquid crystal compound 30 is an axis having the highest refractive index in the liquid crystal compound 30, that is, a so-called slow axis. For example, in a case where the liquid crystal compound 30 is a rod-like liquid crystal compound, the optical axis 30A is along a major axis direction of the rod shape.

In the following description, “one direction indicated by the arrow X” will also be simply referred to as “arrow X direction”. In addition, in the following description, the optical axis 30A derived from the liquid crystal compound 30 will also be referred to as “optical axis 30A of the liquid crystal compound 30” or “optical axis 30A”.

In the optically anisotropic layer, the liquid crystal compound 30 is two-dimensionally aligned in a plane parallel to the arrow X direction and a Y direction orthogonal to the arrow X direction. In FIGS. 6 and 7 and FIGS. 9 to 11 described later, the Y direction is a direction orthogonal to the paper plane.

FIG. 8 conceptually shows a plan view of the first optically anisotropic layer 26A.

The plan view is a view in a case where the optical element 10 is seen from the top in FIG. 6, that is, a view in a case where the optical element 10 is seen from a thickness direction (=laminating direction of the respective layers (films)). In other words, the plan view is a view in a case where the first optically anisotropic layer 26A is seen from a direction orthogonal to the main surface.

In addition, in FIG. 8, in order to clarify the configuration of the optical element 10 according to the embodiment of the present invention, only the liquid crystal compounds 30 on the surface of the alignment film 24A are shown as in FIG. 3. However, as described above, the first optically anisotropic layer 26A has a structure in which the liquid crystal compounds 30 are stacked in the thickness direction from the liquid crystal compounds 30 on the surface of the alignment film 24A as shown in FIG. 7.

In FIG. 8, the first optically anisotropic layer 26A will be described as a representative example; but the second optically anisotropic layer 26B basically has the same configuration and the same effect as the first optically anisotropic layer 26A, except that the length (single period A) of the single period of the liquid crystal alignment pattern differs as described later.

The rotation directions of the orientations of the optical axes 30A in the first optically anisotropic layer 26A and the second optically anisotropic layer 26B are opposite to each other. That is, in a case where the rotation of the orientation of the optical axis 30A in the first optically anisotropic layer 26A is clockwise, the rotation of the orientation of the optical axis 30A in the second optically anisotropic layer is counterclockwise.

The first optically anisotropic layer 26A has a liquid crystal alignment pattern in which the orientation of the optical axis 30A derived from the liquid crystal compound 30 changes while continuously rotating in the arrow X direction in a plane of the first optically anisotropic layer 26A.

Specifically, the “orientation of the optical axis 30A of the liquid crystal compound 30 changes while continuously rotating in the arrow X direction (predetermined one direction)” means that an angle between the optical axis 30A of the liquid crystal compound 30, which is arranged in the arrow X direction, and the arrow X direction varies depending on positions in the arrow X direction, and the angle between the optical axis 30A and the arrow X direction sequentially changes from θ to θ+180° or to θ−180° in the arrow X direction.

A difference between the angles of the optical axes 30A of the liquid crystal compounds 30 adjacent to each other in the arrow X direction is preferably 45° or less, more preferably 15° or less, and still more preferably less than 15°.

Meanwhile, regarding the liquid crystal compound 30 forming the first optically anisotropic layer 26A, the liquid crystal compounds 30 in which the orientations of the optical axes 30A are the same as one another are arranged at equal intervals in the Y direction orthogonal to the arrow X direction, that is, the Y direction orthogonal to one direction in which the optical axes 30A continuously rotate.

In other words, regarding the liquid crystal compound 30 forming the first optically anisotropic layer 26A, in the liquid crystal compounds 30 arranged in the Y direction, angles between the orientations of the optical axes 30A and the arrow X direction are the same.

In the optical element 10 according to the embodiment of the present invention, in such a liquid crystal alignment pattern of the liquid crystal compound 30, the length (distance) over which the optical axis 30A of the liquid crystal compound 30 rotates by 180° in the arrow X direction in which the orientation of the optical axis 30A changes rotationally in a plane is defined as a length A of the single period in the liquid crystal alignment pattern. In other words, the length of the single period in the liquid crystal alignment pattern is defined as the distance between θ and θ+180° that is a range of the angle between the optical axis 30A of the liquid crystal compound 30 and the arrow X direction.

That is, in the arrow X direction, a distance between centers of two liquid crystal compounds 30 having the same angle with respect to the arrow X direction is set as the length A of the single period. Specifically, as shown in FIG. 8, the distance between the centers of two liquid crystal compounds 30 in which the arrow X direction and the direction of the optical axis 30A coincide with each other in the arrow X direction is set as the length A of the single period. In the description below, the length A of the single period is also referred to as “single period A”.

In addition, in the following description, in order to distinguish between the single periods A of the respective optically anisotropic layers, the single period A of the first optically anisotropic layer 26A will also be referred to as “A_{A}”, and the single period A of the second optically anisotropic layer 26B will also be referred to as “A_{B}”.

In the liquid crystal alignment pattern of the optically anisotropic layer in the optical element 10 according to the embodiment of the present invention, the single period A is repeated in the arrow X direction, that is, in the one direction in which the orientation of the optical axis 30A changes while continuously rotating.

As described above, in the optically anisotropic layer, the liquid crystal compounds arranged in the Y direction have the same angle between the optical axis 30A and the arrow X direction (one direction in which the orientation of the optical axis of the liquid crystal compound 30 rotates). A region where the liquid crystal compounds 30 in which the angles between the optical axes 30A and the arrow X direction are the same are arranged in the Y direction will be referred to as a region R.

In this case, it is preferable that an in-plane retardation (Re) value of each of the regions R is a half wavelength, that is, λ/2. The in-plane retardation is calculated from a product of a difference in refractive index Δn due to refractive index anisotropy of the region R and a thickness of the optically anisotropic layer. Here, a difference in refractive index due to the refractive index anisotropy of the regions R in the optically anisotropic layer is defined by a difference between a refractive index of a direction of an in-plane slow axis of the region R and a refractive index of a direction orthogonal to the direction of the slow axis. That is, the difference Δn in refractive index due to the refractive index anisotropy of the regions R is the same as a difference between a refractive index of the liquid crystal compound 30 in the direction of the optical axis 30A and a refractive index of the liquid crystal compound 30 in a direction perpendicular to the optical axis 30A in a plane of the region R. That is, the above-described difference in refractive index Δn is the same as the difference in refractive index of the liquid crystal compound.

In a case where circularly polarized light is incident into the optically anisotropic layer (the first optically anisotropic layer 26A and the second optically anisotropic layer 26B), the light is refracted such that the direction of the circularly polarized light is converted. This action is conceptually shown in FIG. 9 using the first optically anisotropic layer 26A. In the first optically anisotropic layer 26A, a product of the difference in refractive index of the liquid crystal compound and the thickness of the optically anisotropic layer is set to λ/2.

As shown in FIG. 9, in a case where the value of the product of the difference in refractive index of the liquid crystal compound of the first optically anisotropic layer 26A and the thickness of the optically anisotropic layer is λ/2 and an incidence ray L₁ as levorotatory circularly polarized light is incident into the first optically anisotropic layer 26A, the incidence ray L₁ is transmitted through the first optically anisotropic layer 26A to be imparted with a retardation of 180°, and a transmitted ray L₂ is converted into dextrorotatory circularly polarized light.

On the other hand, as conceptually shown in FIG. 10, in a case where the value of the product of the difference in refractive index of the liquid crystal compound of the first optically anisotropic layer 26A and the thickness of the optically anisotropic layer is λ/2 and an incidence ray La as dextrorotatory circularly polarized light is incident into the first optically anisotropic layer 26A, the incidence ray La is transmitted through the first optically anisotropic layer 26A to be imparted with a retardation of 180°, and a transmitted ray L₅ is converted into levorotatory circularly polarized light.

In the first optically anisotropic layer 26A, it is preferable that the in-plane retardation value of the plurality of the regions R is a half wavelength, and it is preferable that an in-plane retardation Re(550)=Δn₅₅₀×d of the plurality of the regions R of the first optically anisotropic layer 26A with respect to an incidence ray having a wavelength of 550 nm is in a range defined by the following expression (1). Here, Δn₅₅₀ is a difference in refractive index due to the refractive index anisotropy of the region R in a case where the wavelength of the incidence ray is 550 nm, and d represents a thickness of the first optically anisotropic layer 26A.

$$200 nm \leq Δ {n}_{550} \times d \leq 350 nm \qquad ( 1 )$$

That is, in a case where the “in-plane retardation Re(550)=Δn₅₅₀×d” of the plurality of the regions R of the first optically anisotropic layer 26A satisfies the expression (1), a sufficient amount of circularly polarized light components of light which has been incident into the first optically anisotropic layer 26A can be converted into circularly polarized light traveling in a direction tilted in a forward or backward direction with respect to the arrow X direction. It is more preferable that the in-plane retardation Re(550)=Δn₅₅₀×d is 225 nm≤Δn₅₅₀×d≤340 nm, and it is still more preferable to be 250 nm≤Δn₅₅₀×d≤330 nm.

The expression (1) is a range with respect to the incidence ray having a wavelength of 550 nm, but an in-plane retardation Re(2)=Δn_{λ}×d of the plurality of the regions R of the optically anisotropic layer with respect to an incidence ray having a wavelength of λ nm is preferably in a range defined by the following expression (1-2), and can be appropriately set.

$$0.7 λ nm \leq Δ {n}_{λ} \times d \leq 1.3 λ nm \qquad ( 1 - 2 )$$

In addition, a value of the in-plane retardation of the plurality of the regions R of the first optically anisotropic layer 26A in a range outside the range of the expression (1) can also be used. Specifically, by adopting Δn₅₅₀×d<200 nm or 350 nm<Δn₅₅₀×d, light can be classified into light which travels in the same direction as a traveling direction of the incidence ray and light which travels in a direction different from a traveling direction of the incidence ray. In a case where Δn₅₅₀×d approaches 0 nm or 550 nm, the light component traveling in the same direction as the traveling direction of the incidence ray increases, and the light component traveling in a direction different from the traveling direction of the incidence ray decreases.

Furthermore, it is preferable that an in-plane retardation Re(450)=Δn₄₅₀×d of each of the regions R of the first optically anisotropic layer 26A with respect to an incidence ray having a wavelength of 450 nm and an in-plane retardation Re(550)=Δn₅₅₀×d of each of the regions R of the first optically anisotropic layer 26A with respect to an incidence ray having a wavelength of 550 nm satisfy the following expression (2). Here, Δn₄₅₀ represents a difference in refractive index due to the refractive index anisotropy of the region R in a case where the wavelength of the incidence ray is 450 nm.

$$( {Δn}_{450} \times d ) / ( Δ {n}_{550} \times d ) < 1. \qquad ( 2 )$$

The expression (2) represents that the liquid crystal compound 30 contained in the first optically anisotropic layer 26A has reverse dispersibility. That is, by satisfying the expression (2), the first optically anisotropic layer 26A can respond to incident light having a wide wavelength range.

Here, by changing the single period A of the liquid crystal alignment pattern formed in the first optically anisotropic layer 26A, refraction angles of the transmitted rays L₂ and L₅ can be adjusted. Specifically, as the single period A of the liquid crystal alignment pattern decreases, light transmitted through the liquid crystal compounds 30 adjacent to each other more strongly interfere with each other, so that the transmitted rays L₂ and L₅ can be more largely refracted.

In addition, the refraction angles of the transmitted rays L₂ and L₅ with respect to the incidence rays L₁ and L₄ vary depending on the wavelengths of the incidence rays L₁ and L₄ (the transmitted rays L₂ and L₅). Specifically, as the wavelength of incidence light increases, the transmitted rays are largely refracted. That is, in a case where the incidence light is red light, green light, and blue light, the red light is refracted to the highest degree, and the blue light is refracted to the lowest degree.

Furthermore, by reversing a rotation direction of the optical axis 30A of the liquid crystal compound 30 which rotates in the arrow X direction, a refraction direction of the transmitted ray can be reversed.

The optically anisotropic layer includes a cured layer of a liquid crystal composition containing a rod-like liquid crystal compound or a disk-like liquid crystal compound, and has a liquid crystal alignment pattern in which an optical axis of the rod-like liquid crystal compound or an optical axis of the disk-like liquid crystal compound is aligned as described above.

The optically anisotropic layer including the cured layer of the liquid crystal composition can be obtained by forming the alignment film on the support 20, coating the alignment film with the liquid crystal composition, and curing the liquid crystal composition. The optically anisotropic layer functions as a so-called λ/2 plate, but in the present invention, an aspect in which a laminate integrally including the support 20 and the alignment film functions as the λ/2 plate is included.

The liquid crystal composition for forming the optically anisotropic layer contains a rod-like liquid crystal compound or a disk-like liquid crystal compound, and may further contain other components such as a leveling agent, an alignment control agent, a polymerization initiator, and an alignment assistant.

In addition, it is preferable that the optically anisotropic layer has a wide range for the wavelength of incident light, and is formed of a liquid crystal material having a reverse birefringence index dispersion. In addition, it is also preferable that the optically anisotropic layer can be made to have a substantially wide range for the wavelength of incidence light by imparting a torsion component to the liquid crystal composition or by laminating different retardation layers. For example, in the optically anisotropic layer, a method of realizing a λ/2 plate having a wide-range pattern by laminating two liquid crystal layers having different twisted directions is described in, for example, JP2014-089476A and can be preferably used in the present invention.

### —Rod-Like Liquid Crystal Compound—

As the rod-like liquid crystal compound, azomethines, azoxys, cyano biphenyls, cyanophenyl esters, benzoic acid esters, cyclohexane carboxylic acid phenyl esters, cyanophenyl cyclohexanes, cyano-substituted phenyl pyrimidines, alkoxy-substituted phenyl pyrimidines, phenyl dioxanes, tolanes, and alkenylcyclohexylbenzonitriles are preferably used. In addition to the above-described low-molecular-weight liquid crystal molecules, a high-molecular-weight liquid crystal molecular can also be used.

It is preferable that the alignment of the rod-like liquid crystal compound is fixed by polymerization, and examples of the polymerizable rod-like liquid crystal compound include compounds described in Makromol. Chem., (1989), Vol. 190, p. 2255, Advanced Materials (1993), Vol. 5, p. 107, U.S. Pat. Nos. 4,683,327A, 5,622,648A, 5,770,107A, WO95/22586A, WO95/24455A, WO97/00600A, WO98/23580A, WO98/52905A, JP1989-272551A (JP-H1-272551A), JP1994-16616A (JP-H6-16616A), JP1995-110469A (JP-H7-110469A), JP1999-80081A (JP-H11-80081A), and JP2001-64627A. Furthermore, as the rod-like liquid crystal compound, for example, compounds described in JP1999-513019A (JP-H11-513019A) and JP2007-279688A can also be preferably used.

### —Disk-Like Liquid Crystal Compound—

As the disk-like liquid crystal compound, for example, compounds described in JP2007-108732A, JP2010-244038A, and the like can be preferably used.

In a case where a disk-like liquid crystal compound is used in the optically anisotropic layer, the liquid crystal compound 30 rises in the thickness direction in the optically anisotropic layer, and the optical axis 30A derived from the liquid crystal compound is defined as an axis perpendicular to a disc plane, that is, a so-called fast axis (see FIG. 20).

### [Wavelength Selective Phase Difference Plate]

In the optical element 10 according to the embodiment of the present invention, the wavelength selective phase difference plate 18G is provided between the first optically anisotropic member 12 and the second optically anisotropic member 14.

In the optical element according to the embodiment of the present invention, the wavelength selective phase difference plate is a member which converts circularly polarized light in a specific wavelength range into circularly polarized light having an opposite turning direction.

In the optical element of the example shown in the drawing, the wavelength selective phase difference plate 18G selectively converts green circularly polarized light into circularly polarized light having an opposite turning direction, converts green dextrorotatory circularly polarized light into green levorotatory circularly polarized light, converts green levorotatory circularly polarized light into green dextrorotatory circularly polarized light, and allows transmission (passage) of the other light in a state where a turning direction thereof is maintained.

In other words, the wavelength selective phase difference plate shifts only a phase in a specific wavelength range by π. The wavelength selective phase difference plate will also be referred to as, for example, a λ/2 plate which acts only in a specific wavelength range.

The wavelength selective phase difference plate (optical component) is as described above.

### [Action of Optical Element]

As described above, the optically anisotropic layer which is formed of the composition containing a liquid crystal compound and has the liquid crystal alignment pattern in which the direction of the optical axis 30A rotates in the arrow X direction refracts circularly polarized light, in which a refraction angle varies depending on the wavelength of light. Specifically, as the wavelength of light increases, the refraction angle increases. Accordingly, for example, in a case where the incidence light is red light, green light, and blue light, the red light is refracted to the highest degree, and the blue light is refracted to the lowest degree.

Therefore, for example, in a light guide plate of AR glasses, in a case where the optical element which includes the optically anisotropic layer having the above-described liquid crystal alignment pattern in which the orientation of the optical axis 30A rotates is used as a diffraction element for incidence and emission of light into the light guide plate, in the case of a full color image, an image having a so-called color shift in which reflection directions of red light, green light, and blue light are different from each other and a red image, a green image, and a blue image do not match each other is observed.

Here, for example, as described in Bernard C. Kress et al., Towards the Ultimate Mixed Reality Experience: HoloLens Display Architecture Choices, SID 2017 DIGEST, pp. 127 to 131, the color shift can be eliminated by providing a light guide plate corresponding to each of a red image, a green image, and a blue image and laminating three light guide plates. However, in the configuration, the light guide plate is thick and heavy as a whole, and the configuration is also complicated.

On the other hand, in the optical element according to the embodiment of the present invention, a plurality of optically anisotropic layers are arranged, the wavelength selective phase difference plate is disposed between at least one pair of two optically anisotropic layers adjacent to each other among the arranged optically anisotropic layers, the optically anisotropic layer has the liquid crystal alignment pattern in which the orientation of the optical axis derived from the liquid crystal compound rotates in one direction, and a single period in the liquid crystal alignment pattern of at least one optically anisotropic layer is different from that of the other optically anisotropic layers.

With the optical element according to the embodiment of the present invention, the wavelength dependence of the refraction angle of light is significantly reduced, light components having different wavelengths can be refracted to be transmitted and emitted substantially in the same direction. Therefore, by using the optical element according to the embodiment of the present invention (for example, an optical element 32 described later) as a diffraction element for incidence of light from the light guide plate and/or as a diffraction element for emission of light into the light guide plate, for example, in AR glasses, a red image, a green image, and a blue image can be propagated by one light guide plate without the occurrence of a color shift, and as a result, an appropriate image can be displayed to a user.

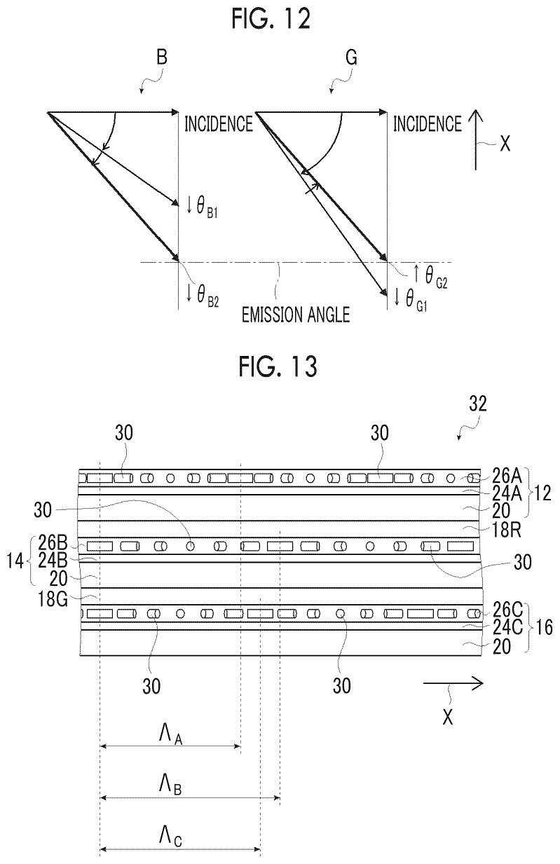

Hereinafter, the action of the optical element 10 will be described in detail with reference to the conceptual diagrams of FIGS. 11 and 12.

In the optical element according to the embodiment of the present invention, basically, only the optically anisotropic layer and the wavelength selective phase difference plate exhibit an optical action. Therefore, in order to simplify the drawing and to clarify the configuration and the effect, in FIG. 11 (and FIG. 12 described later), only the first optically anisotropic layer 26A and the second optically anisotropic layer 26B in the first optically anisotropic member 12 and the second optically anisotropic member 14 are shown, and the members shown in the drawing are spaced from each other in the arrangement direction.

As described above, in the optical element 10, the wavelength selective phase difference plate 18G which converts a turning direction of green circularly polarized light into an opposite direction is provided between the first optically anisotropic member 12 including the first optically anisotropic layer 26A and the second optically anisotropic member 14 including the second optically anisotropic layer 26B.

For example, the optical element 10 refracts incidence light to be transmitted in a predetermined direction, the incidence light including blue circularly polarized light and green circularly polarized light. In FIG. 11, the incidence light is dextrorotatory circularly polarized light, but even in a case where the incidence light is levorotatory circularly polarized light, the effect is the same except that the refraction direction is reversed.

In the optical element 10, in a case where green dextrorotatory circularly polarized light G_{R} and blue dextrorotatory circularly polarized light B_{R} (see the incidence ray L₄ in FIG. 10) are incident into the first optically anisotropic layer 26A, as described above, the green dextrorotatory circularly polarized light G_{R} and the blue dextrorotatory circularly polarized light B_{R} are refracted at a predetermined angle in a direction opposite to the arrow X direction with respect to the incidence direction, and are converted into green levorotatory circularly polarized light G_{1L} and blue levorotatory circularly polarized light B_{1L} (see the transmitted ray L₅ in FIG. 10).

Here, as described above, since an angle of refraction of the first optically anisotropic layer 26A is larger for the green light having a longer wavelength, as shown in FIG. 12, an angle θ_{G1} of green light (G) is larger than an angle θ_{B1} of blue light (B) with respect to the incidence light. In addition, regarding the single period A of the optically anisotropic layer, since the single period Λ_{A} of the first optically anisotropic layer 26A is shorter, the refraction angle of each light transmitted through the first optically anisotropic layer 26A is larger than that of light transmitted through the second optically anisotropic layer 26B.

The green levorotatory circularly polarized light G_{1L} and the blue levorotatory circularly polarized light B_{1L}, which are transmitted through the first optically anisotropic layer 26A, are then incident into the wavelength selective phase difference plate 18G.

As described above, the wavelength selective phase difference plate 18G converts only the green circularly polarized light into circularly polarized light having an opposite turning direction, and allows transmission (passage) of the other light in a state where a turning direction thereof is maintained.

Accordingly, in a case where the green levorotatory circularly polarized light Gul. and the blue levorotatory circularly polarized light B_{1L} are incident into and transmitted through the wavelength selective phase difference plate 18G, the blue levorotatory circularly polarized light B_{1L} is transmitted as it is. On the other hand, the green levorotatory circularly polarized light G_{1L} is converted into green dextrorotatory circularly polarized light G_{1R}.

The green dextrorotatory circularly polarized light G_{1R} and the blue levorotatory circularly polarized light B_{1L}, which are transmitted through the wavelength selective phase difference plate 18G, are then incident into the second optically anisotropic layer 26B.

In the same manner, the green dextrorotatory circularly polarized light G_{1R} and the blue levorotatory circularly polarized light B_{1L}, which are incident into the second optically anisotropic layer 26B, are also refracted and converted into circularly polarized light having an opposite turning direction such that green levorotatory circularly polarized light G_{2L} and blue dextrorotatory circularly polarized light B_{2R} are emitted.

Here, turning directions of the green dextrorotatory circularly polarized light G_{1R} and the blue levorotatory circularly polarized light B_{1L}, which are incident into the second optically anisotropic layer 26B, are opposite to each other. In addition, as described above, the rotation directions of the optical axes 30A of the liquid crystal compounds 30 in the first optically anisotropic layer 26A and the second optically anisotropic layer 26B are opposite to each other.

Therefore, as shown in FIGS. 11 and 12, the blue levorotatory circularly polarized light B_{2L} is further refracted in a direction opposite to the arrow X direction, and emitted at an angle θ_{B2} with respect to the incidence light (the blue dextrorotatory circularly polarized light B_{R}) as shown on the left side of FIG. 12.

On the other hand, the turning direction of the green dextrorotatory circularly polarized light G_{1R} is opposite to that of blue light. Therefore, as shown on the right side of FIG. 12, in the second optically anisotropic layer 26B, the light is refracted in the direction indicated by the arrow X which is opposite to that of the first optically anisotropic layer 26A, such that refraction returns to the original state. As a result, the green levorotatory circularly polarized light G_{2L} is emitted at an angle θ_{G2} which is smaller than the first angle θ_{G1} with respect to the incidence light (the green dextrorotatory circularly polarized light G_{R}), and is almost the same as the angle θ_{B2} of the blue levorotatory circularly polarized light B_{2L}.

In this way, in the optical element 10 according to the embodiment of the present invention, green light having a long wavelength and large refraction by the optically anisotropic layer is refracted in a direction opposite to the arrow X direction in the first optically anisotropic layer 26A and then refracted in the arrow X direction in the second optically anisotropic layer 26B, such that refraction returns to the original state. On the other hand, blue light having a short wavelength and small refraction by the optically anisotropic layer is refracted in a direction opposite to the arrow X direction in the first optically anisotropic layer 26A and the second optically anisotropic layer 26B.

That is, in the optical element 10, in accordance with the magnitude of refraction by the optically anisotropic layer depending on the wavelength, light having large refraction and a long wavelength is initially refracted and then secondly refracted in an opposite direction, such that refraction returns to the original state. On the other hand, light having small refraction and a short wavelength is secondly refracted in the same direction as that the direction in which the light is initially refracted. As a result, the refraction angle θ_{G2} of green light and the refraction angle θ_{B2} of blue light with respect to the incidence light can be made to be very close to each other.

Therefore, in the optical element 10 according to the embodiment of the present invention, the incident blue light and green light can be refracted at substantially the same angle and emitted substantially in the same direction.

As described above, the refraction angles of light by the first optically anisotropic layer 26A and the second optically anisotropic layer 26B increase as the wavelength of light increases.

In addition, the refraction angles of light by the first optically anisotropic layer 26A and the second optically anisotropic layer 26B increase as the length of the single period A over which the orientation of optical axis 30A rotates by 180° in the arrow X direction in the liquid crystal alignment pattern decreases. In the optical element 10, for example, as shown in FIG. 6, the single period Λ_{A} of the liquid crystal alignment pattern in the first optically anisotropic layer 26A is shorter than the single period Λ_{B} of the liquid crystal alignment pattern in the second optically anisotropic layer 26B. That is, in the first optically anisotropic layer 26A on the light incidence side, the light is largely refracted.

Accordingly, by adjusting the single period A of the liquid crystal alignment pattern with respect to the wavelength of light as a target, emission directions of light components having different wavelengths can be suitably made to be the same.

In a case where light components having two wavelength ranges are targets as in the optical element 10 of the example shown in the drawing, a designed wavelength of light having a longer wavelength is denoted by λa, a designed wavelength of light having a shorter wavelength is denoted by λb (λa>λb), the single period of the liquid crystal alignment pattern in the first optically anisotropic layer is denoted by Λ₁, and the single period of the liquid crystal alignment pattern in the second optically anisotropic layer is denoted by Λ₂, emission directions of the light components having two wavelength ranges can be made to be substantially the same by satisfying the following expression.

$${Λ}_{2} = [ ( λ a + λ b ) / ( λa - λb ) ] {Λ}_{1}$$

In the expression, any one of the first optically anisotropic layer 26A or the second optically anisotropic layer 26B may be the first layer.

In consideration of this point, in the present invention, it is preferable that the following expression is satisfied in the optical element 10 in which the light components having two wavelengths (wavelength ranges) are targets.

$$0.6 * \{ [ ( λ a + λ b ) / ( λa - λ b ) ] {Λ}_{1} \} \leq {Λ}_{2} \leq 3. * \{ [ λ a + λ b ) / ( λ a - λ b ) ] {Λ}_{1} \}$$

As a result, by significantly reducing the wavelength dependence of refraction, emission directions of the light components having two wavelength ranges can be made to be substantially the same.

In addition, in the present invention, for the light components having two wavelengths (wavelength ranges) as targets, it is more preferable that the optical element 10 satisfies the following expression,

$$0.7 * \{ [ ( λ a + λ b ) / ( λ a - λ b ) ] {Λ}_{1} \} \leq {Λ}_{2} \leq 1.8 * \{ [ ( λ a + λ b ) / ( λ a - λ b ) ] {Λ}_{1} \} ;$$

it is still more preferable to satisfy the following expression,

$$0.8 * \{ [ ( λ a + λ b ) / ( λ a - λ b ) ] {Λ}_{1} \} \leq {Λ}_{2} \leq 1.3 * \{ [ ( λ a + λ b ) / ( λ a - λ b ) ] {Λ}_{1} \} ;$$

and
it is particularly preferable to satisfy the following expression,

$$0.9 * \{ [ ( λ a + λ b ) / ( λ a - λ b ) ] {Λ}_{1} \} \leq {Λ}_{2} \leq 1.15 * \{ [ ( λ a + λ b ) / ( λ a - λ b ) ] {Λ}_{1} \} .$$

### <Second Aspect of Optical Element>

In the above-described optical element 10, the light components having two wavelength ranges (designed wavelengths), including green light and blue light, are targets; but the optical element according to the embodiment of the present invention is not limited thereto, and incidence light including light components having three or more wavelength ranges may be refracted and emitted.

FIG. 13 shows an example of the optical element.

In an optical element 32 shown in FIG. 13, the same members as those of the optical element 10 shown in FIG. 6 are widely used, so that the same members are represented by the same reference numerals, and different members will be mainly described below.

The optical element 32 shown in FIG. 13 further includes a third optically anisotropic member 16 and a wavelength selective phase difference plate 18R, in addition to the first optically anisotropic member 12, the second optically anisotropic member 14, and the wavelength selective phase difference plate 18G of the above-described optical element 10.

The third optically anisotropic member 16 has the same configuration as that of the first optically anisotropic member 12 or the like, and includes a support 20, an alignment film 24C, and a third optically anisotropic layer 26C. The alignment film 24C and the third optically anisotropic layer 26C have the same configurations as those of the alignment film 24a and the first optically anisotropic layer 26A described above, except for the single period Λ.

In addition, the wavelength selective phase difference plate 18R selectively converts red circularly polarized light into circularly polarized light having an opposite turning direction, converts red dextrorotatory circularly polarized light into red levorotatory circularly polarized light, converts red levorotatory circularly polarized light into red dextrorotatory circularly polarized light, and allows transmission of the other light as it is.

In the optical element 32, rotation directions of optical axes 30A of liquid crystal compounds 30 of the first optically anisotropic layer 26A and the third optically anisotropic layer 26C in the arrow X direction are the same as each other, and a rotation direction of an optical axis 30A of a liquid crystal compound 30 of the second optically anisotropic layer 26B in the arrow X direction is opposite to the rotation directions of the other two optically anisotropic layers.

In addition, in the optical element 32, regarding the length of the single period Λ, over which the optical axis 30A of the liquid crystal compound 30 rotates by 180° in the arrow X direction in the liquid crystal alignment pattern, the single period Λ_{A} of the first optically anisotropic layer 26A is the shortest, and the single period Λ_{B} of the second optically anisotropic layer 26B is the longest. In the optical element 32, the first optically anisotropic member 12 side is the light incidence side. That is, in the optical element 32, light is refracted to the highest degree in the first optically anisotropic layer 26A on the light incidence side.

Furthermore, in the optical element 32, the wavelength selective phase difference plate 18R which selectively converts a turning direction of red circularly polarized light is disposed between the first optically anisotropic member 12 (the first optically anisotropic layer 26A) and the second optically anisotropic member 14 (the second optically anisotropic layer 26B). In addition, in the optical element 32, the wavelength selective phase difference plate 18G which selectively converts a turning direction of green circularly polarized light is disposed between the second optically anisotropic member 14 and the third optically anisotropic member 16 (the third optically anisotropic layer 26C).

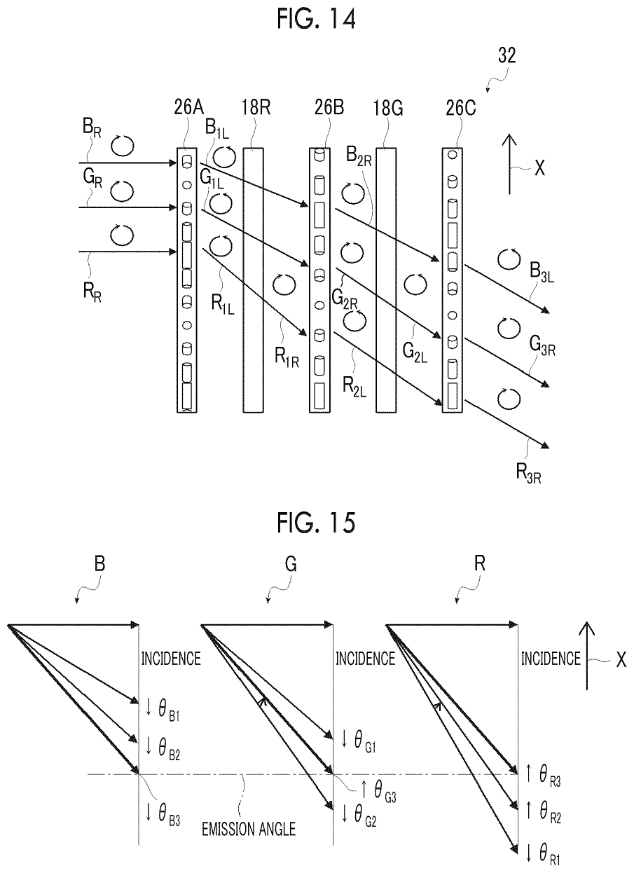

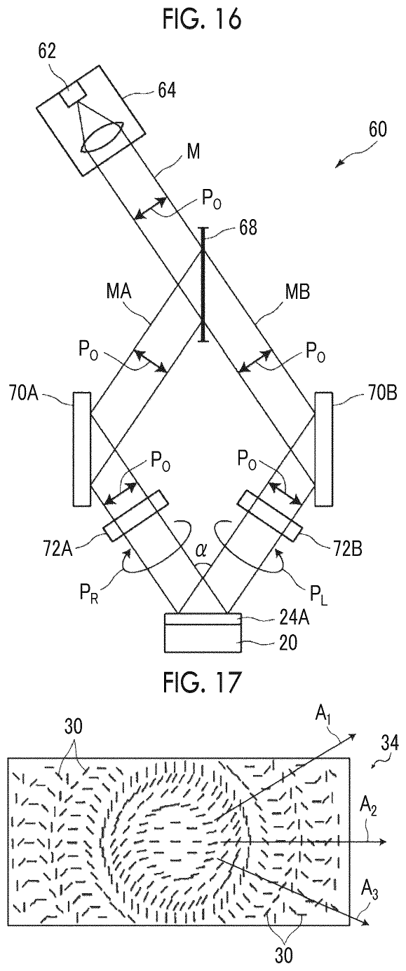

Hereinafter, the action of the optical element 32 will be described in detail with reference to FIGS. 14 and 15.

For example, the optical element 32 refracts incidence light to be transmitted in a predetermined direction, the incidence light including red circularly polarized light, green circularly polarized light, and blue circularly polarized light. In FIG. 14, same as in FIG. 11 described above, the incidence light is dextrorotatory circularly polarized light, but even in a case where the incidence light is levorotatory circularly polarized light, the effect is the same except that the refraction direction is reversed.

In the optical element 10, in a case where red dextrorotatory circularly polarized light R_{R}, green dextrorotatory circularly polarized light G_{R}, and blue dextrorotatory circularly polarized light B_{R} (see the incidence ray L₄ in FIG. 10) are incident into the first optically anisotropic layer 26A, as described above, the red dextrorotatory circularly polarized light R_{R}, the green dextrorotatory circularly polarized light G_{R}, and the blue dextrorotatory circularly polarized light B_{R} are refracted at a predetermined angle in a direction opposite to the arrow X direction with respect to the incidence direction, and are converted into red levorotatory circularly polarized light RIL, green levorotatory circularly polarized light GIL, and blue levorotatory circularly polarized light B_{1L}. (see the transmitted ray L₅ in FIG. 10).

Here, as described above, regarding the refraction angle by the first optically anisotropic layer 26A, the angle of red light having the longest wavelength is the largest, and the angle of blue light having the shortest wavelength is the smallest. Accordingly, regarding the refraction angle with respect to the incidence light, as shown in FIG. 15, an angle θ_{R1} of red light (R) is the largest, an angle θ_{G1} of green light (G) is intermediate, and an angle θ_{B1} of blue light (B) is the smallest. Regarding the single period A of the optically anisotropic layer, since the single period Λ_{A} of the first optically anisotropic layer 26A is the shortest, the refraction angle of each light is the largest in a case of light transmitted through the first optically anisotropic layer 26A.

The red levorotatory circularly polarized light RIL, the green levorotatory circularly polarized light G_{1L}, and the blue levorotatory circularly polarized light B_{1L}, which are transmitted through the first optically anisotropic layer 26A, are then incident into the wavelength selective phase difference plate 18R.

As described above, the wavelength selective phase difference plate 18R converts only the red circularly polarized light into circularly polarized light having an opposite turning direction, and allows transmission (passage) of the other light as it is.

Accordingly, in a case where the red levorotatory circularly polarized light RIL, the green levorotatory circularly polarized light GIL, and the blue levorotatory circularly polarized light B_{1L} are incident into and transmitted through the wavelength selective phase difference plate 18R, the green levorotatory circularly polarized light GIL and the blue levorotatory circularly polarized light B_{1L} are transmitted as they are. On the other hand, the red levorotatory circularly polarized light RIL is converted into red dextrorotatory circularly polarized light RIR.

The red dextrorotatory circularly polarized light RIR, the green levorotatory circularly polarized light GIL, and the blue levorotatory circularly polarized light B_{1L}, which are transmitted through the wavelength selective phase difference plate 18R, are then incident into the second optically anisotropic layer 26B.

In the same manner, the red dextrorotatory circularly polarized light RIR, the green levorotatory circularly polarized light GIL, and the blue levorotatory circularly polarized light B_{1L}, which are incident into the second optically anisotropic layer 26B, are also refracted and converted into circularly polarized light having an opposite turning direction such that red levorotatory circularly polarized light R_{2L}, green dextrorotatory circularly polarized light G_{2R}, and blue dextrorotatory circularly polarized light B_{2R} are emitted.

Here, the green light and the blue light incident into the second optically anisotropic layer 26B are levorotatory circularly polarized light. On the other hand, the red light incident into the second optically anisotropic layer 26B is dextrorotatory circularly polarized light in which a direction of circularly polarized light is converted by the wavelength selective phase difference plate 18R and different from that of the green light and the blue light.

In addition, as described above, the rotation directions of the optical axes 30A of the liquid crystal compounds 30 in the first optically anisotropic layer 26A and the second optically anisotropic layer 26B are opposite to each other.

Therefore, as shown in FIGS. 14 and 15, the green levorotatory circularly polarized light G_{2L} and the blue levorotatory circularly polarized light B_{2L} incident into the second optically anisotropic layer 26B are further refracted in a direction opposite to the arrow X direction, and are emitted at an angle θ_{G2} and an angle θ_{B2} with respect to the incidence light (the green dextrorotatory circularly polarized light G_{R} and the blue dextrorotatory circularly polarized light B_{R}) as shown in FIG. 15.

On the other hand, the red dextrorotatory circularly polarized light RIR having a direction of circularly polarized light opposite to that of circularly polarized light incident into the second optically anisotropic layer 26B is refracted in the arrow X direction which is opposite to that of the first optically anisotropic layer 26A, such that refraction returns to the original state as shown on the right side of FIG. 15. As a result, the red levorotatory circularly polarized light R_{2L} emitted from the second optically anisotropic layer 26B is emitted at an angle θ_{R2} which is smaller than the angle θ_{R1} with respect to the incidence light (the red dextrorotatory circularly polarized light R_{R}).

Regarding the single period Λ of the optically anisotropic layer, since the single period Λ_{B} of the second optically anisotropic layer 26B is the largest, the refraction angle of each light is the shortest in a case of light transmitted through the second optically anisotropic layer 26B.

The red levorotatory circularly polarized light R_{2L}, the green dextrorotatory circularly polarized light G_{2R}, and the blue dextrorotatory circularly polarized light B_{2R}, which are transmitted through the second optically anisotropic layer 26B, are then incident into the wavelength selective phase difference plate 18G.

As described above, the wavelength selective phase difference plate 18G converts only the green circularly polarized light into circularly polarized light having an opposite turning direction, and allows transmission of the other light as it is.

Accordingly, in a case where the red levorotatory circularly polarized light R_{2L}, the green dextrorotatory circularly polarized light G_{2R}, and the blue dextrorotatory circularly polarized light B_{2R} are incident into and transmitted through the wavelength selective phase difference plate 18G, the red levorotatory circularly polarized light R_{2L} and the blue dextrorotatory circularly polarized light B_{2R} are transmitted as they are. On the other hand, the green dextrorotatory circularly polarized light G_{2R} is converted into green levorotatory circularly polarized light G_{2L}.

The red levorotatory circularly polarized light R_{2L}, the green levorotatory circularly polarized light G_{2L}, and the blue dextrorotatory circularly polarized light B_{2R}, which are transmitted through the wavelength selective phase difference plate 18G, are then incident into the third optically anisotropic layer 26C.

In the same manner, the red levorotatory circularly polarized light R_{2L}, the green levorotatory circularly polarized light G_{2L}, and the blue dextrorotatory circularly polarized light B_{2R}, which are incident into the third optically anisotropic layer 26C, are also refracted and converted into circularly polarized light having an opposite turning direction such that red dextrorotatory circularly polarized light R_{3R}, green dextrorotatory circularly polarized light G_{3R}, and blue levorotatory circularly polarized light B_{3L} are emitted.

Here, the blue light incident into the third optically anisotropic layer 26C is the blue dextrorotatory circularly polarized light B_{2R}. In addition, since the direction of circularly polarized light of the red light is previously converted by the wavelength selective phase difference plate 18R, the red light incident into the third optically anisotropic layer 26C is the red levorotatory circularly polarized light R_{2L} having a direction of circularly polarized light which is different from that of blue light. Furthermore, the green light incident into the third optically anisotropic layer 26C is the green levorotatory circularly polarized light G_{2L} having a direction of circularly polarized light, which is converted by the wavelength selective phase difference plate 18G.

That is, the blue light incident into the third optically anisotropic layer 26C is dextrorotatory circularly polarized light, and the red light and the green light incident into the third optically anisotropic layer 26C are levorotatory circularly polarized light having a direction of circularly polarized light, which is converted by the wavelength selective phase difference plate.

In addition, as described above, the rotation directions of the optical axes 30A of the liquid crystal compounds 30 in the second optically anisotropic layer 26B and the third optically anisotropic layer 26C are opposite to each other.

Therefore, as shown in FIGS. 14 and 15, the blue dextrorotatory circularly polarized light B_{2R} incident in the third optically anisotropic layer 26C is further refracted in a direction opposite to the arrow X direction, and emitted at an angle θ_{B3} with respect to the incidence light (the blue dextrorotatory circularly polarized light B_{R}) as shown in FIG. 15.

On the other hand, in a case where the red levorotatory circularly polarized light R_{2L} having an opposite direction of circularly polarized light is incident into the third optically anisotropic layer 26C, the red levorotatory circularly polarized light R_{2L} is further refracted to return to the arrow X direction. As a result, the red dextrorotatory circularly polarized light R_{3R} emitted from the third optically anisotropic layer 26C is emitted at an angle θ_{R3} which is smaller than the angle θ_{R2} with respect to the incidence light (the red dextrorotatory circularly polarized light R_{R}).

Similarly, in a case where the green levorotatory circularly polarized light G_{2L} having a circular polarization opposite to that of the blue light is incident into the third optically anisotropic layer 26C, as shown in the center of FIG. 14, the green levorotatory circularly polarized light G_{2L} is refracted to return to the arrow X in a direction opposite to the previous direction. As a result, the green dextrorotatory circularly polarized light G_{3R} emitted from the third optically anisotropic layer 26C is emitted at an angle θ_{G3} which is smaller than the angle θ_{G2} with respect to the incidence light (the green dextrorotatory circularly polarized light G_{R}).

That is, in the optical element 32, the red light having the longest wavelength and the largest refraction by the optically anisotropic layer is refracted in a direction opposite to the arrow X direction by the first optically anisotropic layer 26A, and then refracted twice in a direction opposite to the arrow X direction by the second optically anisotropic layer 26B and the third optically anisotropic layer 26C.

In addition, the green light having the second longest wavelength and the second largest refraction by the optically anisotropic layer is refracted in a direction opposite to the arrow X direction by the first optically anisotropic layer 26A and the second optically anisotropic layer 26B, and then refracted once in the opposite arrow X direction by the third optically anisotropic layer 26C.

Furthermore, the blue light having the shortest wavelength and the smallest refraction by the optically anisotropic layer is refracted three times in a direction opposite the opposite arrow X direction by the first optically anisotropic layer 26A, the second optically anisotropic layer 26B, and the third optically anisotropic layer 26C.

In this way, in the optical element 32 according to the embodiment of the present invention, initially, all the light components are largely refracted in the same direction. Thereafter, in accordance with the magnitude of refraction by the optically anisotropic layer depending on the wavelength, the light having the longest wavelength is refracted the most multiple times so as to return to a direction opposite to the initial refraction direction. As the wavelength decreases, the number of times of refraction which returns to the direction opposite to the initial refraction direction is reduced. Regarding the light having the shortest wavelength, the number of times of refraction which returns to the direction opposite to the initial refraction direction is the smallest. As a result, the refraction angle θ_{R3} of red light, the refraction angle θ_{G3} of green light, and the refraction angle θ_{B3} of blue light with respect to the incidence light can be made to be very close to each other.

Therefore, in the optical element 32 according to the embodiment of the present invention, the incident red light, blue light, and green light can be refracted at substantially the same angle and emitted substantially in the same direction.

In a case where light components having three wavelength ranges are targets as in the optical element 32 of the example shown in the drawing, a designed wavelength of light having the longest wavelength is denoted by λa, a designed wavelength of light having the intermediate wavelength is denoted by λb, a designed wavelength of light having the shortest wavelength is denoted by λc (λa>λb>λc), the single period of the liquid crystal alignment pattern in the first optically anisotropic layer is denoted by Λ₁, the single period of the liquid crystal alignment pattern in the second optically anisotropic layer is denoted by Λ₂, and the single period of the liquid crystal alignment pattern in the third optically anisotropic layer is denoted by Λ₃, emission directions of light components having two wavelength ranges can be made to be substantially the same by satisfying the following expressions.

$$\begin{matrix}{Λ}_{2} = [ ( λ a + λ c ) λ b / ( λ a - λ b ) λ c ] {Λ}_{1} , \\ {Λ}_{3} = [ ( λ a + λ c ) λ b / ( λ b - λ c ) λ a ] {Λ}_{1}\end{matrix}$$

In the expression, any one of the first optically anisotropic layer 26A or the third optically anisotropic layer 26C may be the first layer.

In consideration of this point, in the present invention, it is preferable that at least one of the following expressions is satisfied in the optical element 32 in which the light components having three wavelengths (wavelength ranges) are targets, and it is more preferable to satisfy both the following two expressions.

$$\begin{matrix}0.6 * \{ [ ( λ a + λ c ) λ b / ( λ a - λ b ) λ c ] {Λ}_{1} \leq {Λ}_{2} \leq 3. * \{ [ ( λ a + λ c ) λ b / ( λ a - λ b ) λ c ] {Λ}_{1} \} \\ 0.6 * \{ [ ( λ a + λ c ) λ b / ( λ b - λ c ) λ a ] {Λ}_{1} \leq {Λ}_{3} \leq 3. * \{ [ ( λ a + λ c ) λ b / ( λ b - λ c ) λ a ] {Λ}_{1} \}\end{matrix}$$

As a result, by significantly reducing the wavelength dependence of refraction, emission directions of the light components having two wavelength ranges can be made to be substantially the same.

In addition, in the present invention, for the light components having three wavelengths (wavelength ranges) as targets, it is more preferable that the optical element 32 satisfies the following two expressions,

$$\begin{matrix}0.7 * \{ [ ( λ a + λ c ) λ b / ( λ a - λ b ) λ c ] {Λ}_{1} \leq {Λ}_{2} \leq 1.8 * \{ [ ( λ a + λ c ) λ b / ( λ a - λ b ) λ c ] {Λ}_{1} \} , \\ 0.7 * \{ [ ( λ a + λ c ) λ b / ( λ b - λ c ) λ a ] {Λ}_{1} \leq {Λ}_{3} \leq 1.8 * \{ [ ( λ a + λ c ) λ b / ( λ b - λ c ) λ a ] {Λ}_{1} \} ;\end{matrix}$$

it is still more preferable to satisfy the following two expressions,

$$\begin{matrix}0.8 * \{ [ ( λ a + λ c ) λ b / ( λ a - λ b ) λ c ] {Λ}_{1} \leq {Λ}_{2} \leq 1.3 * \{ [ ( λ a + λ c ) λ b / ( λ a - λ b ) λ c ] {Λ}_{1} \} , \\ 0.8 * \{ [ ( λ a + λ c ) λ b / ( λ b - λ c ) λ a ] {Λ}_{1} \leq {Λ}_{3} \leq 1.3 * \{ [ ( λ a + λ c ) λ b / ( λ b - λ c ) λ a ] {Λ}_{1} \} ;\end{matrix}$$

and
it is particularly preferable to satisfy the following two expressions,

$$\begin{matrix}0.9 * \{ [ ( λ a + λ c ) λ b / ( λ a - λ b ) λ c ] {Λ}_{1} \leq {Λ}_{2} \leq 1.15 * \{ [ ( λ a + λ c ) λ b / ( λ a - λ b ) λ c ] {Λ}_{1} \} \\ 0.9 * \{ [ ( λ a + λ c ) λ b / ( λ b - λ c ) λ a ] {Λ}_{1} \leq {Λ}_{3} \leq 1.15 * \{ [ ( λ a + λ c ) λ b / ( λ b - λ c ) λ a ] {Λ}_{1} \} .\end{matrix}$$

In the optical element according to the embodiment of the present invention, as described above, a plurality of optically anisotropic layers are arranged, and depending on the wavelength of light, light having a long wavelength and large refraction by the optically anisotropic layer is refracted in a direction opposite to the initial optically anisotropic layer a large number of times. As a result, light components having different wavelengths can be refracted substantially at the same angle substantially in the same direction.

Therefore, in a case where the optical element according to the embodiment of the present invention includes a plurality of wavelength selective phase difference plate, as in the optical element 32 shown in FIGS. 13 and 14, in the wavelength selective phase difference plates, it is preferable that a wavelength range of light having a turning direction of circularly polarized light which is converted into an opposite turning direction gradually becomes shorter in the arrangement direction of the optically anisotropic layers.

In addition, in the optical element according to the embodiment of the present invention, in a case where the refraction by the initial optically anisotropic layer is set to be large, the light is gradually refracted subsequently in the same direction and the refraction gradually returns to the original state in the opposite direction, and thus the refraction of each light is easily controlled and is easily made to be uniform. In consideration of this point, as in the optical element 32 shown in FIGS. 13 and 14, it is preferable that the single period A in the liquid crystal alignment pattern of the optically anisotropic layer positioned at the most distant position in the arrangement direction is the shortest. That is, it is preferable that the refraction by the optically anisotropic layer positioned at the most distant position in the arrangement direction is the largest.

In the optical element according to the embodiment of the present invention, the single period A in the liquid crystal alignment pattern of the optically anisotropic layer may gradually increase in the arrangement direction of the optically anisotropic layers. Alternatively, as in the optical element 32 shown in FIGS. 13 and 14, a change in the single period A in the liquid crystal alignment pattern of the optically anisotropic layer may be irregular in the arrangement direction of the optically anisotropic layers; for example, a configuration in which an optically anisotropic layer having an intermediate length of the single period A in the liquid crystal alignment pattern is provided between an optically anisotropic layer having the longest single period A in the liquid crystal alignment pattern and an optically anisotropic layer having the shortest single period A in the liquid crystal alignment pattern. That is, in the optical element according to the embodiment of the present invention, the single period A in the liquid crystal alignment pattern of each optically anisotropic layer may be appropriately set depending on the wavelength of light and the refractive index of the optically anisotropic layer.

In a case where the optical element according to the embodiment of the present invention includes a plurality of wavelength selective phase difference plates, basically, the optically anisotropic layers and the wavelength selective phase difference plates are alternately arranged as in the optical element 32 shown in FIGS. 13 and 14. In this case, it is preferable that the number of the wavelength selective phase difference plates is less than the number of the optically anisotropic layers by one.

However, the present invention is not limited to the configuration, and for example, a plurality of optically anisotropic layers may be continuously arranged such that the light continuously refracted by the plurality of optically anisotropic layers is incident into the wavelength selective phase difference plate.

In addition, a plurality of wavelength selective phase difference plates may be arranged between two optically anisotropic layers. However, in a case where a plurality of wavelength selective phase difference plates which convert circularly polarized light having the same wavelength range into circularly polarized light having an opposite turning direction are arranged between two optically anisotropic layers, it is preferable that the number of the wavelength selective phase difference plates is an odd number.

In the optical element according to the embodiment of the present invention, optically anisotropic layers having the same single period Λ of the liquid crystal alignment pattern may be present.

However, from the viewpoint that refraction, that is, emission angles of light components having a plurality of wavelength ranges can be easily made to be uniform, it is preferable that all the optically anisotropic layers have different single periods Λ of the liquid crystal alignment patterns.

In the optical element according to the embodiment of the present invention, the single period Λ in the alignment pattern of the optically anisotropic layer is not particularly limited and may be appropriately set depending on the application of the optical element and the like.

The optical element according to the embodiment of the present invention may include a wavelength selective phase difference plate which selectively converts circularly polarized light having the shortest designed wavelength into circularly polarized light having an opposite turning direction. For example, a third wavelength selective phase difference plate B which selectively converts blue circularly polarized light into circularly polarized light having an opposite turning direction may be disposed behind the third optically anisotropic layer 26C (on the downstream side in a traveling direction of the light).

As described above, the third wavelength selective phase difference plate B converts only the blue circularly polarized light into circularly polarized light having an opposite turning direction, and allows transmission of the other light as it is.

Accordingly, in a case where the red dextrorotatory circularly polarized light R_{3R}, the green dextrorotatory circularly polarized light G_{3R}, and the blue levorotatory circularly polarized light B_{3L} are incident into and transmitted through the third wavelength selective phase difference plate B, the red dextrorotatory circularly polarized light R_{3R} and the green dextrorotatory circularly polarized light G_{3R} are transmitted as they are. On the other hand, the blue levorotatory circularly polarized light B_{3L} is converted into blue dextrorotatory circularly polarized light B_{3R}.

As a result, circularly polarized light components of blue light, green light, and red light, emitted from the optical element, can be made to have the same turning direction.

Here, the optical element according to the embodiment of the present invention can be suitably used as, for example, a diffraction element which refracts light displayed by a display to be introduced into a light guide plate or a diffraction element which refracts light propagated in a light guide plate to be emitted to an observation position by a user from the light guide plate in AR glasses. In particular, the optical element 32 which can handle with a full color image can be suitably used as a diffraction element in AR glasses.

In this case, in order to totally reflect light from the light guide plate, it is necessary to refract light to be introduced into the light guide plate at a large angle to some degree with respect to incidence light. In addition, in order to reliably emit light propagated in the light guide plate, it is necessary to refract light at a large angle to some degree with respect to the incidence light.

In addition, as described above, regarding a transmission angle of the light through the optically anisotropic layer, the angle of transmitted light with respect to the incidence light can be increased by reducing the single period Λ in the liquid crystal alignment pattern.

In consideration of this point, the single period Λ in the liquid crystal alignment pattern of the optically anisotropic layer is preferably 50 μm or less, more preferably 10 μm or less, and still more preferably 3 μm or less.

In consideration of the accuracy of the liquid crystal alignment pattern, and the like, the single period Λ in the liquid crystal alignment pattern of the optically anisotropic layer is preferably 0.1 μm or more.

In the optical elements shown in FIGS. 9 to 15, the optical axis 30A of the liquid crystal compound 30 in the liquid crystal alignment pattern of the optically anisotropic layer continuously rotates only in the arrow X direction.

However, the present invention is not limited thereto, and various configurations can be used as long as the optical axis 30A of the liquid crystal compound 30 in the optically anisotropic layer continuously rotates in one direction.

Examples thereof include an optically anisotropic layer 34 conceptually shown in a plan view of FIG. 17, in which a liquid crystal alignment pattern is a concentric circular pattern having a concentric circular shape where one in-plane direction in which the orientation of the optical axis of the liquid crystal compound 30 changes while continuously rotating moves from an inner side toward an outer side. In other words, the liquid crystal alignment pattern of the optically anisotropic layer 34 shown in FIG. 17 is a liquid crystal alignment pattern which has the one direction in which the orientation of the optical axis of the liquid crystal compound 30 changes while continuously rotating, in a radial shape from the center of the optically anisotropic layer 34.

FIG. 17 shows only the liquid crystal compound 30 in the surface of the alignment film as in FIG. 9; but as shown in FIG. 7, the optically anisotropic layer 34 has the structure in which the liquid crystal compound 30 in the surface of the alignment film is stacked as described above.

Furthermore, in FIG. 17, only one optically anisotropic layer 34 is shown, but the optical element according to the embodiment of the present invention includes a plurality of optically anisotropic layers and includes the wavelength selective phase difference plate between at least one pair of the two optically anisotropic layers as described above. Accordingly, even in a case where the optical element includes the optically anisotropic layer having the concentric circular liquid crystal alignment pattern, for example, as in the optical element 32 shown in FIG. 13, the optical element has a configuration in which a first optically anisotropic layer, a wavelength selective phase difference plate which converts red circularly polarized light, a second optically anisotropic layer, a wavelength selective phase difference plate which converts green circularly polarized light, and a third optically anisotropic layer are arranged.

In the optically anisotropic layer 34 shown in FIG. 17, the optical axis (not shown) of the liquid crystal compound 30 is a longitudinal direction of the liquid crystal compound 30.

In the optically anisotropic layer 34, the orientation of the optical axis of the liquid crystal compound 30 changes while continuously rotating in a direction in which a large number of optical axes move to the outer side from the center of the optically anisotropic layer 34, such as the direction indicated by the arrow A1, the direction indicated by the arrow A2, and the direction indicated by the arrow A3.

In circularly polarized light incident into the optically anisotropic layer 34 having the liquid crystal alignment pattern, the absolute phase changes depending on individual local regions having different orientations of optical axes of the liquid crystal compound 30. In this case, the amount of change in absolute phase varies depending on the orientations of the optical axes of the liquid crystal compound 30 into which circularly polarized light is incident.

In this way, in the optically anisotropic layer 34 having the concentric circular liquid crystal alignment pattern, that is, the liquid crystal alignment pattern in which the optical axis changes rotationally in a radial shape, transmission of incidence light can be allowed as diverging light or converging light depending on the rotation direction of the optical axis of the liquid crystal compound 30 and the direction of circularly polarized light to be incident.

That is, by setting the liquid crystal alignment pattern of the optically anisotropic layer in a concentric circular shape, the optical element according to the embodiment of the present invention exhibits, for example, a function as a convex lens or a concave lens.

Here, in a case where the liquid crystal alignment pattern of the optically anisotropic layer is concentric circular such that the optical element functions as a convex lens, it is preferable that the length of the single period Λ over which the optical axis rotates 180° in the liquid crystal alignment pattern gradually decreases from the center of the optically anisotropic layer 34 toward the outer direction of the one direction in which the optical axis continuously rotates.

As described above, the refraction angle of light with respect to an incidence direction increases as the length of the single period Λ in the liquid crystal alignment pattern decreases. Accordingly, the length of the single period Λ in the liquid crystal alignment pattern gradually decreases from the center of the optically anisotropic layer 34 toward the outer direction of the one direction in which the optical axis continuously rotates. As a result, the light gathering power of the optically anisotropic layer 34 can be improved, and the performance as a convex lens can be improved.

In the present invention, depending on the application of the optical element such as a concave lens, it is preferable that the length of the single period Λ over which the optical axis rotates by 180° in the liquid crystal alignment pattern gradually decreases from the center of the optically anisotropic layer 34 toward the outer direction of the one direction by reversing the direction in which the optical axis continuously rotates.

As described above, the refraction angle of light with respect to an incidence direction increases as the length of the single period Λ in the liquid crystal alignment pattern decreases. Accordingly, the length of the single period Λ in the liquid crystal alignment pattern gradually decreases from the center of the optically anisotropic layer 34 toward the outer direction of the one direction in which the optical axis continuously rotates. As a result, the light diverging power of the optically anisotropic layer 34 can be improved, and the performance as a concave lens can be improved.

In the present invention, for example, in a case where the optical element is used as a concave lens, it is preferable that the turning direction of incident circularly polarized light is reversed.

In the present invention, in a case where the optical element is to function as a convex lens or a concave lens, it is preferable that the optical element satisfies the following expression.

$$Φ ( r ) = ( π / λ ) [ {( {r}^{2} + {f}^{2} )}^{1 / 2} - f ]$$

Here, r represents a distance from the center of a concentric circle and is represented by an expression “r=(x²+y²)^{1/2}”. x and y represent in-plane positions, and (x,y)=(0,0) represents the center of the concentric circle. Φ(r) represents an angle of the optical axis at the distance r from the center, λ represents a wavelength, and f represents a designed focal length.

In the present invention, conversely, the length of the single period Λ in the concentric circular liquid crystal alignment pattern may gradually increase from the center of the optically anisotropic layer 34 toward the outer direction of the one direction in which the optical axis continuously rotates.

Furthermore, depending on the uses of the optical element such as a case where it is desired to provide a light amount distribution in the transmitted light, a configuration in which regions having partially different lengths of the single periods A in the one direction in which the optical axis continuously rotates are provided can also be used instead of the configuration in which the length of the single period Λ gradually changes in the one direction in which the optical axis continuously rotates.

Furthermore, the optical element according to the embodiment of the present invention may include an optically anisotropic layer in which the single period Λ is uniform over the entire surface, and an optically anisotropic layer in which regions having different lengths of the single periods Λ are provided. This point is also applicable to a configuration in which the optical axis continuously rotates only in the one in-plane direction as shown in FIG. 6.

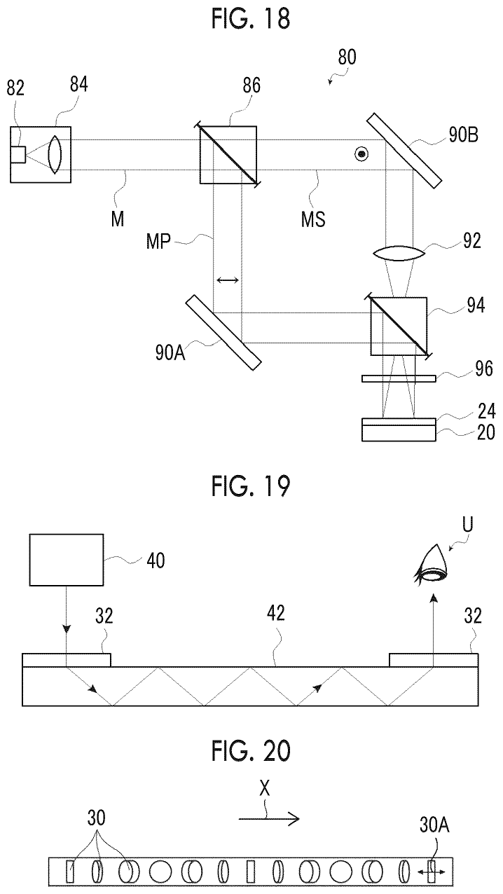

FIG. 18 conceptually shows an example of an exposure device which forms the concentric circular alignment pattern in the alignment film (for example, the alignment film 24A, the alignment film 24B, and the alignment film 24C).

An exposure device 80 includes a light source 84 which includes a laser 82, a polarization beam splitter 86 which splits a laser light M emitted from the laser 82 into an S-polarized light MS and a P-polarized light MP, a mirror 90A which is disposed on an optical path of the P-polarized light MP and a mirror 90B which is disposed on an optical path of the S-polarized light MS, a lens 92 which is disposed on the optical path of the S-polarized light MS, a polarization beam splitter 94, and a λ/4 plate 96.

The P-polarized light MP which is split by the polarization beam splitter 86 is reflected from the mirror 90A to be incident into the polarization beam splitter 94. On the other hand, the S-polarized light MS which is split by the polarization beam splitter 86 is reflected from the mirror 90B and is condensed by the lens 92 to be incident into the polarization beam splitter 94.

The P polarized light MP and the S polarized light MS are combined by the polarization beam splitter 94, are converted into dextrorotatory circularly polarized light and levorotatory circularly polarized light by the λ/4 plate 96 depending on the polarization direction, and are incident into the alignment film 24 on the support 20.

Due to interference between the dextrorotatory circularly polarized light and the levorotatory circularly polarized light, the polarization state of light with which the alignment film 24 is irradiated periodically changes according to interference fringes. An intersecting angle between dextrorotatory circularly polarized light and levorotatory circularly polarized light changes from the inside to the outside of the concentric circle, so that an exposure pattern in which the pitch changes from the inner side toward the outer side can be obtained. As a result, in the alignment film 24, a concentric circular alignment pattern in which the alignment state periodically changes can be obtained.

In the exposure device 80, the single period Λ of the liquid crystal alignment pattern in which the optical axis of the liquid crystal compound 30 continuously rotates by 180° in the one direction can be controlled by changing a focal power of the lens 92 (F number of the lens 92), the focal length of the lens 92, the distance between the lens 92 and the alignment film 24, and the like.

In addition, by adjusting the focal power of the lens 92 (F number of the lens 92), the length Λ of the single period of the liquid crystal alignment pattern in which the optical axis continuously rotates in the one direction can be changed.

Specifically, the length Λ of the single period in the liquid crystal alignment pattern in which the optical axis continuously rotates in the one direction can be changed depending on a light spread angle at which light is spread by the lens 92 due to interference with parallel light. More specifically, in a case where the focal power of the lens 92 is decreased, the light is close to the parallel light, so that the length Λ of the single period in the liquid crystal alignment pattern is gradually decreased from the inner side toward the outer side, and the F-number is increased. Conversely, in a case where the focal power of the lens 92 is stronger, the length Λ of the single period in the liquid crystal alignment pattern rapidly decreases from the inner side toward the outer side, and the F number is decreased.

In this way, the configuration of changing the length of the single period Λ over which the optical axis rotates 180° in the one direction in which the optical axis continuously rotates can also be used in the configuration shown in FIGS. 6 to 15 in which the optical axis 30A of the liquid crystal compound 30 continuously rotates only in the one direction of the arrow X direction.

For example, by gradually decreasing the single period Λ of the liquid crystal alignment pattern in arrow X direction, an optical element which transmits light so as to be condensed can be obtained. In addition, by reversing the direction over which the optical axis in the liquid crystal alignment pattern rotates 180°, an optical element which transmits light so as to be diffused only in arrow X direction can be obtained. By reversing the turning direction of incident circularly polarized light, an optical element which allows transmission of light to be diffused only in the arrow X direction can be obtained.

Furthermore, depending on the uses of the optical element such as a case where it is desired to provide a light amount distribution in the transmitted light, a configuration in which regions having partially different lengths of the single periods A in arrow X direction are provided can also be used instead of the configuration in which the length of the single period Λ gradually changes in arrow X direction. For example, as a method of partially changing the single period Λ, a method of scanning and exposing the photo-alignment film to be patterned while freely changing a polarization direction of laser light to be condensed can be used.

The optical element according to the embodiment of the present invention can be used for various uses where transmission of light in a direction different from an incidence direction is allowed, for example, an optical path changing member, a light condensing element, a light diffusing element to a predetermined direction, a diffraction element, or the like in an optical device.

In a preferred example, as conceptually shown in FIG. 19, the optical element can be used as a diffraction element which is provided to be spaced from a light guide plate 42 such that, in the above-described AR glasses, light (projection image) emitted from a display 40 is guided to the light guide plate 42 at a sufficient angle for total reflection and the light propagated in the light guide plate 42 is emitted from the light guide plate 42 to an observation position by a user U in the AR glasses. FIG. 19 shows the optical element 32 shown in FIG. 13 corresponding to a full color image, but for example, in a case where a two-color image is displayed in the AR glasses, the optical element 10 shown in FIG. 6 can also be suitably used.

As described above, in the optical element according to the embodiment of the present invention, the angle dependence of the refraction angle during transmission is small, so that red light, green light, and blue light emitted from the display 40 can be refracted in the same direction. Therefore, with one light guide plate 42, even in a case where red image, green image, and blue image are propagated, a full color image having no color shift can be emitted from the light guide plate to the observation position by the user U in the AR glasses. Accordingly, in a light guide element using the optical element according to the embodiment of the present invention, the light guide plate of the AR glasses can be made thin and light as a whole, and the configuration of the AR glasses can be simplified.

The light guide element according to the embodiment of the present invention is not limited to the configuration in which two optical elements according to the embodiment of the present invention spaced from each other are provided in the light guide plate 42 as shown in FIG. 19, and a configuration may be adopted in which only one optical element according to the embodiment of the present invention is provided in the light guide plate 42 for introduction or extraction of light into or from the light guide plate 42.

In the above-described examples, the optical element according to the embodiment of the present invention is used as the optical element which includes two or three optically anisotropic layers and allows transmission of two light components including green light and blue light or three light components including red light, green light, and blue light to refract the light components; but the present invention is not limited thereto, and various configurations can be used.

For example, the optical element according to the embodiment of the present invention may have a configuration in which three optically anisotropic layers and two wavelength selective phase difference plates are provided as in FIG. 13, and transmission of not only two light components selected from red light, green light, and blue light but also infrared light or ultraviolet light is allowed to refract the light components. Alternatively, the optical element according to the embodiment of the present invention may have a configuration in which four or five (or six or more) optically anisotropic layers and three or four (the number of optically anisotropic layers-one) wavelength selective phase difference plates are provided, and infrared light and/or ultraviolet light is transmitted and refracted in addition to the red light, green light, and blue light. Alternatively, the optical element according to the embodiment of the present invention may have a configuration in which two optically anisotropic layers and one wavelength selective phase difference plate are provided as in FIG. 6, and transmission of red light and blue light or transmission of red light and green light is allowed to refract the light components, or a configuration in which not only one light component selected from red light, green light, and blue light but also infrared light and ultraviolet light are refracted to be transmitted. Alternatively, the optical element according to the embodiment of the present invention may have a configuration in which infrared light and/or ultraviolet light is refracted to be transmitted.

### EXAMPLES

Hereinbelow, the present invention will be described in more detail with reference to Examples.

The materials, the amounts of materials used, the proportions, the treatment details, the treatment procedure, and the like shown in Examples below may be modified as appropriate as long as the modifications do not depart from the spirit of the present invention. Therefore, the scope of the present invention should not be construed as being limited to Examples shown below.

### Example 1

### [Synthesis of Polymer PA-1 Having Photo-Aligned Group]

The following monomer m-1 was synthesized using 2-hydroxyethyl methacrylate (HEMA) (Tokyo Chemical Industry Co., Ltd.) and the following cinnamic acid chloride derivative according to a method described in Langmuir, 32 (36), pp. 9245 to 9253, (2016).

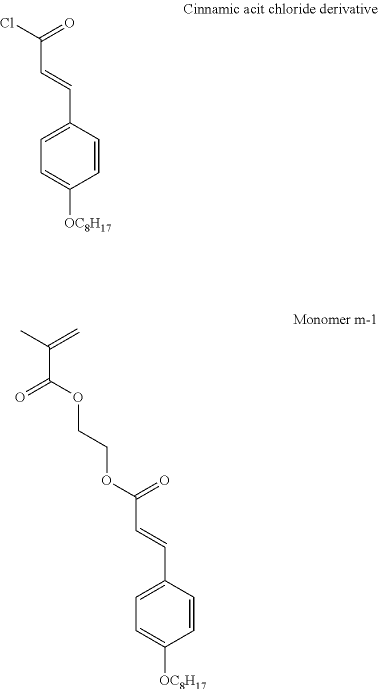

A flask equipped with a cooling pipe, a thermometer, and a stirrer was charged with 5 parts by mass of 2-butanone as a solvent, and while flowing nitrogen in the flask at 5 ml/min, the solvent was refluxed by heating in a water bath. To the solvent, a solution obtained by mixing 5 parts by mass of the monomer m-1, 5 parts by mass of CYCLOMER M100 (3,4-epoxycyclohexylmethyl methacrylate, manufactured by Daicel Corporation), 1 part by mass of 2,2′-azobis(isobutyronitrile) as a polymerization initiator, and 5 parts by mass of 2-butanone as a solvent was added dropwise for 3 hours, and stirred for 3 hours while maintaining the reflux state. After completion of the reaction, the reaction mixture was allowed to cool to room temperature, and 30 parts by mass of 2-butanone was added and diluted to obtain approximately 20% by mass of a polymer solution. The obtained polymer solution was poured into a large excess of methanol to precipitate the polymer, the collected precipitate was separated by filtration, and the obtained solid content was washed with a large amount of methanol, and then subjected to blast drying at 50° C. for 12 hours, thereby obtaining a polymer PA-1 having a photo-aligned group (see below). The obtained polymer PA-1 had an epoxy equivalent of 396 g/eq and a weight-average molecular weight of 28,000.

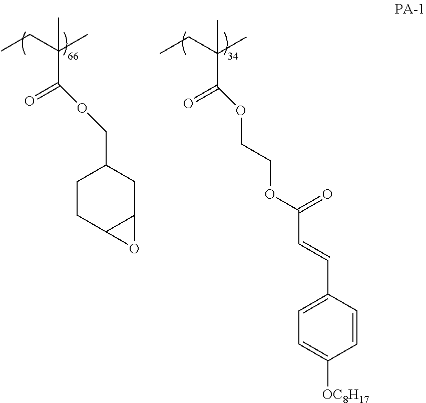

### [Production of Photo-Alignment Film P-1]

The following composition PC-1 for forming a photo-alignment film was continuously applied onto a commercially available triacetyl cellulose film “Z-TAC” (manufactured by FUJIFILM Corporation) using a #2.4 wire bar. The support on which the coating film was formed was dried with hot air at 140° C. for 120 seconds, and the coating film was irradiated with polarized ultraviolet rays (10 mJ/cm², using an ultra-high pressure mercury lamp) to form a photo-alignment film P-1.

Composition PC-1 for forming photo-alignment film

| | | |
|---|---|---|
| Polymer PA-1 shown above | 100.00 | parts by mass |
| Thermal acid generator | 5.00 | parts by mass |
| PAG shown below | | |
| Isopropyl alcohol | 16.50 | parts by mass |
| Butyl acetate | 1072.00 | parts by mass |
| Methyl ethyl ketone | 268.00 | parts by mass |

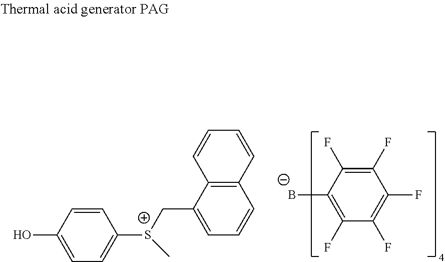

### [Formation of Optical Film A]

The following polymerizable liquid crystal composition 1 was applied onto the photo-alignment film P-1 using a #13 wire bar. After heating at 110° C. for 100 seconds, the composition layer was irradiated with ultraviolet rays (irradiation amount: 500 mJ/cm²) using a metal halide lamp (manufactured by Eye Graphics Co., Ltd.) at 55° C. in a nitrogen atmosphere to fix alignment of the liquid crystal compound and form an optically anisotropic film A1.

Subsequently, the following polymerizable liquid crystal composition 2 was applied onto the optically anisotropic film A1 using a #16 wire bar, and heated at 110° C. for 100 seconds, and the composition layer was irradiated with ultraviolet rays (irradiation amount: 500 mJ/cm²) using a metal halide lamp at 55° C. in a nitrogen atmosphere. The step of applying the following polymerizable liquid crystal composition 2 and irradiating the composition layer with ultraviolet rays was further repeated three times to form an optically anisotropic film A2.

Furthermore, the following polymerizable liquid crystal composition 3 was applied onto the optically anisotropic film A2 using a #13 wire bar, and heated at 110° C. for 100 seconds, and the composition layer was irradiated with ultraviolet rays (irradiation amount: 500 mJ/cm²) using a metal halide lamp at 55° C. in a nitrogen atmosphere to form an optically anisotropic film A3.

As a result, an optical film A in which support/photo-alignment film P-1/optically anisotropic film A1/optically anisotropic film A2/optically anisotropic film A3 were laminated in this order was produced.

In the produced optical film A, the optically anisotropic film A1 and the optically anisotropic film A3 corresponded to a λ/4 plate. In addition, the optically anisotropic film A2 corresponded to the liquid crystal polarization interference element 216 shown in FIG. 1. Therefore, the produced optical film A corresponded to the above-described optical component.

In addition, each layer constituting the optical film A was a layer formed by fixing the alignment state of the liquid crystal compound as shown in Table 1 in the latter part. In addition, the phase difference of each layer constituting the optical film A is also shown in Table 1 in the latter part.

Polymerizable liquid crystal composition 1

| | | |
|---|---|---|
| Liquid crystal compound A-1 shown below | 67 | parts by mass |
| (weight-average molecular weight: 20,000) | | |
| Liquid crystal compound B-1 shown below | 33 | parts by mass |
| Polymerization initiator S-1 shown below | 3 | parts by mass |
| Chiral agent A shown below | 0.40 | parts by mass |
| Chiral agent B shown below | 0.65 | parts by mass |
| Leveling agent (the following compound L-1) | 0.15 | parts by mass |
| Vertical alignment assistant | 0.2 | parts by mass |
| (the following compound T-1) | | |
| Cyclohexanone | 516.8 | parts by mass |

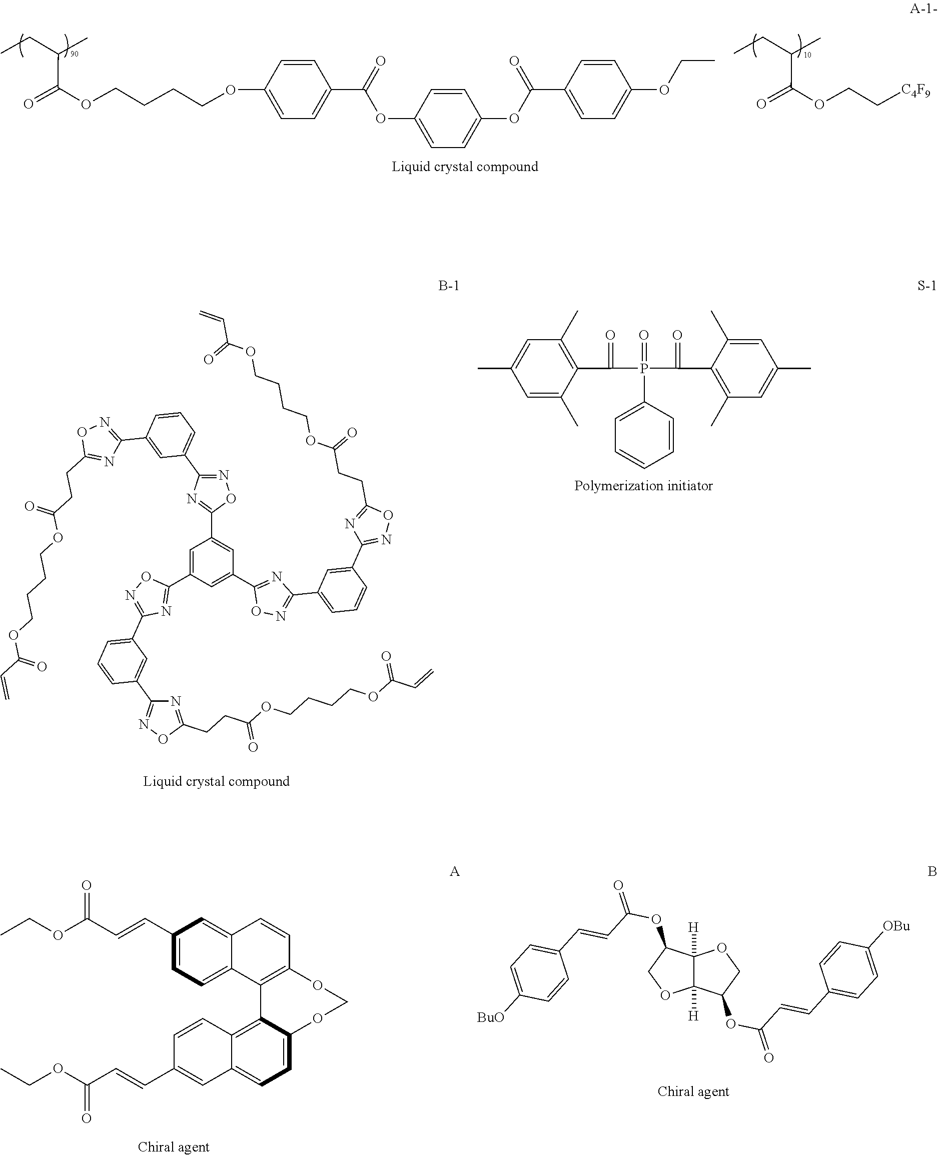

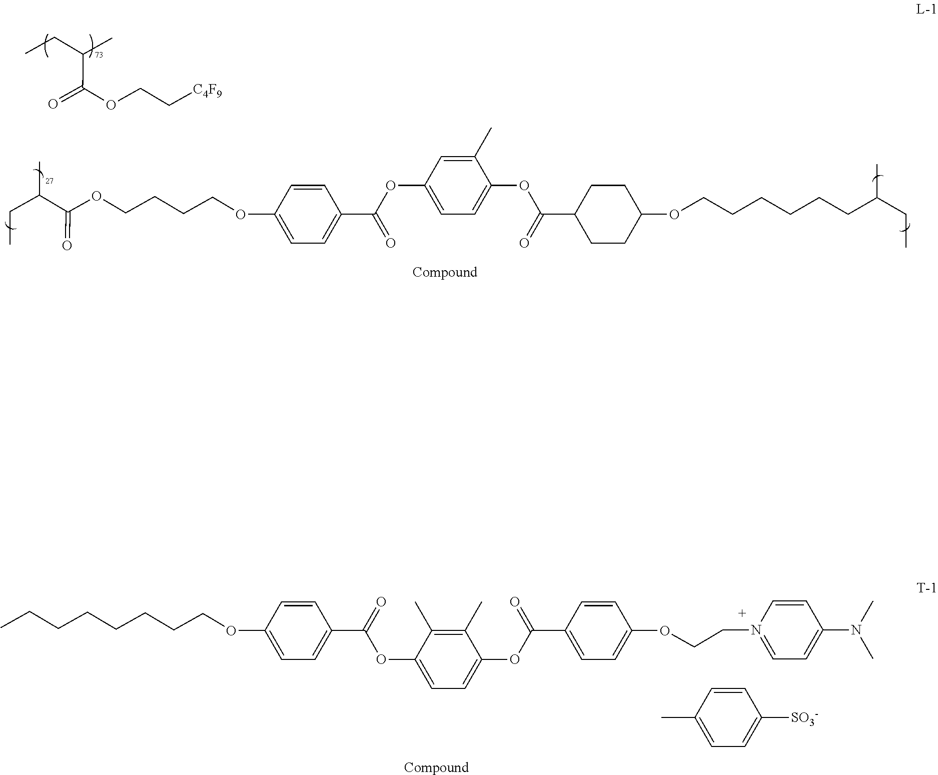

In a case of applying the above-described polymerizable liquid crystal composition 2, the above-described liquid crystal compound A-1 (rod-like liquid crystal compound) was concentrated on the air interface side, and the above-described liquid crystal compound B-1 (disk-like liquid crystal compound) was concentrated on a side opposite to the air interface side. That is, a layer containing the disk-like liquid crystal compound and a layer containing the rod-like liquid crystal compound were separated from the photo-alignment film P-1 side. In addition, the above-described chiral agent A and the above-described chiral agent B were contained in each of the separated layers, and the chiral agent A had a right-handed twist helical twisting power for the disk-like liquid crystal compound and the rod-like liquid crystal compound. On the other hand, the chiral agent B had a left-handed helical twisting power only for the rod-like liquid crystal compound. As a result, the optically anisotropic layer A2 shown in Table 1 in the latter part was formed such that the layer containing the disk-like liquid crystal compound was right-twisted and the layer containing the rod-like liquid crystal compound was left-twisted.

Polymerizable liquid crystal composition 2

| | | |
|---|---|---|
| Liquid crystal compound A-1 shown above | 50 | parts by mass |
| (weight-average molecular weight: 20,000) | | |
| Liquid crystal compound B-1 shown above | 50 | parts by mass |
| Polymerization initiator S-1 shown above | 3 | parts by mass |
| Chiral agent A shown above | 0.05 | parts by mass |
| Chiral agent B shown above | 0.19 | parts by mass |
| Leveling agent (the above compound L-1) | 0.15 | parts by mass |
| Vertical alignment assistant | 0.2 | parts by mass |
| (the above compound T-1) | | |
| Cyclohexanone | 516.8 | parts by mass |

Polymerizable liquid crystal composition 3

| | | |
|---|---|---|
| Liquid crystal compound A-1 shown above | 33 | parts by mass |
| (weight-average molecular weight: 20,000) | | |
| Liquid crystal compound B-1 shown above | 67 | parts by mass |
| Polymerization initiator S-1 shown above | 3 | parts by mass |
| Chiral agent A shown above | 0.07 | parts by mass |
| Chiral agent C shown below | 0.58 | parts by mass |
| Leveling agent (the above compound L-1) | 0.15 | parts by mass |
| Vertical alignment assistant | 0.2 | parts by mass |
| (the above compound T-1) | | |
| Cyclohexanone | 516.8 | parts by mass |

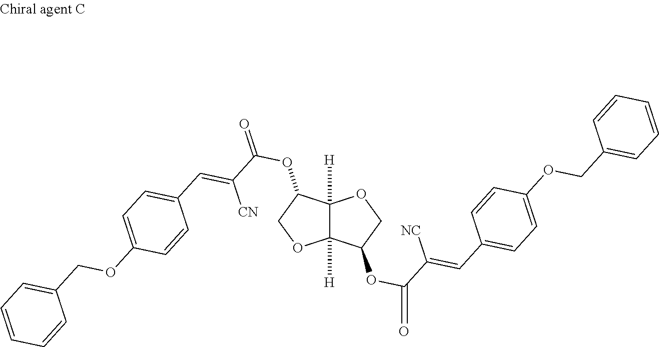 [SMILES: N#C/C(=C\c1ccc(OCc2ccccc2)cc1)C(=O)O[C@H]1CO[C@H]2[C@@H]1OC[C@H]2OC(=O)/C(C#N)=C/c1ccc(OCc2ccccc2)cc1]

### Example 2

An optical film B was produced by the same procedure as in Example 1, except that the amounts of the chiral agents A, B, and C in the polymerizable liquid crystal composition and the diameter of the wire bar were changed. That is, an optical film B in which support/photo-alignment film P-1/optically anisotropic film B1/optically anisotropic film B2/optically anisotropic film B3 were laminated in this order was produced. The optically anisotropic film B1, the optically anisotropic film B2, and the optically anisotropic film B3 corresponded to a λ/4 plate, the liquid crystal polarization interference element 216 shown in FIG. 1, and a λ/4 plate in this order, and the optical film B corresponded to the above-described optical component.

In the production of the optical film B, conditions were adjusted so as to have a phase difference as shown in Table 2 in the latter part. Each layer constituting the optical film B was a layer formed by fixing the alignment state of the liquid crystal compound as shown in Table 2 in the latter part.

### Example 3

An optical film C was produced by the same procedure as in Example 1, except that the amounts of the chiral agents A, B, and C in the polymerizable liquid crystal composition and the diameter of the wire bar were changed. That is, an optical film C in which support/photo-alignment film P-1/optically anisotropic film C1/optically anisotropic film C2/optically anisotropic film C3 were laminated in this order was produced. The optically anisotropic film C1, the optically anisotropic film C2, and the optically anisotropic film C3 corresponded to a λ/4 plate, the liquid crystal polarization interference element 216 shown in FIG. 1, and a λ/4 plate in this order, and the optical film C corresponded to the above-described optical component.

In the production of the optical film C, conditions were adjusted so as to have a phase difference as shown in Table 3 in the latter part. Each layer constituting the optical film C was a layer formed by fixing the alignment state of the liquid crystal compound as shown in Table 3 in the latter part.

### Example 4

First, a film in which support/photo-alignment film P-1 was laminated was produced by the same procedure as in Example 1.

### (Formation of Optical Film D)

The following polymerizable liquid crystal composition 4 was applied onto the photo-alignment film P-1 using a #4 wire bar. After heating at 100° C. for 80 seconds, the composition layer was irradiated with ultraviolet rays (irradiation amount: 19 mJ/cm²) using an LED lamp (manufactured by AcroEdge Co., Ltd.) at 365 nm under a condition of 40° C. in the air containing oxygen (oxygen concentration: approximately 20% by volume). Subsequently, the obtained composition layer was heated at 90° C. for 10 seconds, and then irradiated with ultraviolet rays (irradiation amount: 500 mJ/cm²) using the metal halide lamp at 55° C. in a nitrogen atmosphere to fix alignment of the liquid crystal compound and form an optically anisotropic film 4.

Subsequently, the following polymerizable liquid crystal composition 5 was applied onto the optically anisotropic film 4 using a #7 wire bar, and heated at 100° C. for 80 seconds, and the composition layer was irradiated with ultraviolet rays (irradiation amount: 35 mJ/cm²) using a 365 nm LED lamp at 40° C. in air containing oxygen. By the above-described irradiation with ultraviolet rays, the polymerization proceeded only on a side of the composition layer opposite to the air interface side, and the chiral agent C contained in the air interface side was deactivated. The obtained composition layer was heated at 90° C. for 10 seconds, and then irradiated with ultraviolet rays using the metal halide lamp at 55° C. in a nitrogen atmosphere. That is, the twisted direction of the liquid crystal compound of the composition layer on the air interface side was set to be opposite to the layer on the side opposite to the air interface side, and the polymerization of the entire composition layer was allowed to proceed. The step of applying the following polymerizable liquid crystal composition 5 and irradiating the composition layer with ultraviolet rays using the metal halide lamp was further repeated three times to form an optically anisotropic film 5.

Furthermore, the following polymerizable liquid crystal composition 6 was applied onto the optically anisotropic film 5 using a #4 wire bar. After heating at 100° C. for 80 seconds, the composition layer was irradiated with ultraviolet rays (irradiation amount: 38 mJ/cm²) using a 365 nm LED lamp at 40° C. in air containing oxygen. Subsequently, the obtained composition layer was heated at 90° C. for 10 seconds, and then irradiated with ultraviolet rays (irradiation amount: 500 mJ/cm²) using the metal halide lamp at 55° C. in a nitrogen atmosphere to fix alignment of the liquid crystal compound and form an optically anisotropic film 6.

As a result, an optical film D in which support/photo-alignment film P-1/optically anisotropic film 4/optically anisotropic film 5/optically anisotropic film 6 were laminated in this order was produced. In the produced optical film D, the optically anisotropic film 4 and the optically anisotropic film 6 corresponded to a λ/4 plate. In addition, the optically anisotropic film 5 corresponded to the liquid crystal polarization interference element 216 shown in FIG. 1. Therefore, the produced optical film D corresponded to the above-described optical component.

Each layer constituting the produced optical film D was a layer formed by fixing the alignment state of the liquid crystal compound as shown in Table 4 in the latter part. In addition, the phase difference of each layer of the optical film D is also shown in Table 4 in the latter part.

Polymerizable liquid crystal composition 4

| | | |
|---|---|---|
| Rod-like liquid crystal compound A shown below | 80 | parts by mass |
| Rod-like liquid crystal compound B shown below | 3 | parts by mass |
| Rod-like liquid crystal compound C shown below | 17 | parts by mass |
| Ethylene oxide-modified trimethylolpropane | | |
| triacrylate (V # 360, manufactured by | 4 | parts by mass |
| Osaka Organic Chemical Industry Ltd.) | | |
| Polymerization initiator S-1 shown below | 3 | parts by mass |
| Chiral agent B shown above | 0.24 | parts by mass |
| Chiral agent C shown above | 0.55 | parts by mass |
| Leveling agent (the above compound L-1) | 0.08 | parts by mass |
| Methyl isobutyl ketone | 36 | parts by mass |
| Ethyl propionate | 71 | parts by mass |
| Methyl ethyl ketone | 36 | parts by mass |

Rod-like liquid crystal compound A (mixture of compounds shown below)

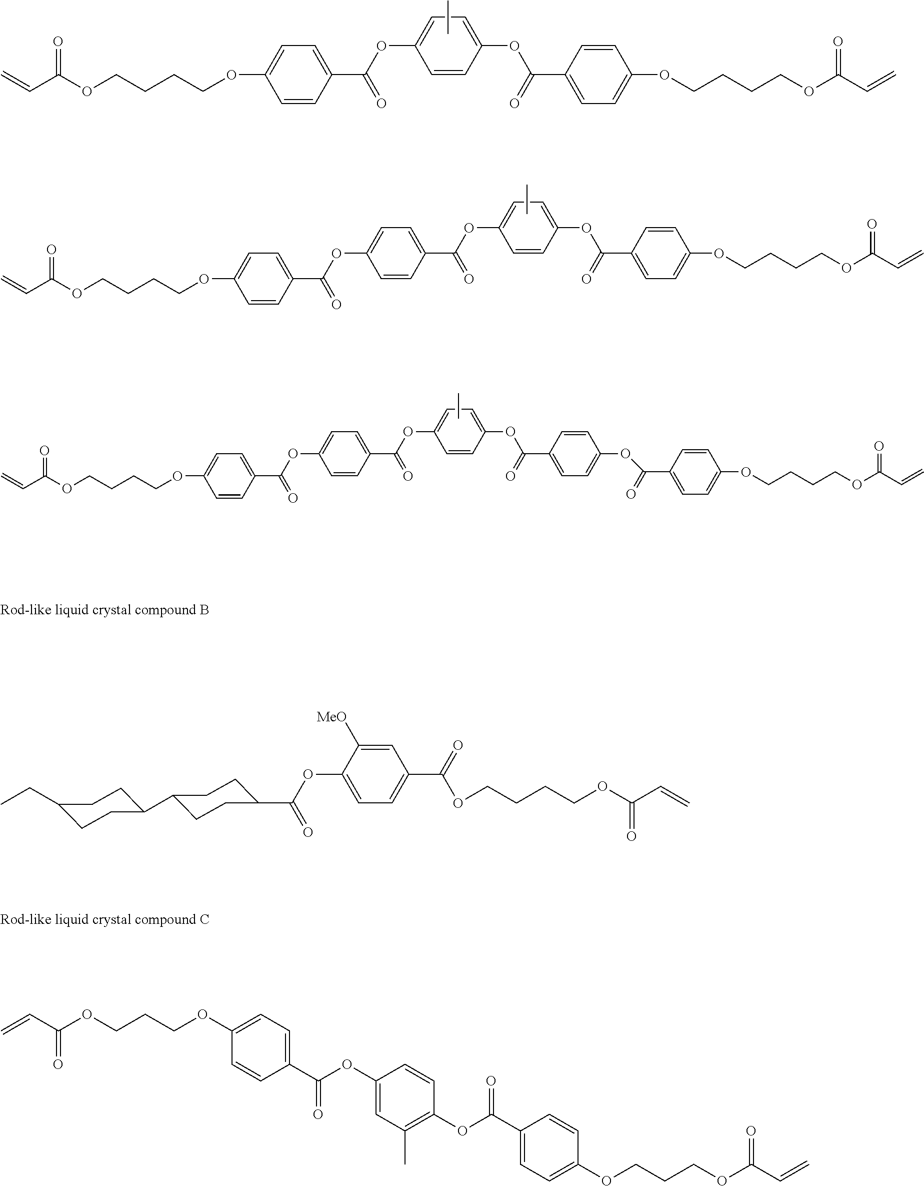

Polymerizable liquid crystal composition 5

| | | |
|---|---|---|
| Rod-like liquid crystal compound A shown above | 80 | parts by mass |
| Rod-like liquid crystal compound B shown above | 3 | parts by mass |
| Rod-like liquid crystal compound C shown above | 17 | parts by mass |
| Ethylene oxide-modified trimethylolpropane | 4 | parts by mass |
| triacrylate (V#360, manufactured by | | |
| Osaka Organic Chemical Industry Ltd.) | | |
| Polymerization initiator S-1 shown below | 3 | parts by mass |
| Chiral agent B shown above | 0.08 | parts by mass |
| Chiral agent C shown above | 0.11 | parts by mass |
| Leveling agent (the above compound L-1) | 0.08 | parts by mass |
| Methyl isobutyl ketone | 36 | parts by mass |
| Ethyl propionate | 71 | parts by mass |
| Methyl ethyl ketone | 36 | parts by mass |

Polymerizable liquid crystal composition 6

| | | |
|---|---|---|
| Rod-like liquid crystal compound A shown above | 80 | parts by mass |
| Rod-like liquid crystal compound B shown above | 3 | parts by mass |
| Rod-like liquid crystal compound C shown above | 17 | parts by mass |
| Ethylene oxide-modified trimethylolpropane | 4 | parts by mass |
| triacrylate (V#360, manufactured by | | |
| Osaka Organic Chemical Industry Ltd.) | | |
| Polymerization initiator S-1 shown below | 3 | parts by mass |
| Chiral agent B shown above | 0.12 | parts by mass |
| Chiral agent D shown below | 0.94 | parts by mass |
| Leveling agent (the above compound L-1) | 0.08 | parts by mass |
| Methyl isobutyl ketone | 36 | parts by mass |
| Ethyl propionate | 71 | parts by mass |
| Methyl ethyl ketone | 36 | parts by mass |

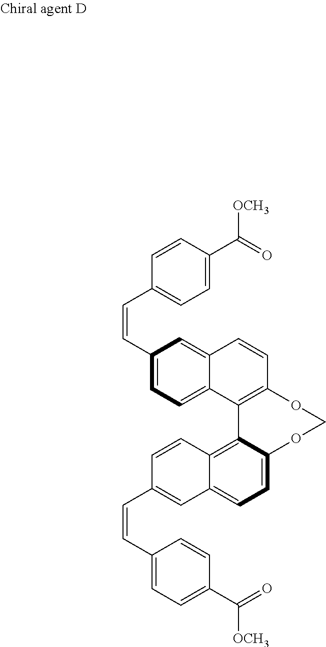

### <Measurement of Optical Characteristics>

Optical characteristics of the optical films A to D produced as described above were determined using Axoscan of Axometrics, Inc. and analysis software (Multi-Layer Analysis) of Axometrics, Inc.

The alignment axis angle of the liquid crystal compound is expressed as negative in a case of clockwise (right-handed) rotation and positive in a case of counterclockwise (left-handed) rotation, with the longitudinal direction of the film as a reference of 0°, upon observing the optical film from a side opposite to the base material side.

In addition, here, the twisted angle of the liquid crystal compound is expressed as negative in a case where the alignment direction of the liquid crystal compound on the air side (front side) is clockwise (right-handed) and as positive in a case where the alignment direction of the liquid crystal compound on the air side (front side) is counterclockwise (left-handed), with the alignment direction of the liquid crystal compound on the support side (back side) as a reference, upon observing the optical film from a side opposite to the base material side.

TABLE 1

| | | | | Slow axis | | |
|---|---|---|---|---|---|---|
| | | | Phase | orientation [°] | | Twisted |
| | | Liquid | difference | Support | Air | angle |
| | Layer | crystal | [nm] | side | side | [°] |
| Optically | 1 | Disk | 138 | −109 | −31 | 78 |
| anisotropic film | 2 | Rod | 275 | −31 | −5 | 26 |
| A1 | | | | | | |
| Optically | 3 | Disk | 255 | −5 | 13 | 18 |
| anisotropic film | 4 | Rod | 255 | 13 | −5 | −18 |
| A2 | 5 | Disk | 255 | −5 | 13 | 18 |
| | 6 | Rod | 255 | 13 | −5 | −18 |
| | 7 | Disk | 255 | −5 | 13 | 18 |
| | 8 | Rod | 255 | 13 | −5 | −18 |
| | 9 | Disk | 255 | −5 | 13 | 18 |
| | 10 | Rod | 255 | 13 | −5 | −18 |
| Optically | 11 | Disk | 275 | −5 | 21 | 26 |
| anisotropic film | 12 | Rod | 138 | 21 | 99 | 78 |
| A3 | | | | | | |

TABLE 2

| | | | | Slow axis | | |
|---|---|---|---|---|---|---|
| | | | Phase | orientation [°] | | Twisted |
| | | Liquid | difference | Support | Air | angle |
| | Layer | crystal | [nm] | side | side | [°] |
| Optically | 1 | Disk | 138 | −109 | −31 | 78 |
| anisotropic film | 2 | Rod | 275 | −31 | −5 | 26 |
| B1 | | | | | | |
| Optically | 3 | Disk | 320 | −5 | 13 | 18 |
| anisotropic film | 4 | Rod | 320 | 13 | −5 | −18 |
| B2 | 5 | Disk | 320 | −5 | 13 | 18 |
| | 6 | Rod | 320 | 13 | −5 | −18 |
| | 7 | Disk | 320 | −5 | 13 | 18 |
| | 8 | Rod | 320 | 13 | −5 | −18 |
| | 9 | Disk | 320 | −5 | 13 | 18 |
| | 10 | Rod | 320 | 13 | −5 | −18 |
| Optically | 11 | Disk | 275 | −5 | 21 | 26 |
| anisotropic film | 12 | Rod | 138 | 21 | 99 | 78 |
| B3 | | | | | | |

TABLE 3

| | | | | Slow axis | | |
|---|---|---|---|---|---|---|
| | | | Phase | orientation [°] | | Twisted |
| | | Liquid | difference | Support | Air | angle |
| | Layer | crystal | [nm] | side | side | [°] |
| Optically | 1 | Disk | 138 | −109 | −31 | 78 |
| anisotropic film | 2 | Rod | 275 | −31 | −5 | 26 |
| C1 | | | | | | |
| Optically | 3 | Disk | 195 | −5 | 13 | 18 |
| anisotropic film | 4 | Rod | 195 | 13 | −5 | −18 |
| C2 | 5 | Disk | 195 | −5 | 13 | 18 |
| | 6 | Rod | 195 | 13 | −5 | −18 |
| | 7 | Disk | 195 | −5 | 13 | 18 |
| | 8 | Rod | 195 | 13 | −5 | −18 |
| | 9 | Disk | 195 | −5 | 13 | 18 |
| | 10 | Rod | 195 | 13 | −5 | −18 |
| Optically | 11 | Disk | 275 | −5 | 21 | 26 |
| anisotropic film | 12 | Rod | 138 | 21 | 99 | 78 |
| C3 | | | | | | |

TABLE 4

| | | | | Slow axis | | |
|---|---|---|---|---|---|---|
| | | | Phase | orientation [°] | | Twisted |
| | | Liquid | difference | Support | Air | angle |
| | Layer | crystal | [nm] | side | side | [°] |
| Optically | 1 | Rod | 138 | −109 | −31 | 78 |
| anisotropic film 4 | 2 | Rod | 275 | −31 | −5 | 26 |
| Optically | 3 | Rod | 255 | −5 | 13 | 18 |
| anisotropic film 5 | 4 | Rod | 255 | 13 | −5 | −18 |
| | 5 | Rod | 255 | −5 | 13 | 18 |
| | 6 | Rod | 255 | 13 | −5 | −18 |
| | 7 | Rod | 255 | −5 | 13 | 18 |
| | 8 | Rod | 255 | 13 | −5 | −18 |
| | 9 | Rod | 255 | −5 | 13 | 18 |
| | 10 | Rod | 255 | 13 | −5 | −18 |
| Optically | 11 | Rod | 275 | −5 | 21 | 26 |
| anisotropic film 6 | 12 | Rod | 138 | 21 | 99 | 78 |

### <Production of Circularly Polarizing Plate>

In order to perform “Evaluation of wavelength dependence of transmission” described below, a circularly polarizing plate B, a circularly polarizing plate G, and a circularly polarizing plate R were produced as follows. The circularly polarizing plate G was produced first. First, the same support as in Example 1 was prepared.

### [Formation of Alignment Film P-10]

The following coating liquid for forming an alignment film P-10 was continuously applied onto the above-described support using a #2.4 wire bar. The support on which the coating film of the coating liquid for forming an alignment film P-10 was formed was dried using a hot plate at 80° C. for 5 minutes to form an alignment film P-10.

Coating liquid for forming alignment film P-10

| | | |
|---|---|---|
| Material for photo-alignment polymer A2 | 4.35 | parts by mass |
| Low-molecular-weight compound B2 | 0.80 | parts by mass |
| Crosslinking agent C1 | 2.20 | parts by mass |
| Compound D1 | 0.48 | parts by mass |
| Compound D2 | 1.15 | parts by mass |
| Butyl acetate | 100.00 | parts by mass |

### (Synthesis of Polymer A2)

100 parts by mass of 2-(3,4-epoxycyclohexyl)ethyltrimethoxysilane, 500 parts by mass of methyl isobutyl ketone, and 10 parts by mass of triethylamine were charged into a reaction container equipped with a stirrer, a thermometer, a dropping funnel, and a reflux condenser, and mixed at room temperature. Next, 100 parts by mass of deionized water was added dropwise thereto for 30 minutes using the dropping funnel, and a reaction was started at 80° C. for 6 hours while mixing the components with each other under reflux. After completion of the reaction, the organic phase was extracted and washed with 0.2% by mass ammonium nitrate aqueous solution until water after the washing was neutral. Next, by distilling off the solvent and water under reduced pressure, epoxy-containing polyorganosiloxane was obtained as a viscous transparent liquid.

The epoxy-containing polyorganosiloxane was subjected to 1H-nuclear magnetic resonance (NMR) analysis, and it was confirmed that peaks based on an oxiranyl group around a chemical shift (δ)=3.2 ppm were obtained as per theoretical strength, and a side reaction of the epoxy group did not occur during the reaction. The epoxy-containing polyorganosiloxane had a weight-average molecular weight Mw of 2,200 and an epoxy equivalent of 186 g/mol.

Next, a 100 mL three-neck flask was charged with 10.1 parts by mass of the epoxy-containing polyorganosiloxane obtained as described above, 0.5 parts by mass of acrylic group-containing carboxylic acid (manufactured by Toagosei Co., Ltd., ARONIX M-5300, acrylic acid ω-carboxypolycaprolactone (degree n of polymerization: approximately 2)), 20 parts by mass of butyl acetate, 1.5 parts by mass of a cinnamic acid derivative obtained by the method of Synthesis Example 1 of JP2015-26050A, and 0.3 parts by mass of tetrabutylammonium bromide; and the obtained reaction solution was stirred at 90° C. for 12 hours. After completion of the reaction, the reaction solution was diluted with the same amount (mass) of butyl acetate as that of the reaction solution, and was washed with water three times. An operation of concentrating the solution and diluting the concentrated solution with butyl acetate was repeated twice, and finally, a solution containing polyorganosiloxane (the following polymer A2) having a photo-aligned group was obtained. A weight-average molecular weight Mw of the polymer A2 was 9,000. In addition, as a result of ¹H-NMR analysis, the amount of the component having a cinnamate group in the polymer A2 was 23.7% by mass.

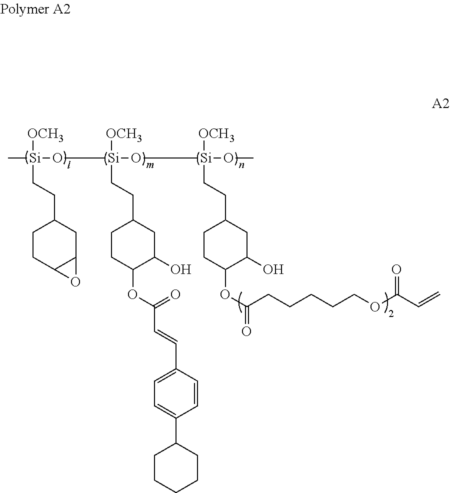

Low-molecular-weight compound B2 (NOMCOAT TAB of Nissin Ion Equipment Co., Ltd.)

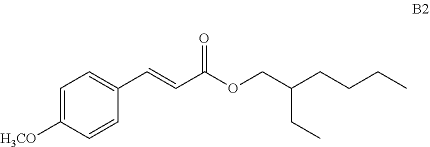 [SMILES: CCCCC(CC)COC(=O)/C=C/c1ccc(OC)cc1]

Crosslinking agent C1 (crosslinking agent C1 represented by the following formula (DENACOL EX411 manufactured by Nagase ChemteX Corporation))

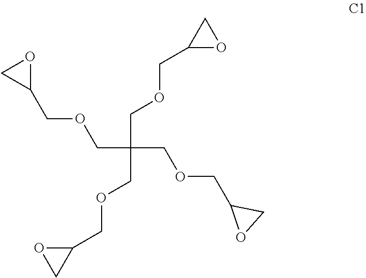 [SMILES: C(OCC(COCC1CO1)(COCC1CO1)COCC1CO1)C1CO1]

Compound D1 (compound D1 represented by the following formula (Aluminum Chelate A (W) manufactured by Kawaken Fine Chemicals Co., Ltd.))

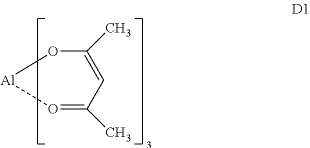

Compound D2 (compound D2 represented by the following formula (triphenylsilanol manufactured by Toyo Science Corp.))

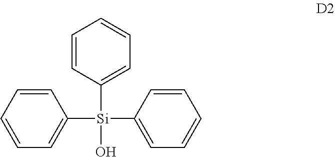 [SMILES: O[Si](c1ccccc1)(c1ccccc1)c1ccccc1]

### (Exposure of Alignment Film P-10)

The alignment film P-10 was exposed by irradiating the obtained alignment film P-10 with polarized ultraviolet rays (20 mJ/cm², using an ultra-high pressure mercury lamp).

### <Production of Optically Anisotropic Layer (λ/4 Plate)>

The composition C-1 was applied onto the alignment film P-10, and the coating film was heated to 110° C. on a hot plate and then cooled to 60° C. After the cooling, the coating film was irradiated with ultraviolet rays having a wavelength of 365 nm at an irradiated amount of 500 mJ/cm² using a high-pressure mercury lamp in a nitrogen atmosphere, thereby fixing an alignment of the liquid crystal compound to produce an optically anisotropic layer. In the obtained optically anisotropic layer, Δn₅₃₀×d (Re(530)) was 132.5 nm.

Coating liquid for forming λ/4 plate

| | | |
|---|---|---|
| Liquid crystal compound L-2 | 4.35 | parts by mass |
| Liquid crystal compound L-3 | 0.80 | parts by mass |
| Liquid crystal compound L-4 | 2.20 | parts by mass |
| Polymerization initiator PI-1 | 0.48 | parts by mass |
| Leveling agent G-1 | 1.15 | parts by mass |
| Methyl ethyl ketone | 176.00 | parts by mass |
| Cyclopentanone | 44.00 | parts by mass |

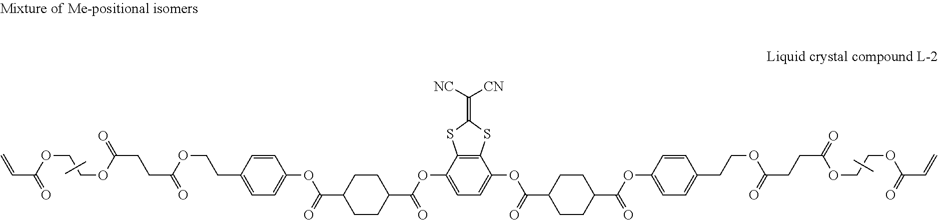

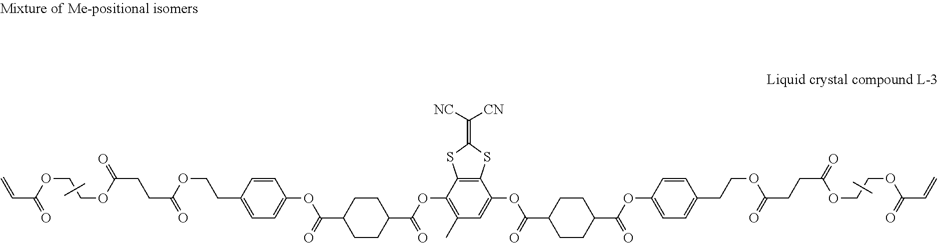

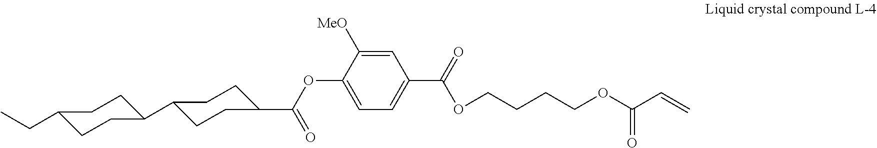 [SMILES: C=CC(=O)OCCCCOC(=O)c1ccc(OC(=O)C2CCC(C3CCC(CC)CC3)CC2)c(OC)c1]

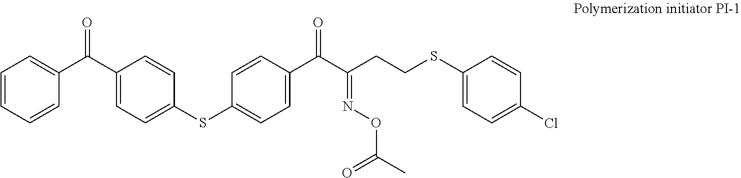 [SMILES: CC(=O)O/N=C(\CCSc1ccc(Cl)cc1)C(=O)c1ccc(Sc2ccc(C(=O)c3ccccc3)cc2)cc1]

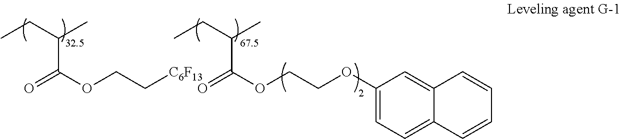

### <Production of Circularly Polarizing Plate G>

A linearly polarizing plate was bonded to the support side of the above-described optically anisotropic layer (λ/4 plate) with a pressure sensitive adhesive to obtain a circularly polarizing plate G.

### <Production of Circularly Polarizing Plate B and Circularly Polarizing Plate R>

The circularly polarizing plate B was obtained in the same manner as in the circularly polarizing plate G, except that, in the production of the circularly polarizing plate G described above, the film thickness of the optically anisotropic layer was adjusted such that Δn₄₅₀×d (Re(450)) of the obtained optically anisotropic layer was 112.5 nm.

The circularly polarizing plate R was obtained in the same manner as in the circularly polarizing plate G, except that, in the production of the circularly polarizing plate G described above, the film thickness of the optically anisotropic layer was adjusted such that Δn₆₃₅×d (Re(635)) of the obtained optically anisotropic layer was 158.8 nm.

### <Evaluation of Wavelength Selectivity>

In a case where light was incident into each of the produced optical films from the front surface (direction with an angle of 0° with respect to the normal line) and a polar angle of 30° (direction with an angle of 30° with respect to the normal line), polarization conversion rates of red light, green light, and blue light were evaluated.

Specifically, first, two circularly polarizing plates R were disposed such that the optically anisotropic layer sides of the circularly polarizing plates R faced each other. In addition, an optical film was disposed between the two circularly polarizing plates R. In the above-described arrangement state, laser light having a central wavelength in a red light range (635 nm) was incident from the normal direction of the circularly polarizing plate R to be converted into circularly polarized light, the circularly polarized light was incident from the normal direction of the optical film, the circularly polarized light emitted from the optical film was incident into the circularly polarizing plate R, and an intensity of the red light emitted from the circularly polarizing plate R was measured. That is, a transmittance (T_{R}) of the red light laser was measured. The above-described incidence of the laser light was adjusted such that the orientation of the transmission axis of the linear polarizer of the circularly polarizing plate R on the side on which the laser light was first incident was parallel to the orientation of the polarization direction of the laser light.

In the above-described operation, in a case where the optical film provided a phase difference of 2/2 with respect to the red circularly polarized light (converted into circularly polarized light having an opposite turning direction), the red light was absorbed by the linear polarizer of the circularly polarizing plate R on the side opposite to the side on which the laser light was incident. On the other hand, in a case where the optical film did not provide a phase difference with respect to the red circularly polarized light (not converted into circularly polarized light having an opposite turning direction), the red light was emitted without being absorbed by the linear polarizer of the circularly polarizing plate R on the side opposite to the side on which the laser light was incident.

A transmittance (T_{G}) of green light laser was measured in the same manner as described above, except that the circularly polarizing plate G and laser light having an output central wavelength in a green light range (530 nm) were used.

In addition, a transmittance (T_{B}) of blue light laser was measured in the same manner as described above, except that the circularly polarizing plate B and laser light having an output central wavelength in a blue light range (450 nm) were used.

In a case where the smallest value of the transmittance among T_{R}, T_{G}, and T_{B} was defined as T1 and the other values were defined as T2 and T3, wavelength selectivity of the optical film was evaluated based on the following standard. The evaluation A is preferable since the wavelength selectivity is excellent.
A: T1 was 30% or less, and T2 and T3 were 80% or more.
B: T1 was 50% or less, and T2 and T3 were 80% or more.

The fact that T2 and T3 were lower than T1 indicates that the optical film could convert only circularly polarized light in a specific wavelength range into circularly polarized light having an opposite turning direction. In addition, at the measurement wavelength of T1, the optical film converted circularly polarized light into circularly polarized light having an opposite turning direction.

Furthermore, the evaluation was performed in the same manner as described above by changing the orientation of only the optical film disposed between the circularly polarizing plates so that circularly polarized light was incident from a direction inclined by 30° from the normal direction of the surface of the optical film.

The evaluation results are shown in Table 5 below.

TABLE 5

| | | Example 1 | Example 2 | Example 3 | Example 4 |
|---|---|---|---|---|---|
| Minimum transmission angle | | 530 | 635 | 450 | 530 |
| Liquid crystal compound of | | Rod-like and | Rod-like and | Rod-like and | Rod-like |
| liquid crystal layer | | disk-like | disk-like | disk-like | |
| Wavelength | Polar angle of 0° | A | A | A | A |
| selectivity | Polar angle of 30° | A | A | A | B |

From the results shown in Table 5, it was found that the optical film (optical component) of each of Examples could convert only circularly polarized light in a specific wavelength range into circularly polarized light having an opposite turning direction. In Examples 1 and 4, T_{G} was T1 (minimum transmittance), in Example 2, T_{R} was T1, and in Example 3, T_{B} was T1.

From the comparison between Example 4 and other examples, it was found that, in a case where any one of the rod-like liquid crystal compound or the disk-like liquid crystal compound was included in the liquid crystal compound in the first liquid crystal layer and the other is included in the liquid crystal compound in the second liquid crystal layer, the wavelength selectivity was excellent even in a case where circularly polarized light was incident from a direction inclined from the normal direction of the surface of the optical film (optical component).

### <Optical Element>

A first optically anisotropic member, a second optically anisotropic member, and a third optically anisotropic member were produced by the following procedure.

### [Formation of First Optically Anisotropic Member]

### (Support)

A glass substrate was used as a support.

### (Formation of Alignment Film)

The following coating liquid for forming an alignment film was applied onto the support by spin coating. The support on which the coating film of the alignment film-forming coating liquid was formed was dried using a hot plate at 60° C. for 60 seconds. As a result, an alignment film was formed.

Alignment film-forming coating liquid

| | | |
|---|---|---|
| Material A for photo-alignment | 1.00 | part by mass |
| Water | 16.00 | parts by mass |
| Butoxyethanol | 42.00 | parts by mass |
| Propylene glycol monomethyl ether | 42.00 | parts by mass |

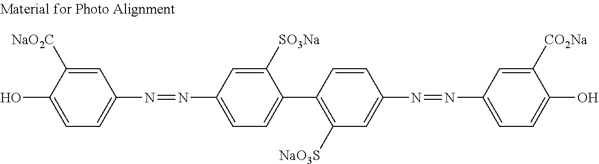

### (Exposure of Alignment Film)

The alignment film was exposed using the exposure device shown in FIG. 18 to form an alignment film PG-1 having an alignment pattern.

In the exposure device, a laser which emitted laser light having a wavelength (355 nm) was used as the laser. An exposure amount of the interference light was set to 1,000 mJ/cm².

### (Formation of Optically Anisotropic Layer)

As a liquid crystal composition forming a first optically anisotropic layer, the following composition E-1 was prepared.

Composition E-1

| | | |
|---|---|---|
| Liquid crystal compound L-1 shown above | 10.00 | parts by mass |
| Liquid crystal compound L-5 shown below | 90.00 | parts by mass |
| Chiral agent C1 | 0.69 | parts by mass |
| Polymerization initiator | 1.00 | part by mass |
| (manufactured by BASF, Irgacure OXE01) | | |
| Surfactant F2 shown above | 0.30 | parts by mass |
| Methyl ethyl ketone | 550.00 | parts by mass |
| Cyclopentanone | 550.00 | parts by mass |

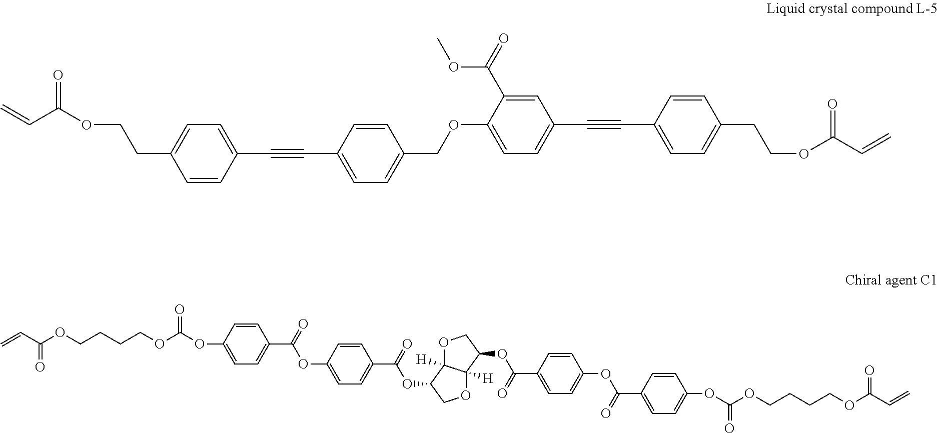

An optically anisotropic layer was formed by applying the composition E-1 onto the alignment film PG-1 in multiple layers. The application in multiple layers refers to repetition of processes including producing a first liquid crystal immobilized layer by applying the first layer-forming composition E-1 onto the alignment film, heating the composition E-1, and irradiating the composition E-1 with ultraviolet light for curing; and producing a second or subsequent liquid crystal immobilized layer by applying the second or subsequent layer-forming composition E-1 onto the formed liquid crystal immobilized layer, heating the composition E-1, and irradiating the composition E-1 with ultraviolet light for curing as described above. Even in a case where the liquid crystal layer was formed by the application of the multiple layers such that the total thickness of the optically anisotropic layer was large, the alignment direction of the alignment film was preserved from a lower surface of the optically anisotropic layer to an upper surface thereof.

Regarding a first layer, the above-described composition E-1 was applied onto the alignment film PG-1 to form a coating film, the coating film was heated to 80° C. on a hot plate, the coating film was irradiated with ultraviolet rays having a wavelength of 365 nm at an irradiation amount of 300 mJ/cm² using a high-pressure mercury lamp in a nitrogen atmosphere, thereby fixing the alignment of the liquid crystal compound to form a liquid crystal immobilized layer.

Regarding the second or subsequent layer, the composition was applied onto the liquid crystal immobilized layer, and heated, and cured with ultraviolet rays under the same conditions as described above to produce a liquid crystal immobilized layer. In this way, by repeating the application multiple times until the total thickness reached a desired film thickness, an optically anisotropic layer was formed, and a liquid crystal diffraction element was produced.

A birefringence index Δn of the cured layer of the liquid crystal composition E-1 was obtained by applying the liquid crystal composition E-1 onto a support with an alignment film for retardation measurement, which was prepared separately, aligning a director of the liquid crystal compound to be parallel to the base material, irradiating the liquid crystal composition E-1 with ultraviolet rays for immobilization to obtain a liquid crystal immobilized layer (cured layer), and measuring a retardation value and a film thickness of the liquid crystal immobilized layer. An could be calculated by dividing the retardation value by the film thickness. The retardation value was measured by measuring a desired wavelength using Axoscan (manufactured by Axometrix, inc.) and measuring the film thickness using a scanning electron microscope.

In the optically anisotropic layer, Δn₅₅₀×thickness (Re(550)) of the liquid crystals was finally 150 nm, and it was confirmed using a polarization microscope that periodic alignment occurred on the surface. In the liquid crystal alignment pattern of the optically anisotropic layer, a single period over which the optical axis derived from the liquid crystal compound rotated by 180° was 0.8 μm. In addition, in the optically anisotropic layer, a twisted angle of the liquid crystal compound in the thickness direction was 83°. Hereinafter, unless specified otherwise, “Δn₅₅₀×d” and the like were measured in the same manner as described above.

As a liquid crystal composition forming a second optically anisotropic layer, the following composition E-2 was prepared.

Composition E-2

| | | |
|---|---|---|
| Liquid crystal compound L-1 shown above | 10.00 | parts by mass |
| Liquid crystal compound L-5 shown above | 90.00 | parts by mass |
| Chiral agent C1 shown above | 0.03 | parts by mass |
| Polymerization initiator | 1.00 | part by mass |
| (manufactured by BASF, Irgacure OXE01) | | |
| Surfactant F2 shown above | 0.30 | parts by mass |
| Methyl ethyl ketone | 550.00 | parts by mass |
| Cyclopentanone | 550.00 | parts by mass |

A second optically anisotropic layer was formed of the composition E-2 by the same method for the first optically anisotropic layer, except that the film thickness of the optically anisotropic layer was adjusted.

In the optically anisotropic layer, Δn₅₅₀×thickness (Re(550)) of the liquid crystals was finally 335 nm, and it was confirmed using a polarization microscope that periodic alignment occurred on the surface. In the liquid crystal alignment pattern of the optically anisotropic layer, a single period over which the optical axis derived from the liquid crystal compound rotated by 180° was 0.8 μm. In addition, in the optically anisotropic layer, a twisted angle of the liquid crystal compound in the thickness direction was 8°.

As a liquid crystal composition forming a third optically anisotropic layer, the following composition E-3 was prepared.

Composition E-3

| | | |
|---|---|---|
| Liquid crystal compound L-1 shown above | 10.00 | parts by mass |
| Liquid crystal compound L-5 shown above | 90.00 | parts by mass |
| Chiral agent C2 shown below | 0.60 | parts by mass |
| Polymerization initiator | 1.00 | part by mass |
| (manufactured by BASF, Irgacure OXE01) | | |
| Surfactant F2 shown above | 0.30 | parts by mass |
| Methyl ethyl ketone | 550.00 | parts by mass |
| Cyclopentanone | 550.00 | parts by mass |

A third optically anisotropic layer was formed of the composition E-3 by the same method for the first optically anisotropic layer, except that the film thickness of the optically anisotropic layer was adjusted.

In the optically anisotropic layer, Δn₅₅₀×thickness (Re(550)) of the liquid crystals was finally 170 nm, and it was confirmed using a polarization microscope that periodic alignment occurred on the surface. In the liquid crystal alignment pattern of the optically anisotropic layer, a single period over which the optical axis derived from the liquid crystal compound rotated by 180° was 0.8 μm. In addition, in the optically anisotropic layer, a twisted angle of the liquid crystal compound in the thickness direction was −78°. In this way, a first optically anisotropic member including a first liquid crystal diffraction element A1 was produced.

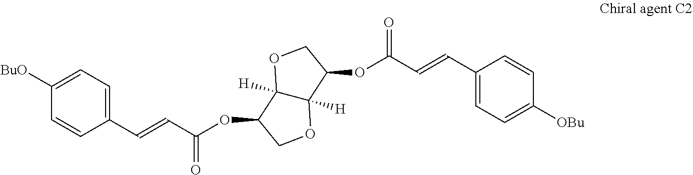

### [Production of Second Optically Anisotropic Member]

### (Formation of Alignment Film)

An alignment film was formed in the same manner as described above. The exposure of the alignment film was performed by the following procedure.

### (Exposure of Alignment Film)

The alignment film was exposed using the exposure device shown in FIG. 18 to form an alignment film PG-2 having an alignment pattern.

In the exposure device, a laser which emitted laser light having a wavelength (355 nm) was used as the laser. An exposure amount of the interference light was set to 1,000 mJ/cm².

A second optically anisotropic member including a second liquid crystal diffraction element A2 was produced by the same procedure as that of the first liquid crystal diffraction element A1, except that the alignment film PG-2 was used and the optically anisotropic layers were adjusted to have the following retardation.

In the produced second liquid crystal diffraction element A2, Δn₅₅₀×thickness (Re(550)) of the first optically anisotropic layer was 150 nm and a twisted angle of the liquid crystal compound in the thickness direction was 83°; Δn₅₅₀×thickness (Re(550)) of the second optically anisotropic layer was 335 nm and a twisted angle of the liquid crystal compound in the thickness direction was 8°; and Δn₅₅₀×thickness (Re(550)) of the third optically anisotropic layer was 170 nm and a twisted angle of the liquid crystal compound in the thickness direction was −78°. In the liquid crystal alignment pattern of the optically anisotropic layer of the liquid crystal diffraction element, a single period over which the optical axis derived from the liquid crystal compound rotated by 180° was 10.0 μm.

### [Production of Third Optically Anisotropic Member]

### (Formation of Alignment Film)

An alignment film was formed on the support in the same manner as described above. The exposure of the alignment film was performed by the following procedure.

### (Exposure of Alignment Film)

The alignment film was exposed using the exposure device shown in FIG. 18 to form an alignment film PG-3 having an alignment pattern.

In the exposure device, a laser which emitted laser light having a wavelength (355 nm) was used as the laser. An exposure amount of the interference light was set to 1,000 mJ/cm².

A third optically anisotropic member including a third liquid crystal diffraction element A3 was produced by the same procedure as that of the first liquid crystal diffraction element A1, except that the alignment film PG-3 was used and the optically anisotropic layers were adjusted to have the following retardation.

In the produced third liquid crystal diffraction element A3, Δn₅₅₀× thickness (Re(550)) of the first optically anisotropic layer was 150 nm and a twisted angle of the liquid crystal compound in the thickness direction was 83°; Δn₅₅₀×thickness (Re(550)) of the second optically anisotropic layer was 335 nm and a twisted angle of the liquid crystal compound in the thickness direction was 8°; and Δn₅₅₀×thickness (Re(550)) of the third optically anisotropic layer was 170 nm and a twisted angle of the liquid crystal compound in the thickness direction was −78°. In the liquid crystal alignment pattern of the optically anisotropic layer of the liquid crystal diffraction element, a single period over which the optical axis derived from the liquid crystal compound rotated by 180° was 8.9 μm.

### [Production and Evaluation of Optical Element]

The above-described liquid crystal diffraction element A1 (optically anisotropic layer), the optical film of Example 2 (optical component), the above-described liquid crystal diffraction element A2 (optically anisotropic layer), the optical film of Example 1 (optical component), and the above-described liquid crystal diffraction element A3 (optically anisotropic layer) were laminated in this order to produce an optical element.

In a case where light was incident into the produced optical element from the front surface (direction with an angle of 0° with respect to the normal line), angles and transmitted diffracted light of red light, green light, and blue light with respect to incidence light were measured. The angle of transmitted diffracted light is an angle of the transmitted diffracted light with respect to the incidence light in a case where an incidence direction of the incidence light was 0°.

Specifically, laser light having output central wavelengths in a red light range (635 nm), a green light range (532 nm), and a blue light range (450 nm) was caused to be vertically incident into the produced optical element from a position at a distance of 10 cm in the normal direction, and the transmitted diffracted light was captured using a screen disposed at a distance of 100 cm to calculate a transmission angle. In the present example, the designed wavelength λa of light having the longest wavelength was 635 nm, the designed wavelength λb of light having the intermediate wavelength was 532 nm, and the designed wavelength Δc of light having the shortest wavelength was 450 nm.

Laser light was caused to be vertically incident into the above-described circularly polarizing plate B, the above-described circularly polarizing plate G, and the above-described circularly polarizing plate R corresponding to the respective wavelengths to be converted into circularly polarized light, the circularly polarized light was incident into the produced optical element, and the evaluation was performed.

From the average transmission angle θₐᵥₑ of red light, green light, and blue light, and the maximum transmission angle θₘₐₓ and the minimum transmission angle θₘᵢₙ of red light, green light, and blue light, wavelength dependence PE [%] of the diffraction angle of the transmitted diffracted light was calculated according to the following expression. As the PE decreases, the wavelength dependence of the diffraction angle of the transmitted diffracted light is lower.

$$PE [ \% ] = [ ( {θ}_{max} - {θ}_{min} ) / {θ}_{ave} ] \times 100$$

In the produced optical element, it was confirmed that the calculated PE was 5% or less and the wavelength dependence of the diffraction angle of the transmitted diffracted light was low.

### EXPLANATION OF REFERENCES

10: optical element
12: first optically anisotropic member
14: second optically anisotropic member
16: third optically anisotropic member
18G, 18R, 100: wavelength selective phase difference plate
20: support
24A, 24B, 24C: alignment film
26A: first optically anisotropic layer
26B: second optically anisotropic layer
26C: third optically anisotropic layer
30: liquid crystal compound
30A: optical axis
34: optically anisotropic layer
40: display
42: light guide plate
60, 80: exposure device
62, 82: laser
64, 84: light source
68: beam splitter
70A, 70B, 90A, 90B: mirror
72A, 72B, 96: λ/4 plate
86, 94: polarization beam splitter
92: lens
112: first wavelength plate
114: second wavelength plate
116: third wavelength plate
210, 230: filter
212: first λ/4 plate
214: second λ/4 plate
216, 246: liquid crystal polarization interference element
218: liquid crystal compound (rod-like liquid crystal compound)
220, 232: first liquid crystal layer
224, 234: second liquid crystal layer
226, 236: liquid crystal layer set
D1: first in-plane slow axis direction
D2: second in-plane slow axis direction
D3: third in-plane slow axis direction
B_{R}, B_{2R}: blue dextrorotatory circularly polarized light
G_{R}, G_{1R}, G_{2R}, G_{3R}: green dextrorotatory circularly polarized light
R_{R}, R_{1R}, R_{3R}: red dextrorotatory circularly polarized light
B_{1L}, B_{3L}: blue levorotatory circularly polarized light
G_{1L}, G_{2L}: green levorotatory circularly polarized light
R_{1L}, R_{2L}: red levorotatory circularly polarized light
M: laser light
MA, MB: ray
MP: P polarized light
MS: S polarized light
P_{O}: linearly polarized light
P_{R}: dextrorotatory circularly polarized light
P_{L}: levorotatory circularly polarized light
Q1, Q2: absolute phase
E1, E2: equiphase plane
U: user

What is claimed is:

1. An optical component comprising, in the following order:
a first λ/4 plate;
an optical laminate; and
a second λ/4 plate,
wherein the optical laminate includes two or more liquid crystal layer sets in a thickness direction, the liquid crystal layer set each consisting of a first liquid crystal layer which is formed by immobilizing a liquid crystal compound twist-aligned in the thickness direction and a second liquid crystal layer which is formed by immobilizing a liquid crystal compound twist-aligned in the thickness direction, in which a twisted direction of the liquid crystal compound in the second liquid crystal layer is opposite to a twisted direction of the liquid crystal compound in the first liquid crystal layer,
in the liquid crystal layer set, an alignment direction of the liquid crystal compound in a surface of the first liquid crystal layer on the second liquid crystal layer side is parallel to an alignment direction of the liquid crystal compound in a surface of the second liquid crystal layer on the first liquid crystal layer side, and
a twisted angle of the liquid crystal compound in the first liquid crystal layer is equal to a twisted angle of the liquid crystal compound in the second liquid crystal layer.

2. The optical component according to claim 1,
wherein the liquid crystal compound in the first liquid crystal layer includes any one of a rod-like liquid crystal compound or a disk-like liquid crystal compound, and the liquid crystal compound in the second liquid crystal layer includes the other.

3. The optical component according to claim 1,
wherein at least one of the first λ/4 plate or the second λ/4 plate is a laminate consisting of a liquid crystal layer A formed by immobilizing a liquid crystal compound twist-aligned in the thickness direction and a liquid crystal layer B formed by immobilizing a liquid crystal compound twist-aligned in the thickness direction.

4. The optical component according to claim 3,
wherein a twisted angle of the liquid crystal compound in the liquid crystal layer A is 16.5° to 36.5° and a product Δn_{A}d_{A} of a difference Δn_{A} in refractive index of the liquid crystal layer A and a thickness d_{A} of the liquid crystal layer A is 252 to 312 nm, and
a twisted angle of the liquid crystal compound in the liquid crystal layer B is 68.6° to 88.6° and a product Δn_{B}d_{B} of a difference Δn_{B} in refractive index of the liquid crystal layer B and a thickness d_{B} of the liquid crystal layer B is 110 to 170 nm.

5. The optical component according to claim 3,
wherein the liquid crystal layer A is disposed on the optical laminate side, and
an alignment direction of the liquid crystal compound in a surface of the optical laminate on the liquid crystal layer A side is parallel to an alignment direction of the liquid crystal compound in a surface of the liquid crystal layer A on the optical laminate side.

6. The optical component according to claim 3,
wherein an alignment direction of the liquid crystal compound in a surface of the liquid crystal layer A on the liquid crystal layer B side is parallel to an alignment direction of the liquid crystal compound in a surface of the liquid crystal layer B on the liquid crystal layer A side.

7. An optical element comprising:
a plurality of optically anisotropic layers which are formed of a composition containing a liquid crystal compound and have a liquid crystal alignment pattern in which an orientation of an optical axis derived from the liquid crystal compound changes while continuously rotating in at least one in-plane direction; and
the optical component according to claim 1, which is disposed between at least one pair of adjacent two optically anisotropic layers among the plurality of optically anisotropic layers,
wherein, in a case where a length over which the orientation of the optical axis derived from the liquid crystal compound rotates by 180° in the one direction in which the orientation of the optical axis derived from the liquid crystal compound changes while continuously rotating in the liquid crystal alignment pattern of the optically anisotropic layer is set as a single period, at least one layer of the optically anisotropic layers has a length of the single period different from lengths of the single periods of the other optically anisotropic layers.

8. The optical component according to claim 2,
wherein at least one of the first λ/4 plate or the second λ/4 plate is a laminate consisting of a liquid crystal layer A formed by immobilizing a liquid crystal compound twist-aligned in the thickness direction and a liquid crystal layer B formed by immobilizing a liquid crystal compound twist-aligned in the thickness direction.

9. The optical component according to claim 8,
wherein a twisted angle of the liquid crystal compound in the liquid crystal layer A is 16.5° to 36.5° and a product Δn_{A}d_{A} of a difference Δn_{A} in refractive index of the liquid crystal layer A and a thickness d_{A} of the liquid crystal layer A is 252 to 312 nm, and
a twisted angle of the liquid crystal compound in the liquid crystal layer B is 68.6° to 88.6° and a product Δn_{B}d_{B} of a difference Δn_{B} in refractive index of the liquid crystal layer B and a thickness d_{B} of the liquid crystal layer B is 110 to 170 nm.

10. The optical component according to claim 4,
wherein the liquid crystal layer A is disposed on the optical laminate side, and
an alignment direction of the liquid crystal compound in a surface of the optical laminate on the liquid crystal layer A side is parallel to an alignment direction of the liquid crystal compound in a surface of the liquid crystal layer A on the optical laminate side.

11. The optical component according to claim 4,
wherein an alignment direction of the liquid crystal compound in a surface of the liquid crystal layer A on the liquid crystal layer B side is parallel to an alignment direction of the liquid crystal compound in a surface of the liquid crystal layer B on the liquid crystal layer A side.

12. An optical element comprising:
a plurality of optically anisotropic layers which are formed of a composition containing a liquid crystal compound and have a liquid crystal alignment pattern in which an orientation of an optical axis derived from the liquid crystal compound changes while continuously rotating in at least one in-plane direction; and
the optical component according to claim 2, which is disposed between at least one pair of adjacent two optically anisotropic layers among the plurality of optically anisotropic layers,
wherein, in a case where a length over which the orientation of the optical axis derived from the liquid crystal compound rotates by 180° in the one direction in which the orientation of the optical axis derived from the liquid crystal compound changes while continuously rotating in the liquid crystal alignment pattern of the optically anisotropic layer is set as a single period, at least one layer of the optically anisotropic layers has a length of the single period different from lengths of the single periods of the other optically anisotropic layers.

13. The optical component according to claim 5,
wherein an alignment direction of the liquid crystal compound in a surface of the liquid crystal layer A on the liquid crystal layer B side is parallel to an alignment direction of the liquid crystal compound in a surface of the liquid crystal layer B on the liquid crystal layer A side.

14. An optical element comprising:
a plurality of optically anisotropic layers which are formed of a composition containing a liquid crystal compound and have a liquid crystal alignment pattern in which an orientation of an optical axis derived from the liquid crystal compound changes while continuously rotating in at least one in-plane direction; and
the optical component according to claim 3, which is disposed between at least one pair of adjacent two optically anisotropic layers among the plurality of optically anisotropic layers,
wherein, in a case where a length over which the orientation of the optical axis derived from the liquid crystal compound rotates by 180° in the one direction in which the orientation of the optical axis derived from the liquid crystal compound changes while continuously rotating in the liquid crystal alignment pattern of the optically anisotropic layer is set as a single period, at least one layer of the optically anisotropic layers has a length of the single period different from lengths of the single periods of the other optically anisotropic layers.

15. An optical element comprising:
a plurality of optically anisotropic layers which are formed of a composition containing a liquid crystal compound and have a liquid crystal alignment pattern in which an orientation of an optical axis derived from the liquid crystal compound changes while continuously rotating in at least one in-plane direction; and
the optical component according to claim 4, which is disposed between at least one pair of adjacent two optically anisotropic layers among the plurality of optically anisotropic layers,
wherein, in a case where a length over which the orientation of the optical axis derived from the liquid crystal compound rotates by 180° in the one direction in which the orientation of the optical axis derived from the liquid crystal compound changes while continuously rotating in the liquid crystal alignment pattern of the optically anisotropic layer is set as a single period, at least one layer of the optically anisotropic layers has a length of the single period different from lengths of the single periods of the other optically anisotropic layers.

16. An optical element comprising:
a plurality of optically anisotropic layers which are formed of a composition containing a liquid crystal compound and have a liquid crystal alignment pattern in which an orientation of an optical axis derived from the liquid crystal compound changes while continuously rotating in at least one in-plane direction; and
the optical component according to claim 5, which is disposed between at least one pair of adjacent two optically anisotropic layers among the plurality of optically anisotropic layers,
wherein, in a case where a length over which the orientation of the optical axis derived from the liquid crystal compound rotates by 180° in the one direction in which the orientation of the optical axis derived from the liquid crystal compound changes while continuously rotating in the liquid crystal alignment pattern of the optically anisotropic layer is set as a single period, at least one layer of the optically anisotropic layers has a length of the single period different from lengths of the single periods of the other optically anisotropic layers.

17. An optical element comprising:
a plurality of optically anisotropic layers which are formed of a composition containing a liquid crystal compound and have a liquid crystal alignment pattern in which an orientation of an optical axis derived from the liquid crystal compound changes while continuously rotating in at least one in-plane direction; and
the optical component according to claim 6, which is disposed between at least one pair of adjacent two optically anisotropic layers among the plurality of optically anisotropic layers,
wherein, in a case where a length over which the orientation of the optical axis derived from the liquid crystal compound rotates by 180° in the one direction in which the orientation of the optical axis derived from the liquid crystal compound changes while continuously rotating in the liquid crystal alignment pattern of the optically anisotropic layer is set as a single period, at least one layer of the optically anisotropic layers has a length of the single period different from lengths of the single periods of the other optically anisotropic layers.
